(19) United States
(12) Patent Application Publication
(10) Pub. No.: US 2024/0111311 A1
(43) Pub. Date: Apr. 4, 2024

(54) CONTROL APPARATUS, BASE STATION, CONTROL METHOD, AND PROGRAM

(71) Applicant: FUJIFILM CORPORATION, Tokyo (JP)

(72) Inventor: Tetsu WADA, Kanagawa (JP)

(21) Appl. No.: 18/534,713

(22) Filed: Dec. 10, 2023

Related U.S. Application Data
(63) Continuation of application No. PCT/JP2022/019851, filed on May 10, 2022.

(30) Foreign Application Priority Data
Jun. 29, 2021 (JP) 2021-108047

(51) Int. Cl. G05D 1/689; B64U 10/14; G05D 1/242; H04N 23/69; H04N 23/695

(52) U.S. Cl. CPC G05D 1/689; B64U 10/14; G05D 1/242; H04N 23/69; H04N 23/695; B64U 2101/30

(57) ABSTRACT

A control apparatus includes a processor, and a memory connected to or incorporated in the processor. The processor is configured to rotate a distance measurement device via a rotational drive apparatus to which the distance measurement device is attached, measure a first distance between a target object and the distance measurement device at a plurality of distance measurement locations of the target object via the distance measurement device, set a flying route for causing a flying object to fly along the target object based on the first distance measured for each distance measurement location, and in a case of causing the flying object to fly along the flying route and acquiring a plurality of first images by imaging a plurality of imaged regions of the target object via a first imaging apparatus mounted on the flying object, perform a control of constantly maintaining pixel resolution of the first imaging apparatus.

### CROSS-REFERENCE TO RELATED APPLICATIONS

This application is a continuation application of International Application No. PCT/JP2022/019851, filed May 10, 2022, the disclosure of which is incorporated herein by reference in its entirety. Further, this application claims priority from Japanese Patent Application No. 2021-108047, filed Jun. 29, 2021, the disclosure of which is incorporated herein by reference in its entirety.

### BACKGROUND OF THE INVENTION

### 1. Field of the Invention

The disclosed technology relates to a control apparatus, a base station, a control method, and a program.

### 2. Description of the Related Art

JP2017-151008A discloses a flying object tracking method comprising optical tracking of irradiating a retroreflection object of a flying object comprising the retroreflection object with tracking light, receiving the tracking light, and tracking the flying object based on a light-receiving result, and image tracking of acquiring an image of the flying object, detecting the flying object from the image, and tracking the flying object based on a detection result, in which the optical tracking and the image tracking are parallelly executed, and in a case where the flying object cannot be tracked by the optical tracking, restoration to the optical tracking based on the detection result of the image tracking is performed.

JP2014-104797A discloses an in-building inspection system comprising a moving mechanism that moves on a floor surface to enter into a building, a camera provided in the moving mechanism, a pan/tilt mechanism of the camera, a flying object mountable on the moving mechanism, a light-emitting object provided in the flying object, pan/tilt control means for controlling the pan/tilt mechanism to make the camera track the light-emitting object, display means for displaying an image captured by the camera, and operation means for operating at least the flying object.

JP2018-173960A discloses an information processing system that performs a flying control of an unmanned aircraft, the information processing system comprising control means for controlling flying of the unmanned aircraft to fly over a position not imaged by a network camera in a case where the unmanned aircraft is flying over a position imaged by the network camera.

JP2018-070013A discloses an unmanned aerial vehicle control system in which an unmanned aerial vehicle connected to a base station through a cable and an information processing apparatus are connected through a network, the unmanned aerial vehicle control system including comparison means for comparing an area of the base station and a length of the cable with each other, and cable adjustment means for, in a case where the comparison means determines that the length of the cable is longer than the area of the base station, controlling the length of the cable to be shorter than the area of the base station.

Pamphlet of WO2017/017984A discloses a moving object identification system that identifies a moving object, in which the moving object identification system acquires moving state information including first positional information of a plurality of moving objects detected by a moving state monitoring apparatus that monitors a moving state of the moving object, acquires predetermined report information including second positional information of the moving object measured by the moving object from the moving object, and identifies a registration status of the moving object based on the first positional information and on the second positional information.

### SUMMARY OF THE INVENTION

One embodiment according to the disclosed technology provides a control apparatus, a base station, a control method, and a program that can constantly maintain resolution of an image obtained by imaging a target object via a first imaging apparatus mounted on a flying object which flies along the target object, even in a case where the target object has, for example, a recessed portion or a protruding portion.

A first aspect according to the disclosed technology is a control apparatus comprising a processor, and a memory connected to or incorporated in the processor, in which the processor is configured to rotate a distance measurement device via a rotational drive apparatus to which the distance measurement device is attached, measure a first distance between a target object and the distance measurement device at a plurality of distance measurement locations of the target object via the distance measurement device, set a flying route for causing a flying object to fly along the target object based on the first distance measured for each distance measurement location, and in a case of causing the flying object to fly along the flying route and acquiring a plurality of first images by imaging a plurality of imaged regions of the target object via a first imaging apparatus mounted on the flying object, perform a control of constantly maintaining pixel resolution of the first imaging apparatus.

A second aspect according to the disclosed technology is the control apparatus according to the first aspect, in which the processor is configured to adjust a rotational angle of the rotational drive apparatus to a second rotational angle at which the flying object is included within a distance measurement range of the distance measurement device, measure a second distance between the flying object and the distance measurement device via the distance measurement device, and perform a control of causing the flying object to fly along the flying route based on the second rotational angle and on the second distance.

A third aspect according to the disclosed technology is the control apparatus according to the second aspect, in which the distance measurement device includes a LiDAR scanner, the second distance is a distance between the flying object and the LiDAR scanner, and the processor is configured to derive second absolute coordinates of the flying object based on first absolute coordinates of the rotational drive apparatus, the second rotational angle, an angle of laser light emitted from the LiDAR scanner toward the flying object, and the second distance; and perform a control of causing the flying object to fly along the flying route based on the second absolute coordinates.

A fourth aspect according to the disclosed technology is the control apparatus according to the second aspect or the third aspect, in which a second imaging apparatus is attached to the rotational drive apparatus, and the processor is configured to perform a control of adjusting the rotational angle of the rotational drive apparatus to the second rotational angle based on a second image obtained by imaging the flying object via the second imaging apparatus.

A fifth aspect according to the disclosed technology is the control apparatus according to the fourth aspect, in which the second rotational angle is an angle at which the flying object is positioned in a center portion of an angle of view of the second imaging apparatus.

A sixth aspect according to the disclosed technology is the control apparatus according to the fourth aspect or the fifth aspect, in which the flying object includes a plurality of members categorized with different aspects, and the processor is configured to control a posture of the flying object based on positions of the plurality of members captured in the second image.

A seventh aspect according to the disclosed technology is the control apparatus according to the sixth aspect, in which the different aspects are different colors, and the members are propellers.

An eighth aspect according to the disclosed technology is the control apparatus according to the sixth aspect, in which the different aspects are different colors, and the members are light-emitting objects.

A ninth aspect according to the disclosed technology is the control apparatus according to the sixth aspect, in which the different aspects are different turn-on and turn-off patterns, and the members are light-emitting objects.

A tenth aspect according to the disclosed technology is the control apparatus according to any one of the first aspect to the ninth aspect, in which the plurality of first images are images acquired each time the flying object reaches each of a plurality of first imaging positions set on the flying route.

An eleventh aspect according to the disclosed technology is the control apparatus according to the tenth aspect, in which the plurality of first imaging positions are positions at which the first images acquired at adjacent first imaging positions among the plurality of first imaging positions partially overlap with each other.

A twelfth aspect according to the disclosed technology is the control apparatus according to any one of the first aspect to the eleventh aspect, in which in a case where a surface of the target object has a recessed portion and an area of an opening portion of the recessed portion is less than a predetermined area, the processor is configured to set the flying route on a smooth virtual plane facing the surface.

A thirteenth aspect according to the disclosed technology is the control apparatus according to the twelfth aspect, in which the processor is configured to, in a case where the flying object flies across the recessed portion, perform a control of constantly maintaining the pixel resolution by operating at least one of a zoom lens or a focus lens of the first imaging apparatus.

A fourteenth aspect according to the disclosed technology is the control apparatus according to any one of the first aspect to the thirteenth aspect, in which the processor is configured to rotate a first distance measurement device as the distance measurement device via a first rotational drive apparatus as the rotational drive apparatus to which the first distance measurement device is attached, measure the first distance at a plurality of first distance measurement locations among the plurality of distance measurement locations via the first distance measurement device, rotate a second distance measurement device as the distance measurement device via a second rotational drive apparatus as the rotational drive apparatus to which the second distance measurement device is attached, measure the first distance at a plurality of second distance measurement locations among the plurality of distance measurement locations via the second distance measurement device, and set the flying route based on the first distance measured for each first distance measurement location and on the first distance measured for each second distance measurement location.

A fifteenth aspect according to the disclosed technology is the control apparatus according to the fourteenth aspect, in which the processor is configured to convert the first distance measured by the second distance measurement device into a distance with reference to a position of the first distance measurement device based on predetermined first calibration information.

A sixteenth aspect according to the disclosed technology is the control apparatus according to the fourteenth aspect or the fifteenth aspect, in which the processor is configured to convert a position of the flying object measured by the second distance measurement device into a position with reference to a position of the first distance measurement device based on predetermined second calibration information.

A seventeenth aspect according to the disclosed technology is the control apparatus according to any one of the fourteenth aspect to the sixteenth aspect, in which the processor is configured to select a distance measurement device to measure a position of the flying object from the first distance measurement device and the second distance measurement device in accordance with the position of the flying object.

An eighteenth aspect according to the disclosed technology is the control apparatus according to any one of the fourteenth aspect to the seventeenth aspect, in which the processor is configured to, in a case of setting the flying route with reference to a point positioned outside a first distance measurement region of the first distance measurement device and outside a second distance measurement region of the second distance measurement device, derive a distance between the point and the first distance measurement device based on an angle of a direction in which the point is positioned with respect to the first distance measurement device and on a distance between the first distance measurement device and the second distance measurement device.

A nineteenth aspect according to the disclosed technology is the control apparatus according to the eighteenth aspect, in which the processor is configured to, in a case where the flying object is positioned outside the first distance measurement region and outside the second distance measurement region, derive a distance between the flying object and the first distance measurement device based on an angle of a direction in which the flying object is positioned with respect to the first distance measurement device and on the distance between the first distance measurement device and the second distance measurement device.

A twentieth aspect according to the disclosed technology is the control apparatus according to any one of the first aspect to the nineteenth aspect, in which the flying object includes a third imaging apparatus, the processor is configured to perform position correction processing of correcting a position of the flying object based on a third image obtained by imaging the target object via the third imaging apparatus in a case where the flying object that has moved from a second imaging position set on the flying route has reached a third imaging position set on the flying route, and in a case of acquiring a fourth image by imaging the target object via the third imaging apparatus in accordance with reaching of the flying object to the second imaging position and then acquiring a fifth image by imaging the target object via the third imaging apparatus in accordance with reaching of the flying object to the third imaging position, the position correction processing is processing of correcting the position of the flying object to a position at which an overlap amount between the fourth image and the fifth image is a predetermined overlap amount based on an overlap amount between the fourth image and the third image.

A twenty-first aspect according to the disclosed technology is a base station comprising the control apparatus according to any one of the first aspect to the twentieth aspect, the rotational drive apparatus, and the distance measurement device.

A twenty-second aspect according to the disclosed technology is a control method comprising rotating a distance measurement device via a rotational drive apparatus to which the distance measurement device is attached, measuring a first distance between a target object and the distance measurement device at a plurality of distance measurement locations of the target object via the distance measurement device, setting a flying route for causing a flying object to fly along the target object based on the first distance measured for each distance measurement location, and performing, in a case of causing the flying object to fly along the flying route and acquiring a plurality of first images by imaging a plurality of imaged regions of the target object via a first imaging apparatus mounted on the flying object, a control of constantly maintaining pixel resolution of the first imaging apparatus.

A twenty-third aspect according to the disclosed technology is a program causing a computer to execute a process comprising rotating a distance measurement device via a rotational drive apparatus to which the distance measurement device is attached, measuring a first distance between a target object and the distance measurement device at a plurality of distance measurement locations of the target object via the distance measurement device, setting a flying route for causing a flying object to fly along the target object based on the first distance measured for each distance measurement location, and performing, in a case of causing the flying object to fly along the flying route and acquiring a plurality of first images by imaging a plurality of imaged regions of the target object via a first imaging apparatus mounted on the flying object, a control of constantly maintaining pixel resolution of the first imaging apparatus.

### BRIEF DESCRIPTION OF THE DRAWINGS

FIG. 1 is a side view illustrating an example of an inspection system according to a first embodiment of the disclosed technology.

FIG. 2 is a plan view illustrating an example of the inspection system according to the first embodiment of the disclosed technology.

FIG. 3 is a plan view illustrating an example of a flying object according to the first embodiment of the disclosed technology.

FIG. 4 is a block diagram illustrating an example of an electrical configuration of a base station according to the first embodiment of the disclosed technology.

FIG. 5 is a block diagram illustrating an example of an electrical configuration of a rotational drive apparatus of the base station according to the first embodiment of the disclosed technology.

FIG. 6 is a block diagram illustrating an example of an electrical configuration of an imaging apparatus of the base station according to the first embodiment of the disclosed technology.

FIG. 7 is a block diagram illustrating an example of an electrical configuration of a distance measurement device of the base station according to the first embodiment of the disclosed technology.

FIG. 8 is a block diagram illustrating an example of an electrical configuration of the flying object according to the first embodiment of the disclosed technology.

FIG. 9 is a block diagram illustrating an example of an electrical configuration of an imaging apparatus of the flying object according to the first embodiment of the disclosed technology.

FIG. 10 is a block diagram illustrating an example of a functional configuration of a processor of the base station according to the first embodiment of the disclosed technology.

FIG. 11 is a block diagram illustrating an example of a functional configuration of a flying route setting processing unit according to the first embodiment of the disclosed technology.

FIG. 12 is a block diagram illustrating an example of a functional configuration of a flying control processing unit according to the first embodiment of the disclosed technology.

FIG. 13 is a block diagram illustrating an example of a functional configuration of an imaging control processing unit according to the first embodiment of the disclosed technology.

FIG. 14 is a block diagram illustrating an example of a functional configuration of a processor of the flying object according to the first embodiment of the disclosed technology.

FIG. 15 is a descriptive diagram for describing an example of a first operation of the flying route setting processing unit according to the first embodiment of the disclosed technology.

FIG. 16 is a descriptive diagram for describing an example of a second operation of the flying route setting processing unit according to the first embodiment of the disclosed technology.

FIG. 17 is a descriptive diagram for describing an example of a third operation of the flying route setting processing unit according to the first embodiment of the disclosed technology.

FIG. 18 is a descriptive diagram for describing an example of a fourth operation of the flying route setting processing unit according to the first embodiment of the disclosed technology.

FIG. 19 is a descriptive diagram for describing an example of a fifth operation of the flying route setting processing unit according to the first embodiment of the disclosed technology.

FIG. 20 is a descriptive diagram for describing an example of a first operation of the flying control processing unit according to the first embodiment of the disclosed technology.

FIG. 21 is a descriptive diagram for describing an example of a second operation of the flying control processing unit according to the first embodiment of the disclosed technology.

FIG. 22 is a descriptive diagram for describing an example of a third operation of the flying control processing unit according to the first embodiment of the disclosed technology.

FIG. 23 is a descriptive diagram for describing an example of a first operation of the imaging control processing unit according to the first embodiment of the disclosed technology.

FIG. 24 is a descriptive diagram for describing an example of a second operation of the imaging control processing unit according to the first embodiment of the disclosed technology.

FIG. 25 is a descriptive diagram for describing an example of a third operation of the imaging control processing unit according to the first embodiment of the disclosed technology.

FIG. 26 is a descriptive diagram for describing an example of a fourth operation of the imaging control processing unit according to the first embodiment of the disclosed technology.

FIG. 27 is a descriptive diagram for describing an example of a fifth operation of the imaging control processing unit according to the first embodiment of the disclosed technology.

FIG. 28 is a descriptive diagram for describing an example of a sixth operation of the imaging control processing unit according to the first embodiment of the disclosed technology.

FIG. 29 is a descriptive diagram for describing an example of a seventh operation of the imaging control processing unit according to the first embodiment of the disclosed technology.

FIG. 30 is a descriptive diagram for describing an example of an eighth operation of the imaging control processing unit according to the first embodiment of the disclosed technology.

FIG. 31 is a descriptive diagram for describing an example of a ninth operation of the imaging control processing unit according to the first embodiment of the disclosed technology.

FIG. 32 is a descriptive diagram for describing an example of a tenth operation of the imaging control processing unit according to the first embodiment of the disclosed technology.

FIG. 33 is a descriptive diagram for describing an example of an eleventh operation of the imaging control processing unit according to the first embodiment of the disclosed technology.

FIG. 34 is a flowchart illustrating an example of a flow of first processing of flying imaging support processing according to the first embodiment of the disclosed technology.

FIG. 35 is a flowchart illustrating an example of a flow of second processing of the flying imaging support processing according to the first embodiment of the disclosed technology.

FIG. 36 is a flowchart illustrating an example of a flow of third processing of the flying imaging support processing according to the first embodiment of the disclosed technology.

FIG. 37 is a flowchart illustrating an example of a flow of fourth processing of the flying imaging support processing according to the first embodiment of the disclosed technology.

FIG. 38 is a flowchart illustrating an example of a flow of fifth processing of the flying imaging support processing according to the first embodiment of the disclosed technology.

FIG. 39 is a flowchart illustrating an example of a flow of sixth processing of the flying imaging support processing according to the first embodiment of the disclosed technology.

FIG. 40 is a flowchart illustrating an example of a flow of first processing of flying imaging processing according to the first embodiment of the disclosed technology.

FIG. 41 is a flowchart illustrating an example of a flow of second processing of the flying imaging processing according to the first embodiment of the disclosed technology.

FIG. 42 is a flowchart illustrating an example of a flow of third processing of the flying imaging processing according to the first embodiment of the disclosed technology.

FIG. 43 is a plan view illustrating a modification example of the flying object according to the first embodiment of the disclosed technology.

FIG. 44 is a plan view illustrating an example of an inspection system according to a second embodiment of the disclosed technology.

FIG. 45 is a block diagram illustrating an example of a functional configuration of a flying route setting processing unit according to the second embodiment of the disclosed technology.

FIG. 46 is a block diagram illustrating an example of a functional configuration of a flying control processing unit according to the second embodiment of the disclosed technology.

FIG. 47 is a block diagram illustrating an example of a functional configuration of an imaging control processing unit according to the second embodiment of the disclosed technology.

FIG. 48 is a descriptive diagram for describing an example of a first operation of the flying route setting processing unit according to the second embodiment of the disclosed technology.

FIG. 49 is a descriptive diagram for describing an example of a second operation of the flying route setting processing unit according to the second embodiment of the disclosed technology.

FIG. 50 is a schematic diagram illustrating an example of a plurality of points of a region in which distance measurement regions of each distance measurement device according to the second embodiment of the disclosed technology overlap with each other.

FIG. 51 is a descriptive diagram for describing an example of a third operation of the flying route setting processing unit according to the second embodiment of the disclosed technology.

FIG. 52 is a descriptive diagram for describing an example of a fourth operation of the flying route setting processing unit according to the second embodiment of the disclosed technology.

FIG. 53 is a descriptive diagram for describing an example of operation of the flying control processing unit according to the second embodiment of the disclosed technology.

FIG. 54 is a descriptive diagram for describing an example of operation of the imaging control processing unit according to the second embodiment of the disclosed technology.

FIG. 55 is a flowchart illustrating an example of a flow of first processing of flying imaging support processing according to the second embodiment of the disclosed technology.

FIG. 56 is a flowchart illustrating an example of a flow of second processing of the flying imaging support processing according to the second embodiment of the disclosed technology.

FIG. 57 is a flowchart illustrating an example of a flow of third processing of the flying imaging support processing according to the second embodiment of the disclosed technology.

FIG. 58 is a flowchart illustrating an example of a flow of fourth processing of the flying imaging support processing according to the second embodiment of the disclosed technology.

FIG. 59 is a flowchart illustrating an example of a flow of fifth processing of the flying imaging support processing according to the second embodiment of the disclosed technology.

FIG. 60 is a block diagram illustrating an example of a functional configuration of a processor of a base station according to a third embodiment of the disclosed technology.

FIG. 61 is a descriptive diagram for describing an example of a first operation of a distance derivation processing unit according to the third embodiment of the disclosed technology.

FIG. 62 is a descriptive diagram for describing an example of a second operation of the distance derivation processing unit according to the third embodiment of the disclosed technology.

FIG. 63 is a schematic diagram illustrating an example of a point positioned outside a distance measurement region of each distance measurement device according to the third embodiment of the disclosed technology.

FIG. 64 is a descriptive diagram for describing an example of distance derivation processing according to the third embodiment of the disclosed technology.

FIG. 65 is a block diagram illustrating an example of a functional configuration of a processor of a base station according to a fourth embodiment of the disclosed technology.

FIG. 66 is a block diagram illustrating an example of a functional configuration of a position correction processing unit according to the fourth embodiment of the disclosed technology.

FIG. 67 is a block diagram illustrating an example of a first operation of the position correction processing unit according to the fourth embodiment of the disclosed technology.

FIG. 68 is a flowchart illustrating an example of a flow of first processing of position correction processing according to the fourth embodiment of the disclosed technology.

FIG. 69 is a flowchart illustrating an example of a flow of second processing of the position correction processing according to the fourth embodiment of the disclosed technology.

### DESCRIPTION OF THE PREFERRED EMBODIMENTS

Hereinafter, an example of embodiments of a control apparatus, a base station, a control method, and a program according to the disclosed technology will be described in accordance with the accompanying drawings.

First, terms used in the following description will be described.

CPU refers to an abbreviation for “Central Processing Unit”. GPU refers to an abbreviation for “Graphics Processing Unit”. RAM refers to an abbreviation for “Random Access Memory. NVM refers to an abbreviation for “Non-Volatile Memory”. IC refers to an abbreviation for “Integrated Circuit”. ASIC refers to an abbreviation for “Application Specific Integrated Circuit”. PLD refers to an abbreviation for “Programmable Logic Device”. FPGA refers to an abbreviation for “Field-Programmable Gate Array”. SoC refers to an abbreviation for “System-on-a-Chip”. SSD refers to an abbreviation for “Solid State Drive”. HDD refers to an abbreviation for “Hard Disk Drive”. EEPROM refers to an abbreviation for “Electrically Erasable and Programmable Read Only Memory”. SRAM refers to an abbreviation for “Static Random Access Memory”. I/F refers to an abbreviation for “Interface”. USB refers to an abbreviation for “Universal Serial Bus”. CMOS refers to an abbreviation for “Complementary Metal Oxide Semiconductor”. CCD refers to an abbreviation for “Charge Coupled Device”. LED refers to an abbreviation for “Light Emitting Diode”. EL refers to an abbreviation for “Electro Luminescence”. LiDAR refers to an abbreviation for “Light Detection And Ranging”. MEMS refers to an abbreviation for “Micro Electro Mechanical Systems”. AI refers to an abbreviation for “Artificial Intelligence”.

In description of the present specification, a “horizontal direction” refers to, in addition to a complete horizontal direction, a horizontal direction in the sense of including error that is error generally allowed in the technical field to which the disclosed technology belongs and that is of a degree not contradicting the gist of the disclosed technology. In description of the present specification, a “vertical direction” refers to, in addition to a complete vertical direction, a vertical direction in the sense of including error that is error generally allowed in the technical field to which the disclosed technology belongs and that is of a degree not contradicting the gist of the disclosed technology. In description of the present specification, “parallel” refers to, in addition to being completely parallel, being parallel in the sense of including error that is error generally allowed in the technical field to which the disclosed technology belongs and that is of a degree not contradicting the gist of the disclosed technology. In description of the present specification, “symmetrical” refers to, in addition to being completely symmetrical, being symmetrical in the sense of including error that is error generally allowed in the technical field to which the disclosed technology belongs and that is of a degree not contradicting the gist of the disclosed technology. In the present specification, “constant” refers to, in addition to being completely constant, being constant in the sense of including error that is error generally allowed in the technical field to which the disclosed technology belongs and that is of a degree not contradicting the gist of the disclosed technology. In the present specification, “match” refers to, in addition to complete match, match in the sense of including error that is error generally allowed in the technical field to which the disclosed technology belongs and that is of a degree not contradicting the gist of the disclosed technology. In addition, a numerical range represented using “to” in the following description means a range including numerical values before and after “to” as a lower limit value and an upper limit value.

### First Embodiment

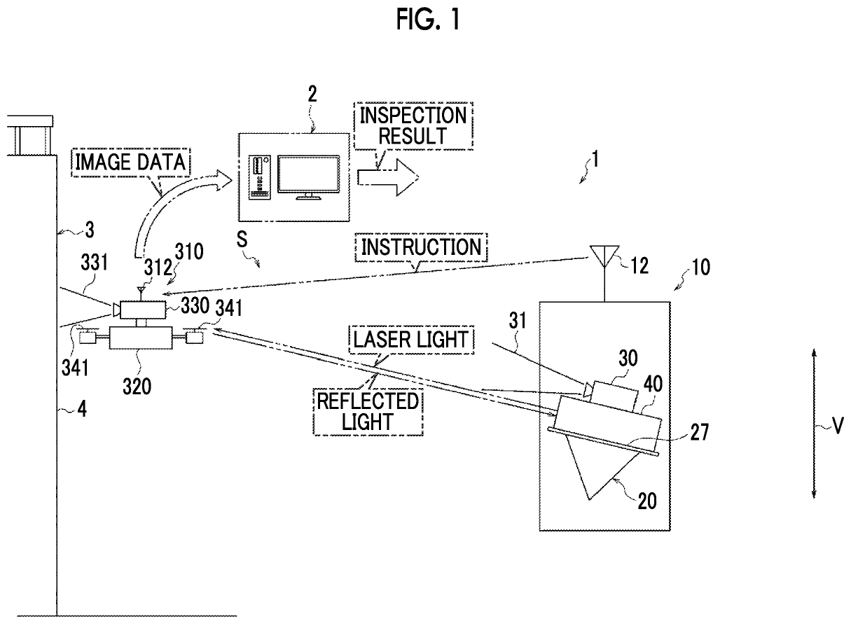

As illustrated in FIG. 1 as an example, an inspection system 1 comprises an image analysis apparatus 2 and an imaging system S and inspects an inspection target object 3.

As an example, the inspection target object 3 is a pier of a bridge. As an example, the pier is made of reinforced concrete. Here, while the pier is illustrated as an example of the inspection target object 3, the inspection target object 3 may be road equipment other than the pier. Examples of the road equipment include a road surface, a tunnel, a guard rail, a traffic signal, and/or a windbreak fence. The inspection target object 3 may be a social infrastructure (for example, airport equipment, port equipment, water storage equipment, gas equipment, medical equipment, firefighting equipment, and/or educational equipment) other than the road equipment or may be a private possession. In addition, the inspection target object 3 may be a land (for example, a public land and/or a private land). The pier illustrated as the inspection target object 3 may be a pier made of other than the reinforced concrete.

In the present embodiment, inspection refers to, for example, inspection of a state of the inspection target object 3. For example, whether or not the inspection target object 3 is damaged and/or a degree of damage is inspected by the inspection system 1. The inspection target object 3 is an example of a “target object” according to the embodiment of the disclosed technology.

The imaging system S comprises a base station 10 and a flying object 310. The base station 10 has a control function. The control function is a function of controlling the flying object 310 by providing an instruction such as a flying instruction or an imaging instruction to the flying object 310. The flying object 310 has a flying function and a first imaging function. The flying function is a function of flying based on the flying instruction. The first imaging function is a function of imaging a subject (in the example illustrated in FIG. 1, the inspection target object 3) based on the imaging instruction.

For further detailed description of the flying object 310, the flying object 310 comprises, for example, an unmanned aerial vehicle such as a drone, a communication apparatus 312, a flying object body 320, and an imaging apparatus 330. A communication apparatus 12 is mounted on the base station 10, and the communication apparatus 312 communicates with the communication apparatus 12. The communication apparatus 312 may communicate with the communication apparatus 12 in a wireless manner or may communicate with the communication apparatus 12 in a wired manner.

The first imaging function is implemented by the imaging apparatus 330. Examples of the imaging apparatus 330 include a digital camera or a video camera. The imaging apparatus 330 images a second subject (in the example illustrated in FIG. 1, the inspection target object 3). While the imaging apparatus 330 is mounted on an upper portion of the flying object body 320 in the example illustrated in FIG. 1, this is merely an example. The imaging apparatus 330 may be mounted on a lower portion of the flying object body 320. The imaging apparatus 330 is mounted on a center portion of the flying object body 320 and is disposed in a direction of imaging a front of the flying object 310. The imaging apparatus 330 is an example of a “first imaging apparatus” according to the embodiment of the disclosed technology.

The imaging system S is a system that provides image data obtained by imaging the inspection target object 3 via the flying object 310 to the image analysis apparatus 2. The image analysis apparatus 2 inspects whether or not the inspection target object 3 is damaged and/or a degree or the like of damage by executing image analysis processing with respect to the image data provided from the imaging system S and outputs an inspection result. As an example, the image analysis processing is processing of analyzing an image using a template matching technology and/or artificial intelligence or the like.

The base station 10 comprises a rotational drive apparatus 20, an imaging apparatus 30, and a distance measurement device 40, in addition to the communication apparatus 12. The rotational drive apparatus 20 comprises a seat 27. The rotational drive apparatus 20 is an apparatus that can rotate the seat 27 in the horizontal direction and in the vertical direction. In FIG. 1, arrow V denotes the vertical direction. The imaging apparatus 30 and the distance measurement device 40 are attached to the seat 27. While the imaging apparatus 30 is disposed on an upper side of the distance measurement device 40 in the example illustrated in FIG. 1, this is merely an example. The imaging apparatus 30 may be disposed on a lower side of the distance measurement device 40 or may be disposed next to the distance measurement device 40 in the horizontal direction.

The imaging apparatus 30 is an apparatus that has a second imaging function. The second imaging function is a function of capturing an imaging scene including the inspection target object 3 or the flying object 310. The second imaging function is implemented by, for example, a digital camera or a video camera. The imaging apparatus 30 is an example of a “second imaging apparatus” according to the embodiment of the disclosed technology. The distance measurement device 40 is a device having a distance measurement function. The distance measurement function is a function of measuring a distance between the inspection target object 3 or the flying object 310 and the distance measurement device 40. The distance measurement function is implemented by, for example, an ultrasonic distance measurement device, a laser distance measurement device, or a radar distance measurement device. Examples of the laser distance measurement device include a LiDAR scanner. Hereinafter, a case where the LiDAR scanner is used as an example of the laser distance measurement device implementing the distance measurement function will be described.

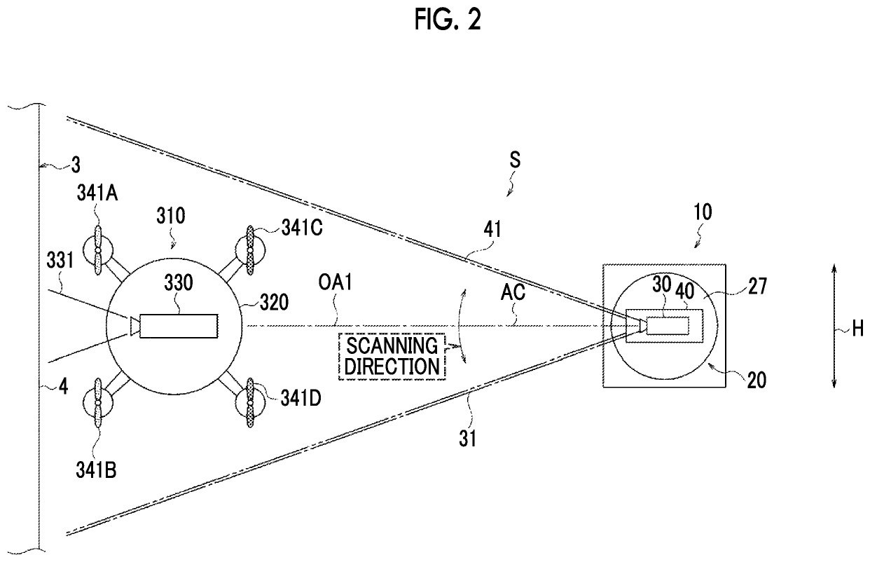

As illustrated in FIG. 2 as an example, a direction (hereinafter, referred to as a scanning direction) in which the distance measurement device 40 performs scanning with laser light is set to the horizontal direction. In FIG. 2, arrow H denotes the horizontal direction. In addition, a distance measurement range 41 that is a range scanned with the laser light by the distance measurement device 40 is set within an imaging range 31 of the imaging apparatus 30 in a plan view. In a case where a first subject (for example, the flying object 310 illustrated in FIG. 1 and FIG. 2) is positioned in a center portion of an angle of view of the imaging apparatus 30, the distance measurement range 41 is set to a range in which the first subject is positioned in a center portion of the distance measurement range 41. In addition, an optical axis OA1 of the imaging apparatus 30 matches a central axis AC of the distance measurement range 41 in a plan view of the imaging system S.

The scanning direction of the distance measurement device 40 may be set to the vertical direction and may be set to directions of both of the horizontal direction and the vertical direction. In addition, while the base station 10 comprises the imaging apparatus 30 and the distance measurement device 40 in the examples illustrated in FIG. 1 and FIG. 2 as an example, this is merely an example. The base station 10 may comprise an imaging apparatus having the second imaging function and the distance measurement function. Examples of the imaging apparatus having the second imaging function and the distance measurement function include a stereo camera or a phase difference pixel camera.

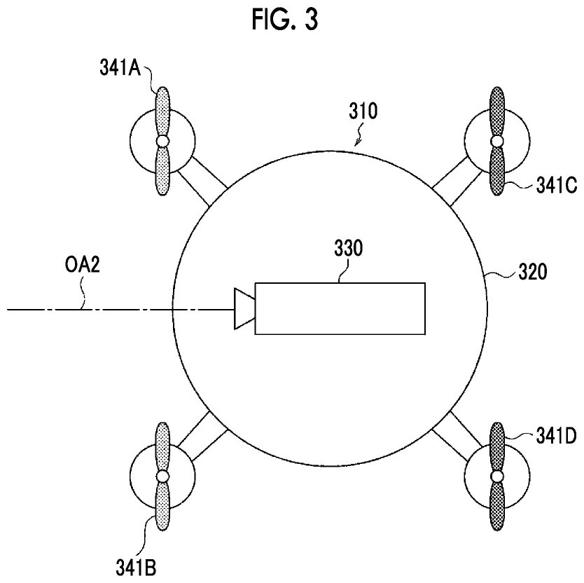

As illustrated in FIG. 3 as an example, the flying object body 320 is a multicopter including a first propeller 341A, a second propeller 341B, a third propeller 341C, and a fourth propeller 341D. The first propeller 341A is disposed on a right side of a front of the flying object body 320. The second propeller 341B is disposed on a left side of the front of the flying object body 320. The third propeller 341C is disposed on a right side of a rear of the flying object body 320. The fourth propeller 341D is disposed on a left side of the rear of the flying object body 320.

As an example, the first propeller 341A and the third propeller 341C are disposed on a right side of the imaging apparatus 330, and the second propeller 341B and the fourth propeller 341D are disposed on a left side of the imaging apparatus 330. The first propeller 341A is disposed at a position of line symmetry with the second propeller 341B about an optical axis OA2 of the imaging apparatus 330 in a plan view. The third propeller 341C is disposed at a position of line symmetry with the fourth propeller 341D about the optical axis OA2 of the imaging apparatus 330 in a plan view. The first propeller 341A, the second propeller 341B, the third propeller 341C, and the fourth propeller 341D are an example of a “plurality of members” according to the embodiment of the disclosed technology.

The first propeller 341A, the second propeller 341B, the third propeller 341C, and the fourth propeller 341D are categorized with different colors as an example of different aspects. In the example illustrated in FIG. 3, the color of each propeller is represented by a dot provided to each of the first propeller 341A, the second propeller 341B, the third propeller 341C, and the fourth propeller 341D.

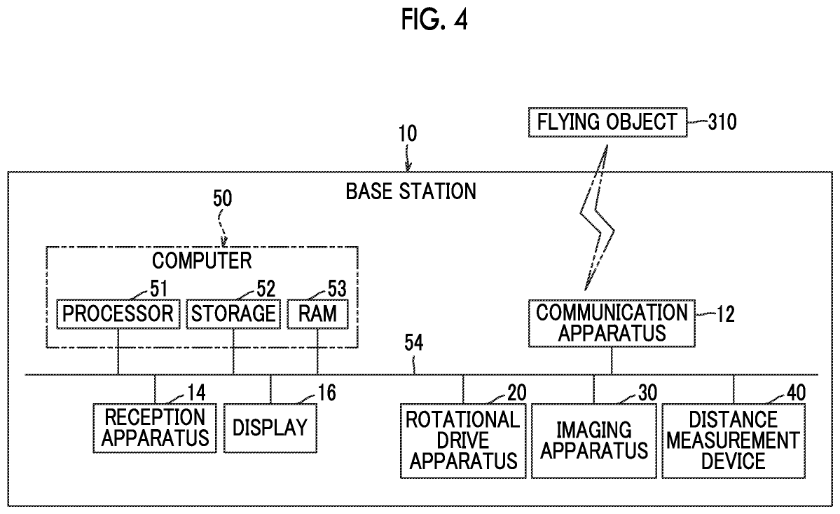

As an example, the color of the first propeller 341A is the same as the color of the second propeller 341B, and the color of the third propeller 341C is the same as the color of the fourth propeller 341D. A first color set for the first propeller 341A and the second propeller 341B is different from a second color set for the third propeller 341C and the fourth propeller 341D. Each of the first color and the second color may be a chromatic color or an achromatic color. The first color and the second color may be any color as long as a processor 51 (refer to FIG. 4) of the base station 10, described later, can identify the first color and the second color based on an image obtained by capturing via the imaging apparatus 30.

While the first color is set for the first propeller 341A and the second propeller 341B and the second color is set for the third propeller 341C and the fourth propeller 341D in the example illustrated in FIG. 3, this is merely an example. The first color may be set for the first propeller 341A and the third propeller 341C, and the second color may be set for the second propeller 341B and the fourth propeller 341D. In addition, the first color may be set for the first propeller 341A and the fourth propeller 341D, and the second color may be set for the second propeller 341B and the third propeller 341C. In addition, colors different from each other may be set for the first propeller 341A, the second propeller 341B, the third propeller 341C, and the fourth propeller 341D.

As illustrated in FIG. 4 as an example, the base station 10 comprises the communication apparatus 12, a reception apparatus 14, a display 16, the rotational drive apparatus 20, the imaging apparatus 30, the distance measurement device 40, and a computer 50.

The computer 50 is an example of a “control apparatus” and a “computer” according to the embodiment of the disclosed technology. The computer 50 comprises the processor 51, a storage 52, and a RAM 53. The processor 51 is an example of a “processor” according to the embodiment of the disclosed technology, and the RAM 53 is an example of a “memory” according to the embodiment of the disclosed technology. The processor 51, the storage 52, and the RAM 53 are connected to each other through a bus 54. In addition, the communication apparatus 12, the reception apparatus 14, the display 16, the rotational drive apparatus 20, the imaging apparatus 30, and the distance measurement device 40 are also connected to the bus 54. While one bus is illustrated as the bus 54 in the example illustrated in FIG. 4 for convenience of illustration, a plurality of buses may be used. The bus 54 may be a serial bus or may be a parallel bus including a data bus, an address bus, a control bus, and the like.

The processor 51, for example, includes a CPU and controls the entire base station 10. Here, while an example in which the processor 51 includes a CPU is illustrated, this is merely an example. For example, the processor 51 may include a CPU and a GPU. In this case, for example, the GPU operates under control of the CPU and executes image processing.

The storage 52 is a non-volatile storage device that stores various programs, various parameters, and the like. Examples of the storage 52 include an HDD and an SSD. The HDD and the SSD are merely an example. A flash memory, a magnetoresistive memory, and/or a ferroelectric memory may be used instead of the HDD and/or the SDD or together with the HDD and/or the SSD.

The RAM 53 is a memory in which information is temporarily stored, and is used as a work memory by the processor 51. Examples of the RAM 53 include a DRAM and/or an SRAM.

The reception apparatus 14 includes a keyboard, a mouse, a touchpad, and the like and receives information provided from a user. The display 16 displays various types of information (for example, an image and a text) under control of the processor 51. Examples of the display 16 include an EL display (for example, an organic EL display or an inorganic EL display). The display 16 is not limited to the EL display and may be of other types such as a liquid crystal display.

The communication apparatus 12 is communicably connected to the flying object 310. Here, the communication apparatus 12 is wirelessly communicably connected to the flying object 310 using a predetermined wireless communication standard. Examples of the predetermined wireless communication standard include Bluetooth (registered trademark). Other wireless communication standards (for example, Wi/Fi or 5G) may be used. Here, while wireless communication is illustrated, the disclosed technology is not limited thereto. Wired communication may be applied instead of wireless communication. The communication apparatus 12 exchanges information with the flying object 310. For example, the communication apparatus 12 transmits information corresponding to a request from the processor 51 to the flying object 310. In addition, the communication apparatus 12 receives information transmitted from the flying object 310 and outputs the received information to the processor 51 through the bus 54.

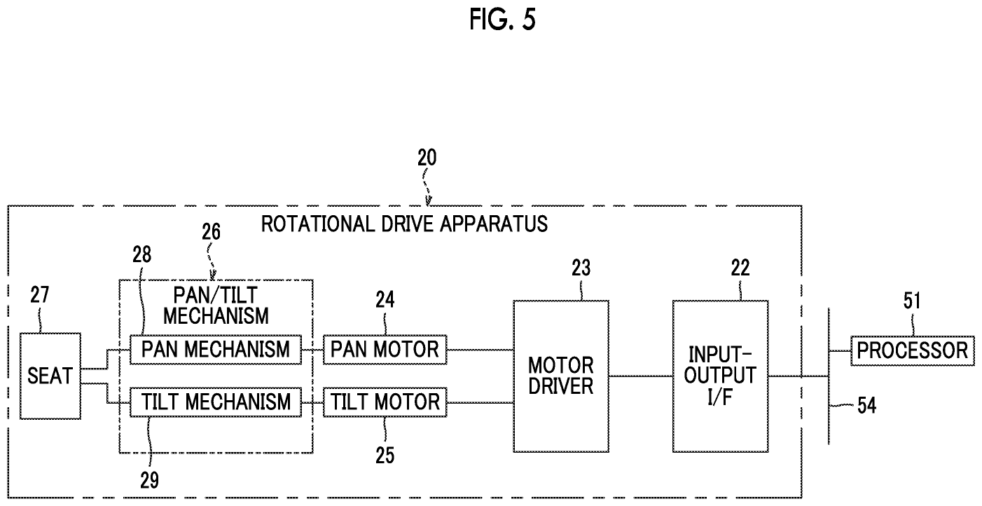

As illustrated in FIG. 5 as an example, the rotational drive apparatus 20 comprises an input-output I/F 22, a motor driver 23, a pan motor 24, a tilt motor 25, a pan/tilt mechanism 26, and the seat 27.

The motor driver 23 is connected to the processor 51 through the input-output I/F 22 and through the bus 54. The motor driver 23 controls the pan motor 24 and the tilt motor 25 in accordance with an instruction from the processor 51. For example, the pan motor 24 and the tilt motor 25 are motors such as a brushed direct current motor, a brushless motor, or a stepping motor.

The pan/tilt mechanism 26 is, for example, a two-axis gimbal and comprises a pan mechanism 28 and a tilt mechanism 29. The pan mechanism 28 is connected to a rotation axis of the pan motor 24, and the tilt mechanism 29 is connected to a rotation axis of the tilt motor 25. The seat 27 is connected to the pan/tilt mechanism 26. The pan mechanism 28 receives rotational force of the pan motor 24 to provide rotational force in the horizontal direction to the seat 27, and the tilt mechanism 29 receives rotational force of the tilt motor 25 to provide rotational force in the vertical direction to the seat 27. The seat 27 rotates in the horizontal direction via the rotational force provided from the pan motor 24 through the pan mechanism 28 and rotates in the vertical direction via the rotational force provided from the tilt motor 25 through the tilt mechanism 29.

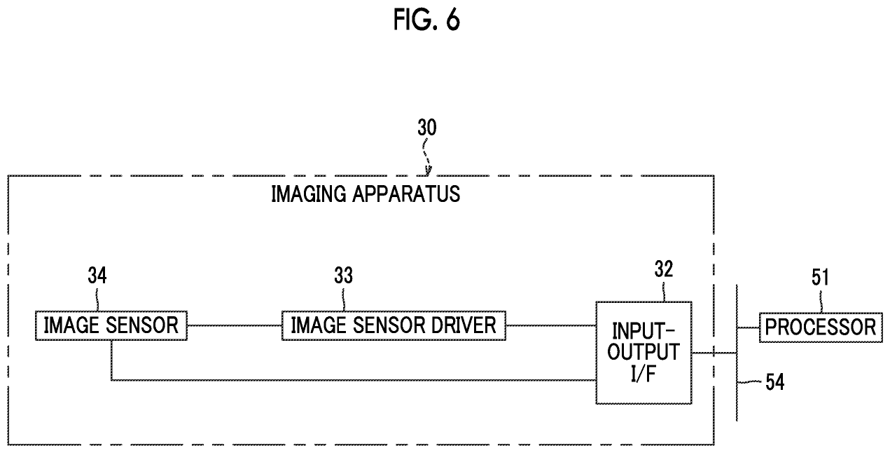

As illustrated in FIG. 6 as an example, the imaging apparatus 30 comprises an input-output I/F 32, an image sensor driver 33, and an image sensor 34. The image sensor driver 33 and the image sensor 34 are connected to the processor 51 through the input-output I/F 32 and through the bus 54.

The image sensor driver 33 controls the image sensor 34 in accordance with an instruction from the processor 51. The image sensor 34 is, for example, a CMOS image sensor. Here, while the CMOS image sensor is illustrated as the image sensor 34, the disclosed technology is not limited thereto. Other image sensors may be used. The image sensor 34 images the first subject (for example, the flying object 310 illustrated in FIG. 1 and FIG. 2) and outputs an image obtained by imaging to the processor 51 under control of the image sensor driver 33.

While illustration is not particularly provided, the imaging apparatus 30 comprises optical components such as an objective lens, a focus lens, a zoom lens, and a stop. In addition, while illustration is not particularly provided, the imaging apparatus 30 comprises an actuator that drives the optical components such as the focus lens, the zoom lens, and the stop. In a case where imaging is performed by the imaging apparatus 30, the actuator is controlled to drive the optical components such as the focus lens, the zoom lens, and the stop comprised in the imaging apparatus 30.

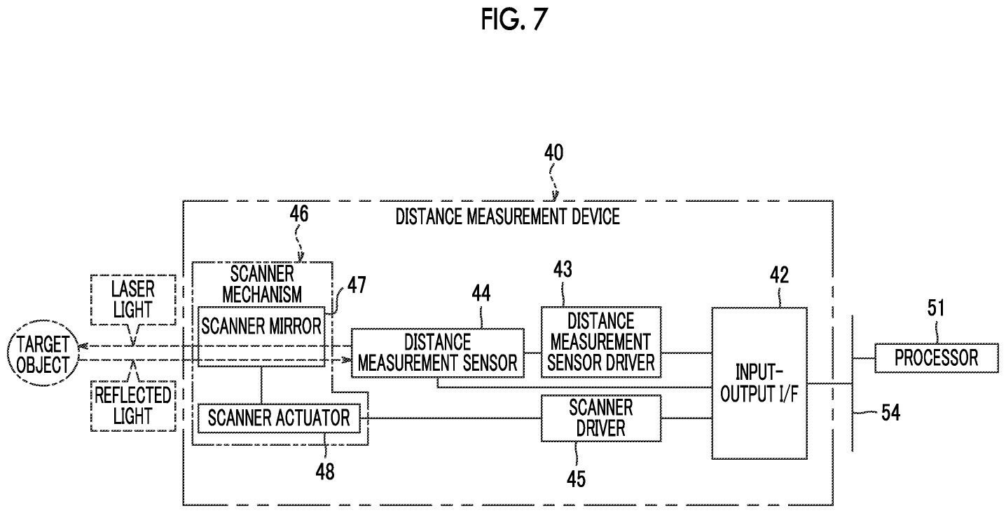

As illustrated in FIG. 7 as an example, the distance measurement device 40 comprises an input-output I/F 42, a distance measurement sensor driver 43, a distance measurement sensor 44, a scanner driver 45, and a scanner mechanism 46. The distance measurement sensor driver 43, the distance measurement sensor 44, and the scanner driver 45 are connected to the processor 51 through the input-output I/F 42 and through the bus 54.

The distance measurement sensor driver 43 controls the distance measurement sensor 44 in accordance with an instruction from the processor 51. The distance measurement sensor 44 has a laser light output function, a reflected light detection function, and a distance information output function. The laser light output function is a function of outputting laser light. The reflected light detection function is a function of detecting reflected light that is light after the laser light is reflected by the target object. The distance information output function is a function of outputting distance information (that is, information indicating a distance from the distance measurement sensor 44 to the target object) corresponding to a time period from output of the laser light to detection of the reflected light.

The scanner mechanism 46 is, for example, a galvano mirror scanner or a MEMS minor scanner and comprises a scanner minor 47 and a scanner actuator 48. The scanner mirror 47 reflects laser light. The target object (for example, the flying object 310 or the inspection target object 3 illustrated in FIG. 1) is irradiated with the laser light reflected by the scanner mirror 47. The scanner actuator 48 changes an angle of the scanner minor 47 by providing motive power to the scanner minor 47. Changing the angle of the scanner mirror 47 causes a reflection angle of the laser light reflected by the scanner mirror 47 to change in the horizontal direction. In addition, changing the reflection angle of the laser light reflected by the scanner minor 47 in the horizontal direction causes a position of the laser light with which the target object is irradiated to change in the horizontal direction. Accordingly, the target object is scanned with the laser light in the horizontal direction. Here, while scanning in the horizontal direction is illustrated, this is merely an example. Scanning in the vertical direction is also implemented based on the same principle.

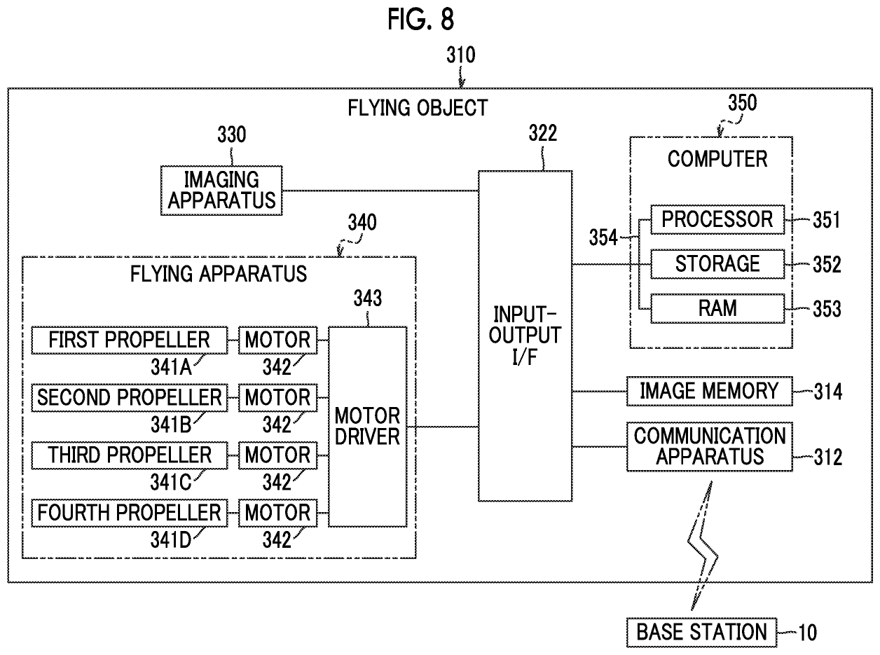

As illustrated in FIG. 8 as an example, the flying object 310 comprises the communication apparatus 312, an image memory 314, an input-output I/F 322, the imaging apparatus 330, a flying apparatus 340, and a computer 350.

The computer 350 comprises a processor 351, a storage 352, and a RAM 353. The processor 351, the storage 352, and the RAM 353 are connected to each other through a bus 354, and the bus 354 is connected to the input-output I/F 322. In addition, the communication apparatus 312, the image memory 314, and the imaging apparatus 330 are also connected to the input-output I/F 322. While one bus is illustrated as the bus 354 in the example illustrated in FIG. 8 for convenience of illustration, a plurality of buses may be used. The bus 354 may be a serial bus or may be a parallel bus including a data bus, an address bus, a control bus, and the like.

The processor 351, for example, includes a CPU and controls the entire flying object 310. Here, while an example in which the processor 351 includes a CPU is illustrated, this is merely an example. For example, the processor 351 may include a CPU and a GPU. In this case, for example, the GPU operates under control of the CPU and executes image processing.

The storage 352 is a non-volatile storage device that stores various programs, various parameters, and the like. Examples of the storage 352 include an HDD and an SSD. The HDD and the SSD are merely an example. A flash memory, a magnetoresistive memory, and/or a ferroelectric memory may be used instead of the HDD and/or the SDD or together with the HDD and/or the SSD.

The RAM 353 is a memory in which information is temporarily stored, and is used as a work memory by the processor 351. Examples of the RAM 353 include a DRAM and/or an SRAM.

The image memory 314 is, for example, an EEPROM. However, this is merely an example. An HDD and/or an SSD or the like may be applied as the image memory 314 instead of the EEPROM or together with the EEPROM. In addition, the image memory 314 may be a memory card. An image obtained by capturing via the imaging apparatus 330 is stored in the image memory 314.

The communication apparatus 312 is communicably connected to the base station 10. The communication apparatus 312 exchanges information with the base station 10. For example, the communication apparatus 312 transmits information corresponding to a request from the processor 351 to the base station 10. In addition, the communication apparatus 312 receives information transmitted from the base station 10 and outputs the received information to the processor 351 through the bus 354.

The flying apparatus 340 includes the first propeller 341A, the second propeller 341B, the third propeller 341C, the fourth propeller 341D, a plurality of motors 342, and a motor driver 343. The motor driver 343 is connected to the processor 351 through the input-output I/F 322 and through the bus 354. The motor driver 343 individually controls the plurality of motors 342 in accordance with an instruction from the processor 351. The number of the plurality of motors 342 is the same as the number of a plurality of propellers 341.

The first propeller 341A, the second propeller 341B, the third propeller 341C, and the fourth propeller 341D are fixed to rotation axes of each motor 342. In the following description, the first propeller 341A, the second propeller 341B, the third propeller 341C, and the fourth propeller 341D will be referred to as the propellers 341 unless otherwise required to distinguish among the first propeller 341A, the second propeller 341B, the third propeller 341C, and the fourth propeller 341D.

Each motor 342 rotates the propellers 341. Rotating the plurality of propellers 341 causes the flying object 310 to fly. The flying object 310 ascends in a case where rotation speeds per unit time of the plurality of propellers 341 are increased. The flying object 310 descends in a case where the rotation speeds per unit time (hereinafter, simply referred to as the “rotation speeds”) of the plurality of propellers 341 are decreased. In addition, in a state where propulsive force of the plurality of propellers 341 and gravity acting on the flying object 310 are balanced out, the flying object 310 stops in the air (that is, hovers). Furthermore, providing a difference among the rotation speeds of the plurality of propellers 341 causes the flying object 310 to roll, revolve, move forward, move rearward, and/or laterally move.

While the number of the plurality of propellers 341 comprised in the flying object body 320 is four as an example, this is merely an example. The number of the plurality of propellers 341 may be, for example, three or may be five or more.

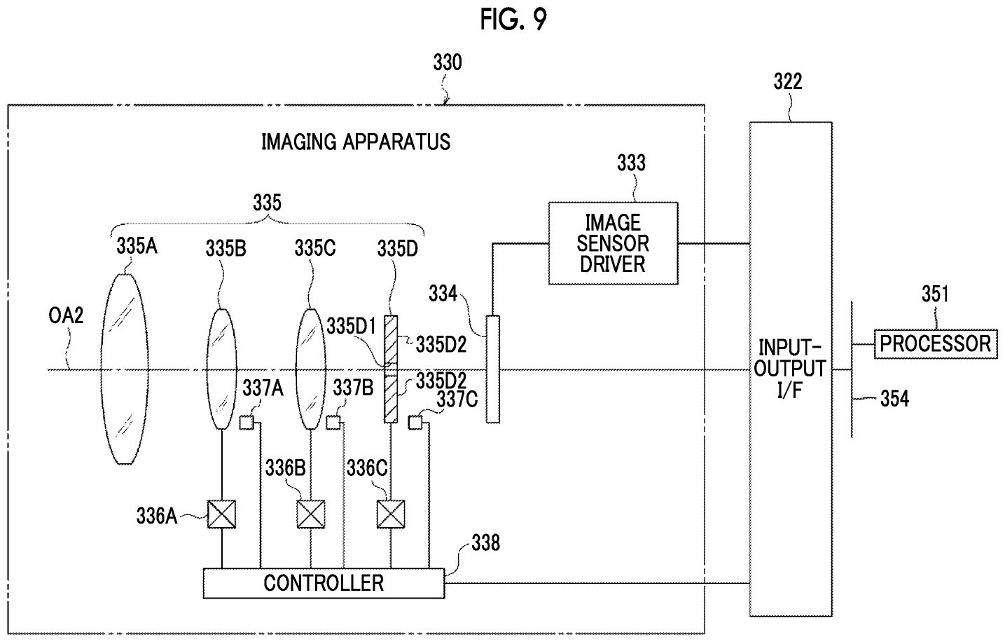

As illustrated in FIG. 9 as an example, the imaging apparatus 330 comprises an image sensor driver 333, an image sensor 334, an imaging lens 335, a first actuator 336A, a second actuator 336B, a third actuator 336C, a first sensor 337A, a second sensor 337B, a third sensor 337C, and a controller 338. The image sensor driver 333, the image sensor 334, and the controller 338 are connected to the processor 351 through the input-output I/F 322 and through the bus 354.

The image sensor driver 333 controls the image sensor 334 in accordance with an instruction from the processor 351. The image sensor 334 is, for example, a CMOS image sensor. Here, while the CMOS image sensor is illustrated as the image sensor 334, the disclosed technology is not limited thereto. Other image sensors may be used. The image sensor images the second subject (for example, the inspection target object 3 illustrated in FIG. 1 and FIG. 2) and outputs an image obtained by imaging to the processor 351 under control of the image sensor driver 333.

The imaging lens 335 includes an objective lens 335A, a focus lens 335B, a zoom lens 335C, and a stop 335D. The objective lens 335A, the focus lens 335B, the zoom lens 335C, and the stop 335D are disposed in an order of the objective lens 335A, the focus lens 335B, the zoom lens 335C, and the stop 335D from a subject side (object side) to an image sensor 334 side (image side) along the optical axis OA2 of the imaging apparatus 330.

The controller 338 controls the first actuator 336A, the second actuator 336B, and the third actuator 336C in accordance with an instruction from the processor 351. The controller 338 is an apparatus including a computer that includes, for example, a CPU, an NVM, and a RAM. Here, while the computer is illustrated, this is merely an example. A device including an ASIC, an FPGA, and/or a PLD may be applied. In addition, for example, an apparatus implemented by a combination of a hardware configuration and a software configuration may be used as the controller 338.

The first actuator 336A comprises a focus sliding mechanism (not illustrated) and a focus motor (not illustrated). The focus lens 335B is attached to the focus sliding mechanism in a slidable manner along the optical axis OA2. In addition, the focus motor is connected to the focus sliding mechanism, and the focus sliding mechanism operates by receiving motive power of the focus motor to move the focus lens 335B along the optical axis OA2.

The second actuator 336B comprises a zoom sliding mechanism (not illustrated) and a zoom motor (not illustrated). The zoom lens 335C is attached to the zoom sliding mechanism in a slidable manner along the optical axis OA2. In addition, the zoom motor is connected to the zoom sliding mechanism, and the zoom sliding mechanism operates by receiving motive power of the zoom motor to move the zoom lens 335C along the optical axis OA2.

Here, while an example of a form in which the focus sliding mechanism and the zoom sliding mechanism are separately provided is illustrated, this is merely an example. An integrated sliding mechanism that can implement both of focus and zoom may be used. In addition, in this case, motive power generated by one motor may be transmitted to the sliding mechanism without using the focus motor and the zoom motor.

The third actuator 336C comprises a motive power transmission mechanism (not illustrated) and an aperture stop motor (not illustrated). The stop 335D is a stop that includes an opening 335D1 and that has a variable size of the opening 335D1. The opening 335D1 is formed by a plurality of blades 335D2. The plurality of blades 335D2 are connected to the motive power transmission mechanism. In addition, the aperture stop motor is connected to the motive power transmission mechanism, and the motive power transmission mechanism transmits motive power of the aperture stop motor to the plurality of blades 335D2. The plurality of blades 335D2 operate by receiving the motive power transmitted from the motive power transmission mechanism to change the size of the opening 335D1. The stop 335D adjusts exposure by changing the size of the opening 335D1.

The focus motor, the zoom motor, and the aperture stop motor are connected to the controller 338, and driving of each of the focus motor, the zoom motor, and the aperture stop motor is controlled by the controller 338. Stepping motors, as an example, are employed in the focus motor, the zoom motor, and the aperture stop motor. Accordingly, the focus motor, the zoom motor, and the aperture stop motor operate in synchronization with a pulse signal in accordance with an instruction from the controller 338.

The first sensor 337A detects a position of the focus lens 335B on the optical axis OA2. Examples of the first sensor 337A include a potentiometer. A detection result of the first sensor 337A is acquired by the controller 338 and is output to the processor 351. The processor 351 adjusts the position of the focus lens 335B on the optical axis OA2 based on the detection result of the first sensor 337A.

The second sensor 337B detects a position of the zoom lens 335C on the optical axis OA2. Examples of the second sensor 337B include a potentiometer. A detection result of the second sensor 337B is acquired by the controller 338 and is output to the processor 351. The processor 351 adjusts the position of the zoom lens 335C on the optical axis OA2 based on the detection result of the second sensor 337B.

The third sensor 337C detects the size of the opening 335D1. Examples of the third sensor 337C include a potentiometer. A detection result of the third sensor 337C is acquired by the controller 338 and is output to the processor 351. The processor 351 adjusts the size of the opening 335D1 based on the detection result of the third sensor 337C.

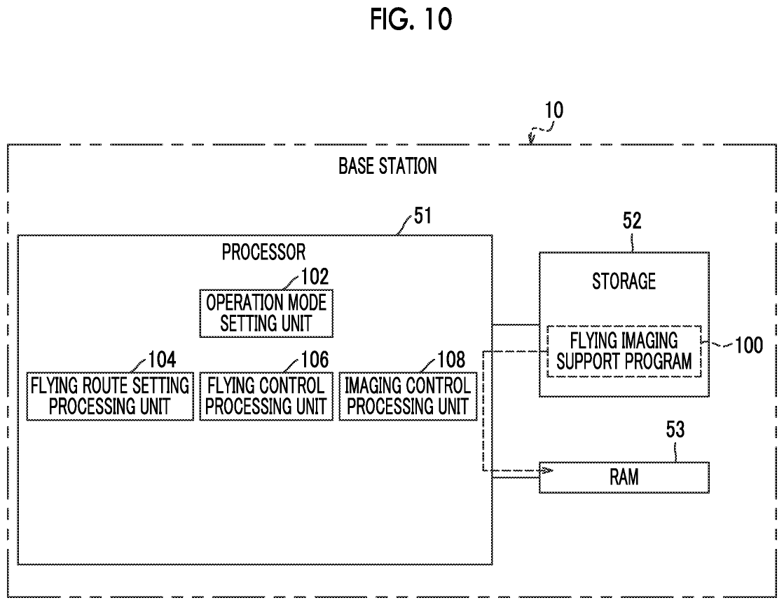

As illustrated in FIG. 10 as an example, a flying imaging support program 100 is stored in the storage 52 of the base station 10.

The processor 51 reads out the flying imaging support program 100 from the storage 52 and executes the read flying imaging support program 100 on the RAM 53. By executing the flying imaging support program 100, the processor 51 operates as an operation mode setting unit 102, a flying route setting processing unit 104, a flying control processing unit 106, and an imaging control processing unit 108.

The base station 10 has a flying route setting processing mode, a flying control processing mode, and an imaging control processing mode as operation modes. The operation mode setting unit 102 selectively sets the flying route setting processing mode, the flying control processing mode, and the imaging control processing mode as the operation mode of the base station 10. In a case where the operation mode of the base station 10 is set to the flying route setting processing mode by the operation mode setting unit 102, the processor 51 operates as the flying route setting processing unit 104. In a case where the operation mode of the base station 10 is set to the flying control processing mode by the operation mode setting unit 102, the processor 51 operates as the flying control processing unit 106. In a case where the operation mode of the base station 10 is set to the imaging control processing mode by the operation mode setting unit 102, the processor 51 operates as the imaging control processing unit 108.

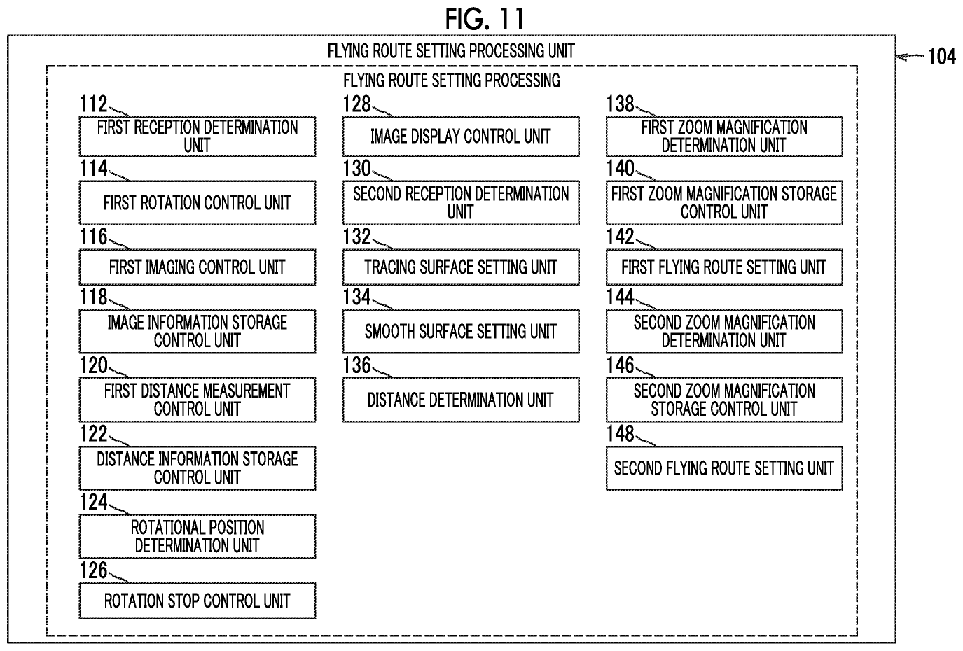

As illustrated in FIG. 11 as an example, the flying route setting processing unit 104 performs flying route setting processing. The flying route setting processing is processing performed by the flying route setting processing unit 104 in a case where the operation mode of the base station 10 is set to the flying route setting processing mode. The flying route setting processing unit 104 includes a first reception determination unit 112, a first rotation control unit 114, a first imaging control unit 116, an image information storage control unit 118, a first distance measurement control unit 120, a distance information storage control unit 122, a rotational position determination unit 124, a rotation stop control unit 126, an image display control unit 128, a second reception determination unit 130, a tracing surface setting unit 132, a smooth surface setting unit 134, a distance determination unit 136, a first zoom magnification determination unit 138, a first zoom magnification storage control unit 140, a first flying route setting unit 142, a second zoom magnification determination unit 144, a second zoom magnification storage control unit 146, and a second flying route setting unit 148.

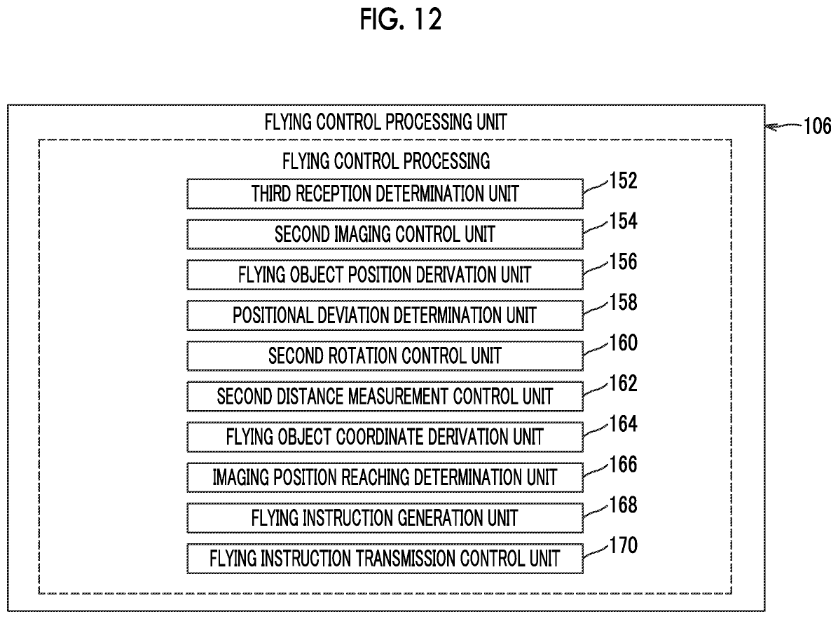

As illustrated in FIG. 12 as an example, the flying control processing unit 106 performs flying control processing. The flying control processing is processing performed by the flying control processing unit 106 in a case where the operation mode of the base station 10 is set to the flying control processing mode. The flying control processing unit 106 includes a third reception determination unit 152, a second imaging control unit 154, a flying object position derivation unit 156, a positional deviation determination unit 158, a second rotation control unit 160, a second distance measurement control unit 162, a flying object coordinate derivation unit 164, an imaging position reaching determination unit 166, a flying instruction generation unit 168, and a flying instruction transmission control unit 170.

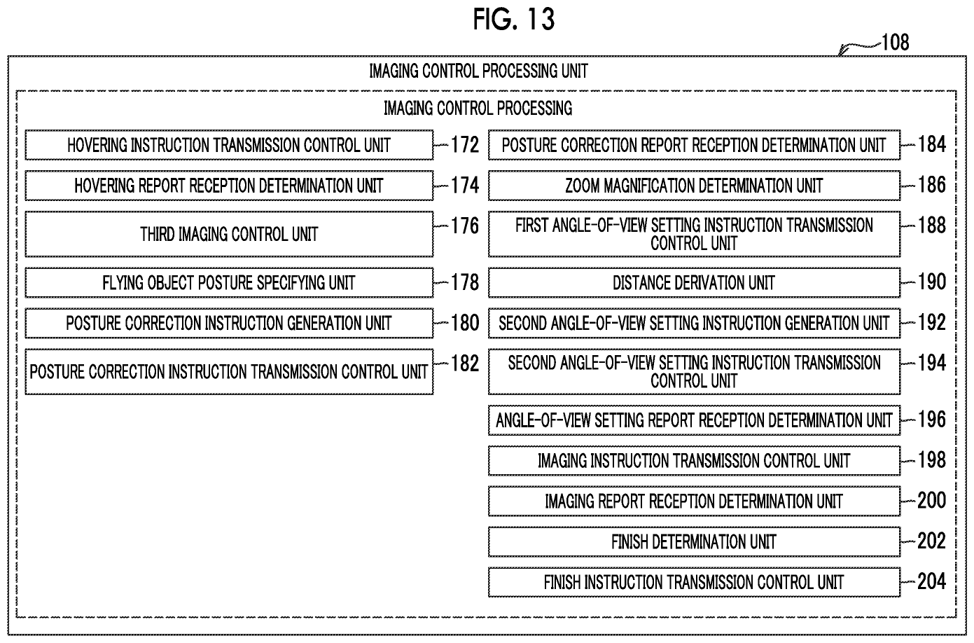

As illustrated in FIG. 13 as an example, the imaging control processing unit 108 performs imaging control processing. The imaging control processing is processing performed by the imaging control processing unit 108 in a case where the operation mode of the base station 10 is set to the imaging control processing mode. The imaging control processing unit 108 includes a hovering instruction transmission control unit 172, a hovering report reception determination unit 174, a third imaging control unit 176, a flying object posture specifying unit 178, a posture correction instruction generation unit 180, a posture correction instruction transmission control unit 182, a posture correction report reception determination unit 184, a zoom magnification determination unit 186, a first angle-of-view setting instruction transmission control unit 188, a distance derivation unit 190, a second angle-of-view setting instruction generation unit 192, a second angle-of-view setting instruction transmission control unit 194, an angle-of-view setting report reception determination unit 196, an imaging instruction transmission control unit 198, an imaging report reception determination unit 200, a finish determination unit 202, and a finish instruction transmission control unit 204.

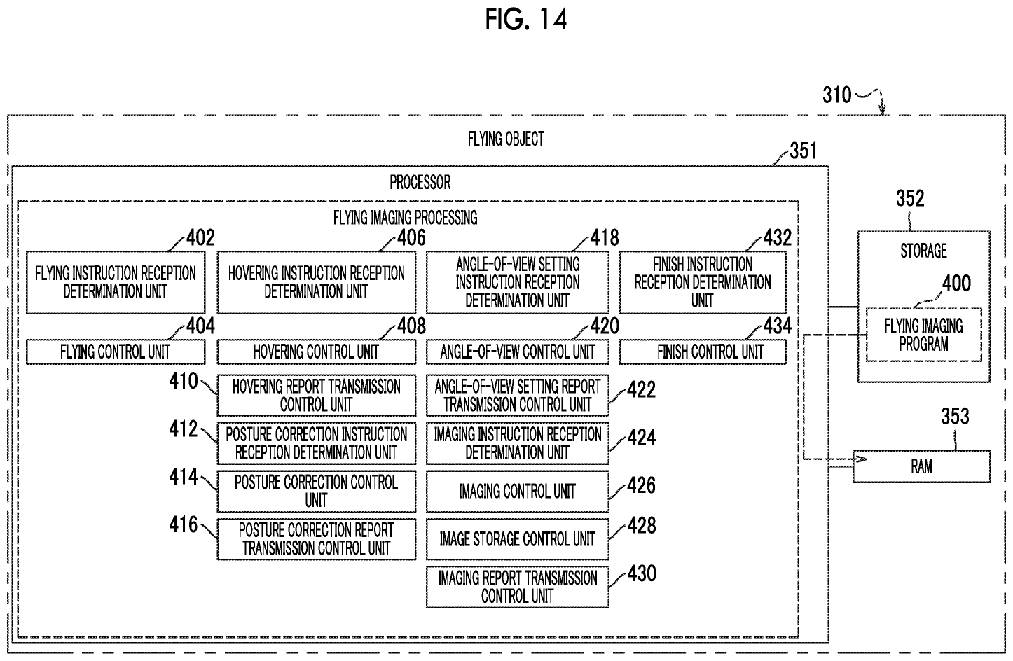

As illustrated in FIG. 14 as an example, a flying imaging program 400 is stored in the storage 352 of the flying object 310.

The processor 351 reads out the flying imaging program 400 from the storage 352 and executes the read flying imaging program 400 on the RAM 353. The processor 351 performs flying imaging processing in accordance with the flying imaging program 400 executed on the RAM 353. By executing the flying imaging program 400, the processor 351 operates as a flying instruction reception determination unit 402, a flying control unit 404, a hovering instruction reception determination unit 406, a hovering control unit 408, a hovering report transmission control unit 410, a posture correction instruction reception determination unit 412, a posture correction control unit 414, a posture correction report transmission control unit 416, an angle-of-view setting instruction reception determination unit 418, an angle-of-view control unit 420, an angle-of-view setting report transmission control unit 422, an imaging instruction reception determination unit 424, an imaging control unit 426, an image storage control unit 428, an imaging report transmission control unit 430, a finish instruction reception determination unit 432, and a finish control unit 434.

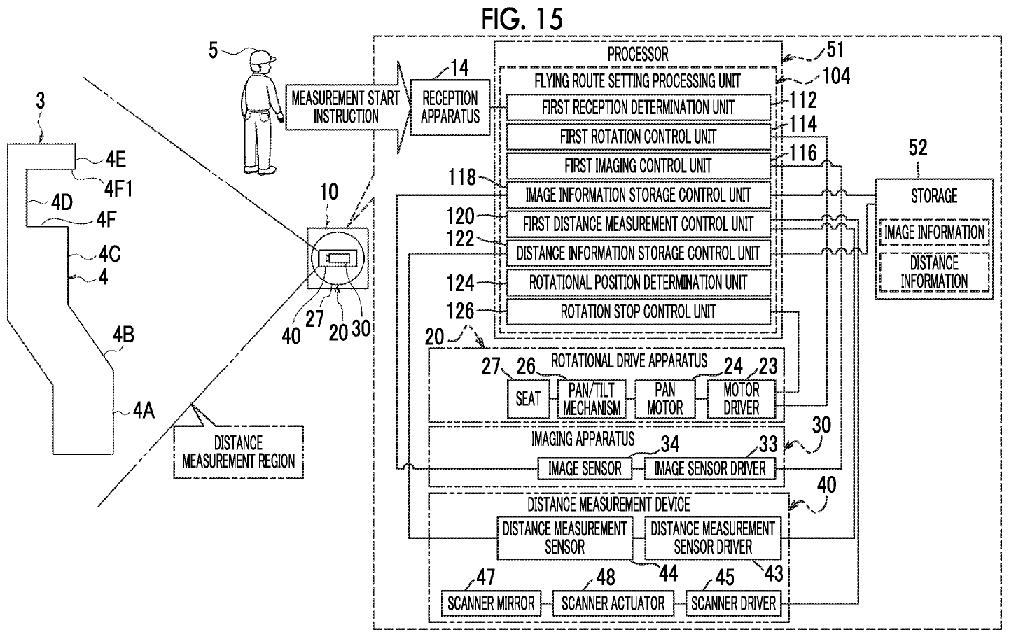

As illustrated in FIG. 15 as an example, the inspection target object 3 has a wall surface 4. Hereinafter, an example of inspecting the wall surface 4 will be described as an example. The wall surface 4 is an example of a “surface” according to the embodiment of the disclosed technology. The wall surface 4 has a first surface 4A, a second surface 4B, a third surface 4C, a fourth surface 4D, and a fifth surface 4E.

The base station 10 is installed at a position where the wall surface 4 can be imaged by the imaging apparatus 30 and where a distance between the wall surface 4 and the distance measurement device 40 can be measured by the distance measurement device 40. The following description assumes that the wall surface 4 falls within a distance measurement region of the distance measurement device 40 as an example.

The distance measurement region is a region in which the wall surface 4 is scanned a plurality of times by the distance measurement device 40 while the seat 27 is rotated from a first rotational position to a second rotational position. In the distance measurement region, the wall surface 4 is imaged a plurality of times by the imaging apparatus 30.

All of the first surface 4A, the second surface 4B, the third surface 4C, the fourth surface 4D, and the fifth surface 4E face the base station 10. The second surface 4B is positioned between the first surface 4A and the third surface 4C. The second surface 4B is inclined with respect to the first surface 4A and to the third surface 4C. The second surface 4B is an inclined surface of which a distance from the base station 10 is increased from a first surface 4A side toward a third surface 4C side. The third surface 4C is positioned on a side more separated from the base station 10 than the first surface 4A.

The wall surface 4 of the inspection target object 3 has a recessed portion 4F. The recessed portion 4F has an opening portion 4F1 that is open on a base station 10 side. As an example, an area of the opening portion 4F1 is less than an area through which the flying object 310 can enter inside the recessed portion 4F. As an example, the recessed portion 4F is formed from a lower end to an upper end of the inspection target object 3. The recessed portion 4F is formed between the third surface 4C and the fifth surface 4E, and the fourth surface 4D is formed by a bottom surface of the recessed portion 4F. The fourth surface 4D is positioned on a side more separated from the base station 10 than the third surface 4C and than the fifth surface 4E, and the fifth surface 4E is positioned on a side closer to the base station 10 than the third surface 4C. The first surface 4A, the third surface 4C, the fourth surface 4D, and the fifth surface 4E are surfaces that are parallel to each other. The following description assumes that all of the first surface 4A, the second surface 4B, the third surface 4C, the fourth surface 4D, and the fifth surface 4E are planes parallel to the vertical direction.

A worker 5 provides a measurement start instruction to the reception apparatus 14. In the base station 10, the first reception determination unit 112 determines whether or not the measurement start instruction is received by the reception apparatus 14.

In a case where the first reception determination unit 112 determines that the measurement start instruction is received by the reception apparatus 14, the first rotation control unit 114 performs a control of rotating the seat 27 from the first rotational position toward the second rotational position that is a position different from the first rotational position via the rotational drive apparatus 20. Specifically, the first rotation control unit 114 rotates the seat 27 from the first rotational position toward the second rotational position by operating the pan motor 24 through the motor driver 23 of the rotational drive apparatus 20. Accordingly, the imaging apparatus 30 and the distance measurement device 40 attached to the seat 27 start rotating in the horizontal direction.

The first imaging control unit 116 performs a control of imaging the wall surface 4 via the imaging apparatus 30. Specifically, the first imaging control unit 116 causes the image sensor 34 to image the wall surface 4 through the image sensor driver 33 of the imaging apparatus 30. In this case, the imaging apparatus 30 images a part of the wall surface 4 in the horizontal direction. Accordingly, an image is obtained by imaging the part of the wall surface 4 in the horizontal direction via the imaging apparatus 30.

A rotation detector (not illustrated) is provided in the pan/tilt mechanism 26 and/or the seat 27, and a rotational position of the seat 27 (hereinafter, simply referred to as the “rotational position”) is detected by the rotation detector. The image information storage control unit 118 generates image information based on the image obtained by capturing via the imaging apparatus 30 and on the rotational position detected by the rotation detector and stores the image information in the storage 52. For example, the image information is information in which the image obtained by capturing via the imaging apparatus 30 is associated with the rotational position detected by the rotation detector.

The first distance measurement control unit 120 performs a control of scanning the wall surface 4 with the laser light via the distance measurement device 40. Specifically, the first distance measurement control unit 120 outputs the laser light from the distance measurement sensor 44 and causes the distance measurement sensor 44 to detect the reflected light of the laser light reflected by the wall surface 4 by controlling the distance measurement sensor 44 through the distance measurement sensor driver 43 of the distance measurement device 40. In addition, the first distance measurement control unit 120 changes the position of the laser light in the horizontal direction by controlling the scanner actuator 48 through the scanner driver 45 of the distance measurement device 40 to rotate the scanner mirror 47. In this case, the distance measurement device 40 scans a part of the wall surface 4 in the horizontal direction. Accordingly, the distance between the wall surface 4 and the distance measurement device 40 is measured by scanning the part of the wall surface 4 in the horizontal direction via the distance measurement device 40. During scanning of the distance measurement device 40 performed once, the distance between the wall surface 4 and the distance measurement device 40 is measured at a plurality of distance measurement locations in the part of the wall surface 4 in the horizontal direction. The distance between the wall surface 4 and the distance measurement device 40 is an example of a “first distance” according to the embodiment of the disclosed technology.

An angle detector (not illustrated) is provided in the scanner mirror 47, and a rotational angle of the scanner mirror 47 (hereinafter, simply referred to as the “rotational angle”) is detected by the angle detector. The distance information storage control unit 122 generates the distance information based on the distance measured for each distance measurement location, the rotational position detected by the rotation detector, and the rotational angle detected by the angle detector and stores the distance information in the storage 52. For example, the distance information is information in which the distance measured for each distance measurement location is associated with the rotational position detected by the rotation detector and with the rotational angle detected by the angle detector.

The rotational position determination unit 124 determines whether or not the rotational position of the seat 27 has reached the second rotational position. The rotational position determination unit 124 determines whether or not the rotational position of the seat 27 has reached the second rotational position by, for example, comparing the rotational position detected by the rotation detector and the position of the second rotational position with each other. In a case where the rotational position determination unit 124 determines that the rotational position of the seat 27 has not reached the second rotational position, the above controls of the first imaging control unit 116, the image information storage control unit 118, the first distance measurement control unit 120, and the distance information storage control unit 122 are executed.

By repeatedly executing the above controls of the first imaging control unit 116 and the image information storage control unit 118 while the rotational position of the seat 27 reaches the second rotational position, a plurality of imaged regions of the wall surface 4 are continuously imaged in order from a first end part side to a second end part side of the wall surface 4. The image information corresponding to each imaged region is stored in the storage 52. In addition, by repeatedly executing the above controls of the first distance measurement control unit 120 and the distance information storage control unit 122 while the rotational position of the seat 27 reaches the second rotational position, each of a plurality of distance measurement regions of the wall surface 4 is continuously scanned with the laser light in order from the first end part side to the second end part side of the wall surface 4. The distance information corresponding to each distance measurement region is stored in the storage 52.

In a case where the rotational position determination unit 124 determines that the rotational position of the seat 27 has reached the second rotational position, the rotation stop control unit 126 performs a control of stopping rotation of the seat 27 via the rotational drive apparatus 20. Specifically, the rotation stop control unit 126 stops rotation of the seat 27 by stopping rotation of the pan motor 24 through the motor driver 23 of the rotational drive apparatus 20.

According to the above, the image information and the distance information corresponding to the wall surface 4 are obtained by imaging the wall surface 4 a plurality of times via the imaging apparatus 30 and by scanning the wall surface 4 a plurality of times via the distance measurement device 40 while the seat 27 rotates from the first rotational position to the second rotational position.

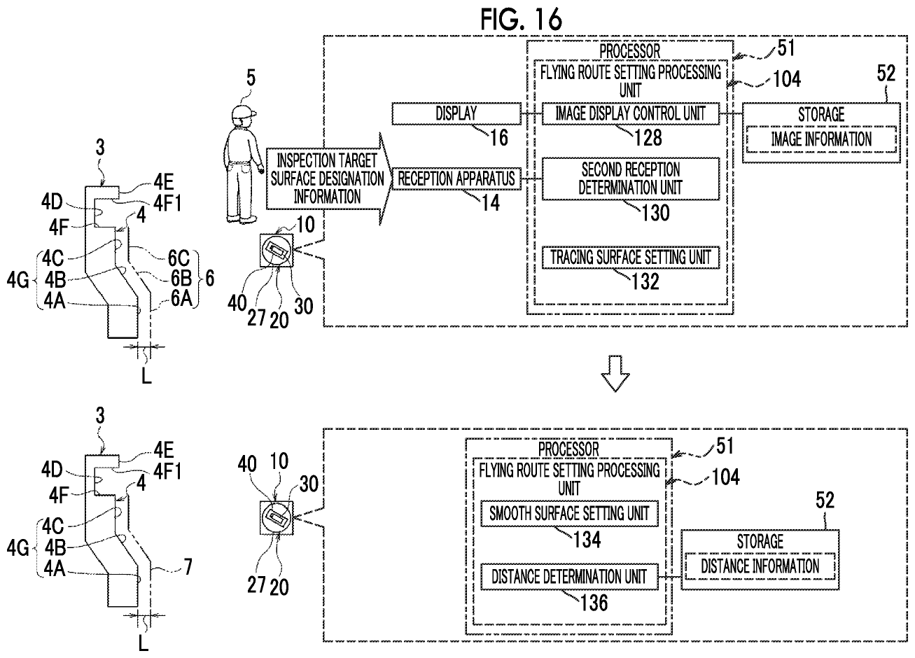

As illustrated in FIG. 16 as an example, in the base station 10, the image display control unit 128 performs a control of displaying an image (that is, an image in which the wall surface 4 is represented as an image) on the display 16 based on the image information stored in the storage 52. In this case, the image display control unit 128 displays images (here, as an example, images that are electronic images) corresponding to the first surface 4A, the second surface 4B, the third surface 4C, the fourth surface 4D, and the fifth surface 4E next to each other on the display 16 based on the rotational position included in the image information in accordance with the first surface 4A, the second surface 4B, the third surface 4C, the fourth surface 4D, and the fifth surface 4E.

The worker 5 determines an inspection target surface 4G to be inspected by the flying object 310 from the first surface 4A, the second surface 4B, the third surface 4C, the fourth surface 4D, and the fifth surface 4E based on the images displayed on the display 16 (for example, with visual reference to the images). The worker 5 provides inspection target surface designation information indicating designation of the inspection target surface 4G to the reception apparatus 14. The second reception determination unit 130 determines whether or not the inspection target surface designation information is received by the reception apparatus 14.

In a case where the second reception determination unit 130 determines that the inspection target surface designation information is received by the reception apparatus 14, the tracing surface setting unit 132 sets a tracing surface 6 based on the inspection target surface designation information. The tracing surface 6 is a surface that is separated by a predetermined distance L from the inspection target surface 4G in a normal direction of the inspection target surface 4G and that traces the inspection target surface 4G (that is, a virtual surface along the inspection target surface 4G). The predetermined distance L is a distance in which the inspection target surface 4G is included within a depth of field of the imaging apparatus 330 of the flying object 310 and is a distance set in advance. As an example, the predetermined distance L is set to 1 m to 3 m.

In the example illustrated in FIG. 16 as an example, the first surface 4A, the second surface 4B, and the third surface 4C are designated as the inspection target surface 4G by the worker 5. Accordingly, in the example illustrated in FIG. 16, the tracing surface 6 having a first tracing surface 6A that traces the first surface 4A, a second tracing surface 6B that traces the second surface 4B, and a third tracing surface 6C that traces the third surface 4C is set by the tracing surface setting unit 132. The first tracing surface 6A is a surface separated by the predetermined distance L from the first surface 4A. The second tracing surface 6B is a surface separated by the predetermined distance L from the second surface 4B. The third tracing surface 6C is a surface separated by the predetermined distance L from the third surface 4C.

The smooth surface setting unit 134 sets a smooth surface 7 (that is, a smooth virtual plane facing the wall surface 4) by smoothing the tracing surface 6. For example, “smooth” refers to an aspect of being smooth and not rough without a discontinuous location. In addition, “smoothing” is implemented by decreasing a degree of bending of the tracing surface 6 to a degree designated as an allowable degree. In a case where the tracing surface 6 is originally smooth, smoothing the tracing surface 6 means replacing the tracing surface 6 with the smooth surface 7. As an example, the smooth surface setting unit 134 sets the smooth surface 7 that satisfies a first condition and a second condition below. That is, the first condition is a condition that a surface that passes through at least any surface of a plurality of surfaces forming the tracing surface 6 and that faces the inspection target surface 4G is set as the smooth surface 7. The second condition is a condition that a surface for which all of distances between the plurality of surfaces forming the inspection target surface 4G and the smooth surface 7 are greater than or equal to the predetermined distance L is set as the smooth surface 7.

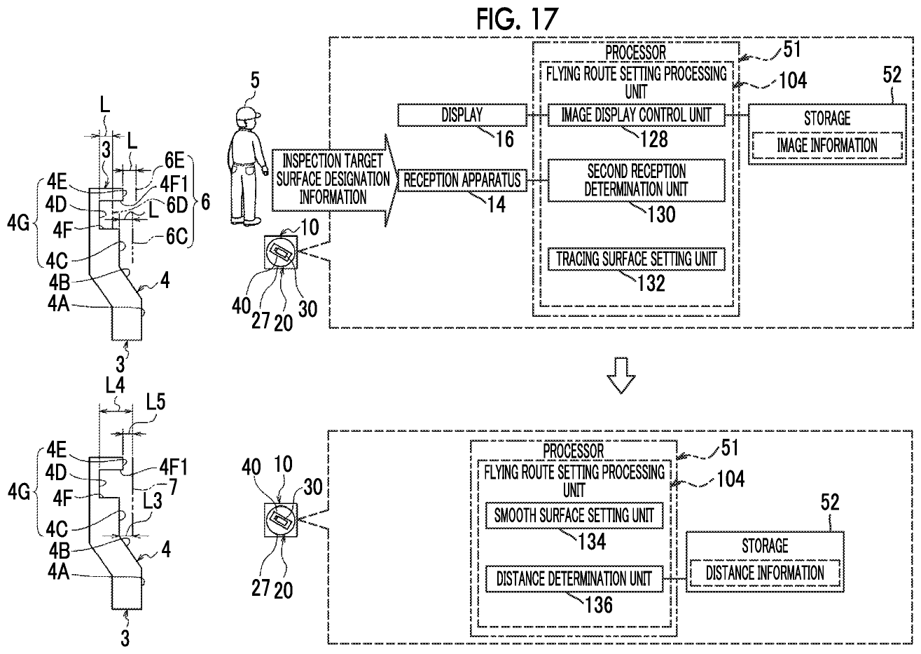

For example, in the example illustrated in FIG. 16, the smooth surface 7 that passes through the first tracing surface 6A, the second tracing surface 6B, and the third tracing surface 6C and that faces the inspection target surface 4G is set as the smooth surface 7 satisfying the first condition and the second condition. On the other hand, the example illustrated in FIG. 17 as an example is an example in which the third surface 4C, the fourth surface 4D, and the fifth surface 4E are designated as the inspection target surface 4G by the worker 5. In the example illustrated in FIG. 17, the tracing surface 6 having the third tracing surface 6C that traces the third surface 4C, a fourth tracing surface 6D that traces the fourth surface 4D, and a fifth tracing surface 6E that traces the fifth surface 4E is set by the tracing surface setting unit 132. The third tracing surface 6C is a surface separated by the predetermined distance L from the third surface 4C. The fourth tracing surface 6D is a surface separated by the predetermined distance L from the fourth surface 4D. The fifth tracing surface 6E is a surface separated by the predetermined distance L from the fifth surface 4E. In addition, in the example illustrated in FIG. 17, the smooth surface 7 that passes through the fifth tracing surface 6E and that faces the inspection target surface 4G is set as the smooth surface 7 satisfying the first condition and the second condition.

The distance determination unit 136 determines whether or not a distance between the inspection target surface 4G and the smooth surface 7 is constant based on the distance information stored in the storage 52. For example, in the example illustrated in FIG. 16, the distance between the inspection target surface 4G and the smooth surface 7 is constant as the predetermined distance L. Accordingly, in the example illustrated in FIG. 16, the distance determination unit 136 determines that the distance between the inspection target surface 4G and the smooth surface 7 is constant. On the other hand, for example, in the example illustrated in FIG. 17, the distance between the inspection target surface 4G and the smooth surface 7 is not constant. That is, a distance L4 between the fourth surface 4D that is the bottom surface of the recessed portion 4F and the smooth surface 7 is longer than a distance L3 between the third surface 4C and the smooth surface 7. In addition, the distance L4 between the fourth surface 4D that is the bottom surface of the recessed portion 4F and the smooth surface 7 is longer than a distance L5 between the fifth surface 4E and the smooth surface 7. Accordingly, in the example illustrated in FIG. 17, the distance determination unit 136 determines that the distance between the inspection target surface 4G and the smooth surface 7 is not constant.

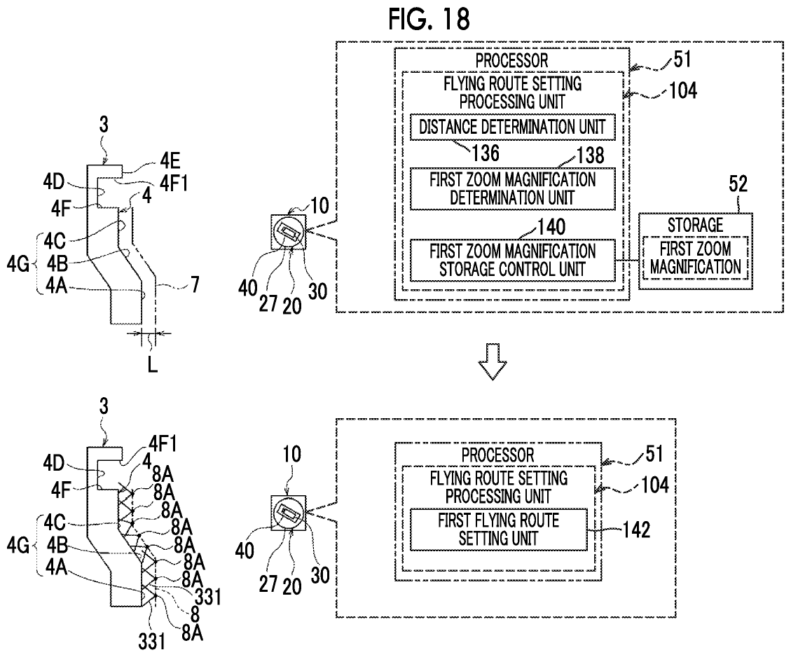

The example illustrated in FIG. 18 is an example in which the distance between the inspection target surface 4G and the smooth surface 7 is constant as the predetermined distance L, as in the example illustrated in FIG. 16. As illustrated in FIG. 18 as an example, in the base station 10, in a case where the distance determination unit 136 determines that the distance between the inspection target surface 4G and the smooth surface 7 is constant, the first zoom magnification determination unit 138 determines a zoom magnification of the imaging apparatus 330 (refer to FIG. 1) of the flying object 310 as a first zoom magnification. As an example, the first zoom magnification is a zoom magnification at which pixel resolution of the imaging apparatus 330 has a predetermined value in the case of imaging the inspection target surface 4G via the imaging apparatus 330 from a position separated by the predetermined distance L from the inspection target surface 4G.

The pixel resolution of the imaging apparatus 330 corresponds to a size of a visual field per pixel of the image sensor 334 comprised in the imaging apparatus 330. The size of the visual field corresponds to a range in which the subject is actually imaged. The predetermined value related to the pixel resolution is set to a value with which whether or not the inspection target surface 4G is damaged and/or the degree or the like of damage may be inspected in a case where the image analysis processing is executed by the image analysis apparatus 2 (refer to FIG. 1) with respect to the image obtained by imaging the inspection target surface 4G.

The first zoom magnification storage control unit 140 stores the first zoom magnification determined by the first zoom magnification determination unit 138 in the storage 52.

The first flying route setting unit 142 sets a flying route 8 that passes through a plurality of imaging positions 8A by setting the plurality of imaging positions 8A on the smooth surface 7 based on the first zoom magnification determined by the first zoom magnification determination unit 138. The plurality of imaging positions 8A are positions at which the inspection target surface 4G is imaged by the imaging apparatus 330 (refer to FIG. 1) of the flying object 310.

As an example, in the case of imaging the inspection target surface 4G at the first zoom magnification determined by the first zoom magnification determination unit 138, the first flying route setting unit 142 sets the flying route 8 passing through the plurality of imaging positions 8A by setting the plurality of imaging positions 8A at positions where imaging ranges 331 of the imaging apparatus 330 partially overlap with each other at adjacent imaging positions 8A among the plurality of imaging positions 8A. By setting the plurality of imaging positions 8A at the positions where the imaging ranges 331 of the imaging apparatus 330 partially overlap with each other at the adjacent imaging positions 8A among the plurality of imaging positions 8A, images obtained by capturing via the imaging apparatus 330 partially overlap with each other each time each of the plurality of imaging positions 8A is reached, as will be described later. The plurality of imaging positions 8A are an example of a “first imaging position” according to the embodiment of the disclosed technology.

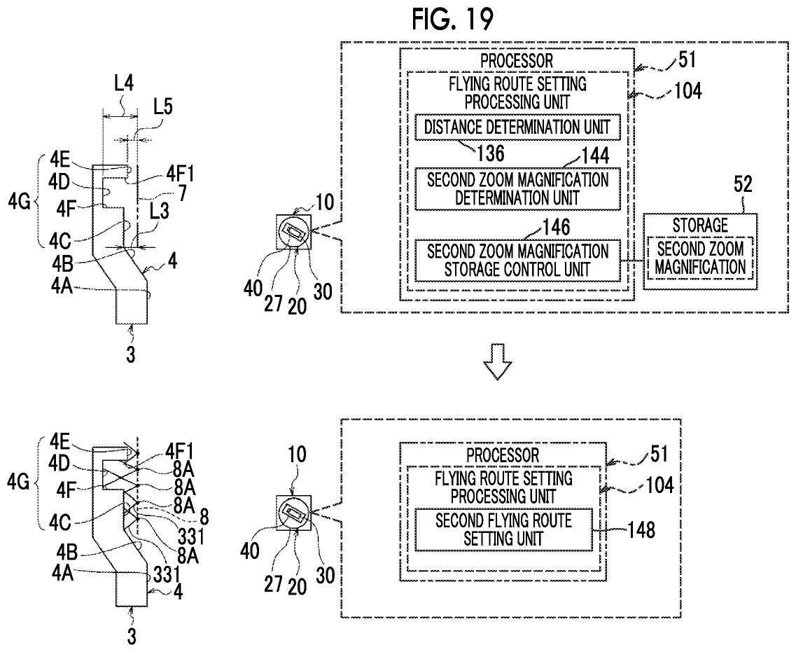

The example illustrated in FIG. 19 is an example in which the distance between the inspection target surface 4G and the smooth surface 7 is not constant, as in the example illustrated in FIG. 17. As illustrated in FIG. 19 as an example, in the base station 10, in a case where the distance determination unit 136 determines that the distance between the inspection target surface 4G and the smooth surface 7 is not constant, the second zoom magnification determination unit 144 determines the zoom magnification of the imaging apparatus 330 (refer to FIG. 1) of the flying object 310 as a second zoom magnification. As an example, the second zoom magnification is a zoom magnification at which the pixel resolution of the imaging apparatus 330 has the predetermined value in the case of imaging the inspection target surface 4G via the imaging apparatus 330 from a position separated by a shortest distance between the inspection target surface 4G and the smooth surface 7 (in this case, the distance L5 between the fifth surface 4E and the smooth surface 7).

The second zoom magnification storage control unit 146 stores the second zoom magnification determined by the second zoom magnification determination unit 144 in the storage 52.

The second flying route setting unit 148 sets the flying route 8 passing through the plurality of imaging positions 8A by setting the plurality of imaging positions 8A on the smooth surface 7 based on the second zoom magnification determined by the second zoom magnification determination unit 144. In a case where the flying object 310 flies along the flying route 8 set by the second flying route setting unit 148, the pixel resolution of the imaging apparatus 330 is controlled to be constantly maintained by adjusting the second zoom magnification determined by the second zoom magnification determination unit 144 in accordance with a distance between the inspection target surface 4G and the imaging position 8A, as will be described later.

As an example, even in the case of adjusting the second zoom magnification determined by the second zoom magnification determination unit 144 in accordance with the distance between the inspection target surface 4G and the imaging position 8A, the second flying route setting unit 148 sets the flying route 8 passing through the plurality of imaging positions 8A by setting the plurality of imaging positions 8A at the positions where the imaging ranges 331 of the imaging apparatus 330 partially overlap with each other at the adjacent imaging positions 8A among the plurality of imaging positions 8A. By setting the plurality of imaging positions 8A at the positions where the imaging ranges 331 of the imaging apparatus 330 partially overlap with each other at the adjacent imaging positions 8A among the plurality of imaging positions 8A, the images obtained by capturing via the imaging apparatus 330 partially overlap with each other each time each of the plurality of imaging positions 8A is reached, as will be described later.

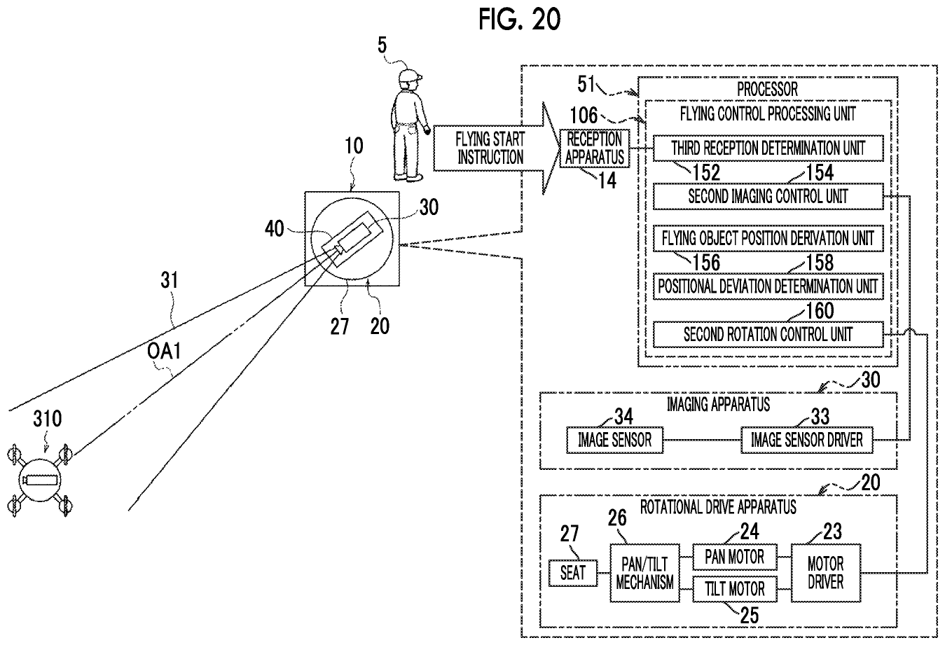

As illustrated in FIG. 20 as an example, the flying object 310 is disposed within the imaging range 31 of the imaging apparatus 30 of the base station 10. The worker 5 provides a flying start instruction to the reception apparatus 14 in a stage where the flying object 310 is in a state of being able to start flying. In the base station 10, the third reception determination unit 152 determines whether or not the flying start instruction is received by the reception apparatus 14.

In a case where the third reception determination unit 152 determines that the flying start instruction is received by the reception apparatus 14, the second imaging control unit 154 performs a control of capturing the imaging scene including the flying object 310 via the imaging apparatus 30. Specifically, the second imaging control unit 154 causes the image sensor 34 to capture the imaging scene including the flying object 310 through the image sensor driver 33 of the imaging apparatus 30. Accordingly, an image is obtained by capturing the imaging scene including the flying object 310 via the imaging apparatus 30. In this case, the image obtained by capturing the imaging scene including the flying object 310 is an example of a “second image” according to the embodiment of the disclosed technology.

The flying object position derivation unit 156 derives a position, within the image, of the flying object 310 included as an image in the image by executing object recognition processing with respect to the image obtained by capturing the imaging scene including the flying object 310 via the imaging apparatus 30.

The positional deviation determination unit 158 determines whether or not the position of the flying object 310 deviates from the center portion of the angle of view of the imaging apparatus 30 based on the position of the flying object 310 within the image derived by the flying object position derivation unit 156.

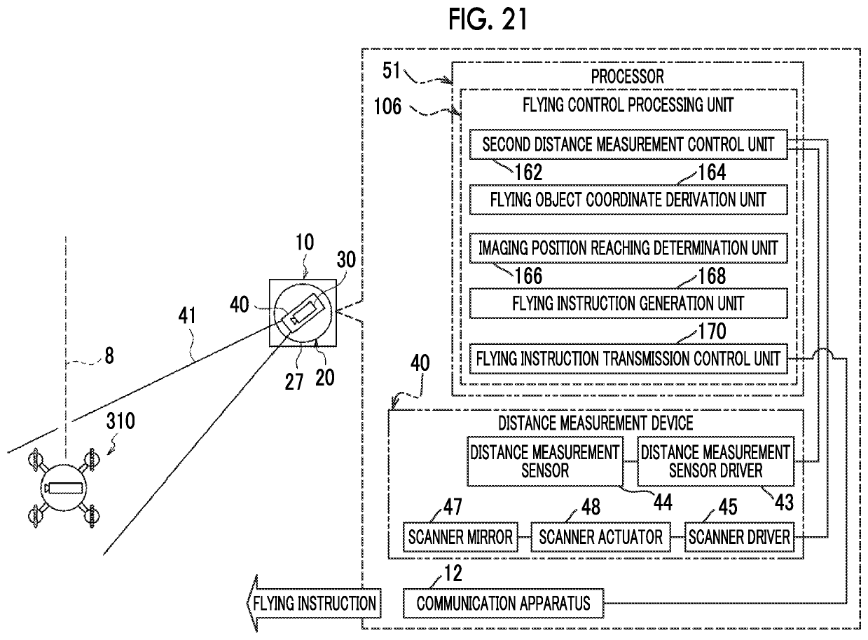

In a case where it is determined that the position of the flying object 310 deviates from the center portion of the angle of view of the imaging apparatus 30, the second rotation control unit 160 performs a control of adjusting a rotational angle in the horizontal direction and/or a rotational angle in the vertical direction of the rotational drive apparatus 20 to an angle at which the flying object 310 is positioned in the center portion of the angle of view of the imaging apparatus 30. Specifically, the second rotation control unit 160 adjusts the rotational angle in the horizontal direction and/or the rotational angle in the vertical direction of the rotational drive apparatus 20 to the angle at which the flying object 310 is positioned in the center portion of the angle of view of the imaging apparatus 30 by controlling the pan motor 24 and/or the tilt motor 25 through the motor driver 23 of the rotational drive apparatus 20. Accordingly, the flying object 310 is included in the center portion of the distance measurement range 41 (refer to FIG. 21) of the distance measurement device 40.

Hereinafter, the rotational angle in the horizontal direction and/or the rotational angle in the vertical direction of the rotational drive apparatus 20 will be referred to as the rotational angle of the rotational drive apparatus 20. In this case, the rotational angle of the rotational drive apparatus 20 is an example of a “second rotational angle” according to the embodiment of the disclosed technology.

As illustrated in FIG. 21 as an example, in the base station 10, the second distance measurement control unit 162 performs a control of scanning the distance measurement range 41 with the laser light via the distance measurement device 40. Specifically, the second distance measurement control unit 162 outputs the laser light from the distance measurement sensor 44 and causes the distance measurement sensor 44 to detect the reflected light of the laser light reflected by an object (in this case, for example, the flying object 310 and other objects) included in the distance measurement range 41 by controlling the distance measurement sensor 44 through the distance measurement sensor driver 43 of the distance measurement device 40. In addition, the second distance measurement control unit 162 changes the position of the laser light in the horizontal direction by controlling the scanner actuator 48 through the scanner driver 45 of the distance measurement device 40 to rotate the scanner minor 47. Accordingly, the distance measurement range 41 is scanned by the distance measurement device 40. A distance between the object and the distance measurement device 40 is measured by scanning the distance measurement range 41 via the distance measurement device 40.

During scanning of the distance measurement device 40 performed once, the distance between the object and the distance measurement device 40 is measured at a plurality of distance measurement locations of the distance measurement range 41. In this case, since the flying object 310 is positioned within the distance measurement range 41 of the distance measurement device 40, a distance between the flying object 310 and the distance measurement device 40 is measured by the distance measurement device 40.

The flying object coordinate derivation unit 164 derives absolute coordinates of the flying object 310 based on absolute coordinates of the rotational drive apparatus 20, the rotational angle of the rotational drive apparatus 20, an angle of the laser light emitted from the distance measurement device 40 toward the flying object 310, and the distance between the flying object 310 and the distance measurement device 40. Absolute coordinates are coordinates measured from an origin of a coordinate system (here, for example, an absolute coordinate system set at a fixed point on the imaging system S). The absolute coordinates of the rotational drive apparatus 20 are an example of “first absolute coordinates” according to the embodiment of the disclosed technology. The absolute coordinates of the flying object 310 are an example of “second absolute coordinates” according to the embodiment of the disclosed technology. In this case, the flying object coordinate derivation unit 164 acquires the absolute coordinates of the rotational drive apparatus 20, the rotational angle of the rotational drive apparatus 20, the angle of the laser light emitted from the distance measurement device 40 toward the flying object 310, and the distance between the flying object 310 and the distance measurement device 40 in the following manner.

That is, the flying object coordinate derivation unit 164 acquires the distance between the flying object 310 and the distance measurement device 40 from the distance information obtained by scanning the distance measurement range 41 via the distance measurement device 40. For example, the flying object coordinate derivation unit 164 acquires a distance measured with respect to the center portion of the distance measurement range 41 of the distance measurement device 40 as the distance between the flying object 310 and the distance measurement device 40. For example, the distance between the flying object 310 and the distance measurement device 40 corresponds to a distance between the flying object 310 and the LiDAR scanner. The flying object coordinate derivation unit 164 may acquire an average value of distances measured at a plurality of distance measurement locations of a predetermined region including the center portion of the distance measurement range 41 of the distance measurement device 40 as the distance between the flying object 310 and the distance measurement device 40. The predetermined region is, for example, a region including only the flying object 310. The distance between the flying object 310 and the distance measurement device 40 is an example of a “second distance” according to the embodiment of the disclosed technology.

In addition, the flying object coordinate derivation unit 164 acquires the absolute coordinates of the rotational drive apparatus 20 based on coordinates (for example, three-dimensional coordinates corresponding to a latitude, a longitude, and an altitude) of the base station 10 measured using, for example, a satellite positioning system (for example, a global positioning system) in a state where the base station 10 is installed on a measurement site. The absolute coordinates of the rotational drive apparatus 20 correspond to absolute coordinates of the base station 10. In addition, the flying object coordinate derivation unit 164 acquires the angle of the laser light emitted from the distance measurement device 40 toward the flying object 310 based on the rotational angle of the scanner mirror 47 detected by the angle detector. The angle of the laser light emitted from the distance measurement device 40 toward the flying object 310 corresponds to an angle of the laser light emitted from the LiDAR scanner toward the flying object 310. In addition, the flying object coordinate derivation unit 164 acquires the rotational angle of the rotational drive apparatus 20 based on the rotational position of the seat 27 detected by the rotation detector (not illustrated) provided in the pan/tilt mechanism 26 and/or the seat 27.

Based on the coordinates of the flying object 310 derived by the flying object coordinate derivation unit 164 and on absolute coordinates of the imaging position 8A (hereinafter, referred to as a target imaging position 8A) closest to the flying object 310 among the plurality of imaging positions 8A, the imaging position reaching determination unit 166 determines whether or not the flying object 310 has reached the target imaging position 8A.

In a case where the imaging position reaching determination unit 166 determines that the flying object 310 has not reached the target imaging position 8A, the flying instruction generation unit 168 generates the flying instruction with respect to the flying object 310 based on a difference between the coordinates of the flying object 310 derived by the flying object coordinate derivation unit 164 and the coordinates of the target imaging position 8A. Specifically, the flying instruction generation unit 168 calculates a flying direction of the flying object 310 and a movement amount of the flying object 310 for the flying object 310 to fly along the flying route 8 to reach the target imaging position 8A based on the absolute coordinates of the flying object 310 derived by the flying object coordinate derivation unit 164 and on the absolute coordinates of the target imaging position 8A. The flying instruction generation unit 168 calculates the rotation speed of each propeller 341 corresponding to the flying direction of the flying object 310 and to the movement amount of the flying object 310 and generates the flying instruction corresponding to the rotation speed of each propeller 341.

The flying instruction transmission control unit 170 performs a control of transmitting the flying instruction to the flying object 310 through the communication apparatus 12.

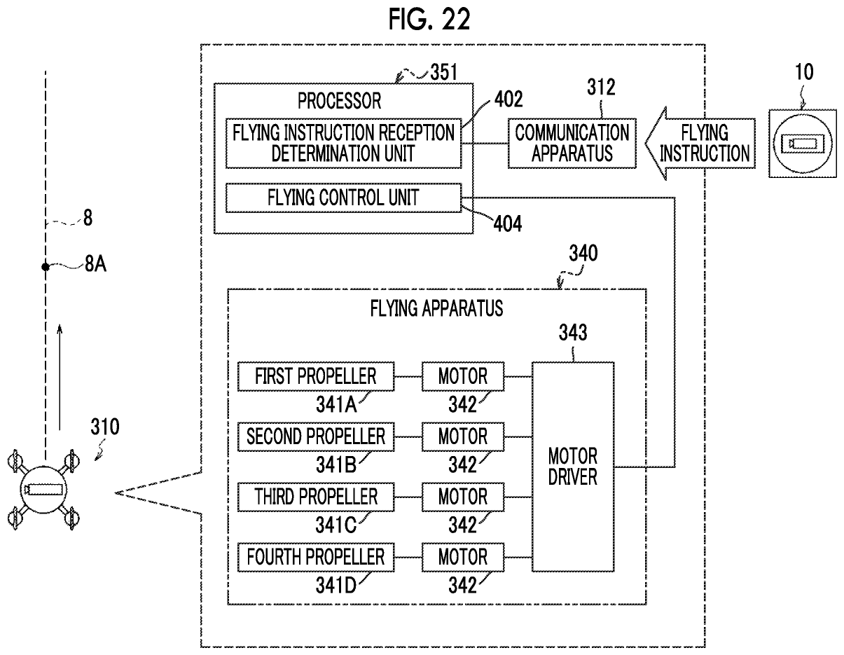

As illustrated in FIG. 22 as an example, in the flying object 310, the flying instruction reception determination unit 402 determines whether or not the communication apparatus 312 has received the flying instruction.

In a case where the flying instruction reception determination unit 402 determines that the communication apparatus 312 has received the flying instruction, the flying control unit 404 controls the flying apparatus 340 in accordance with the flying instruction. Specifically, the flying control unit 404 adjusts the rotation speed of each propeller 341 to a rotation speed corresponding to the flying instruction by controlling the plurality of motors 342 through the motor driver 343 of the flying apparatus 340 in accordance with the flying instruction. Accordingly, the flying object 310 flies toward the target imaging position 8A.

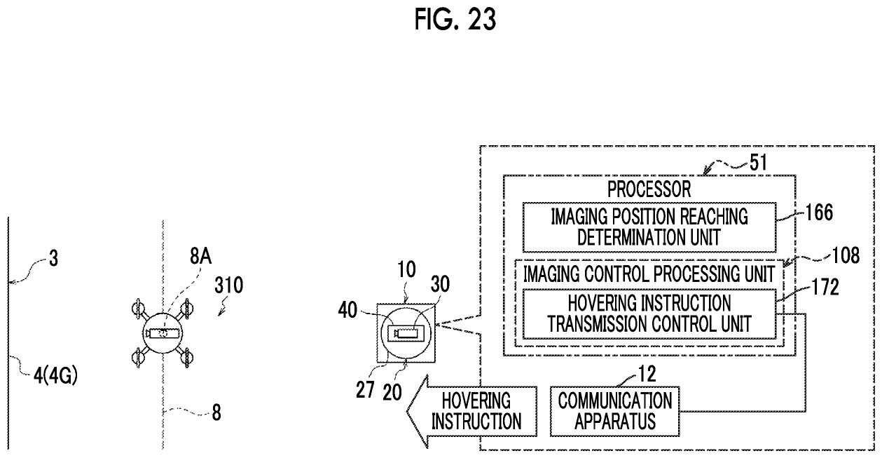

As illustrated in FIG. 23 as an example, in the base station 10, in a case where the imaging position reaching determination unit 166 determines that the flying object 310 has reached the target imaging position 8A, the hovering instruction transmission control unit 172 performs a control of transmitting a hovering instruction to the flying object 310 through the communication apparatus 12.

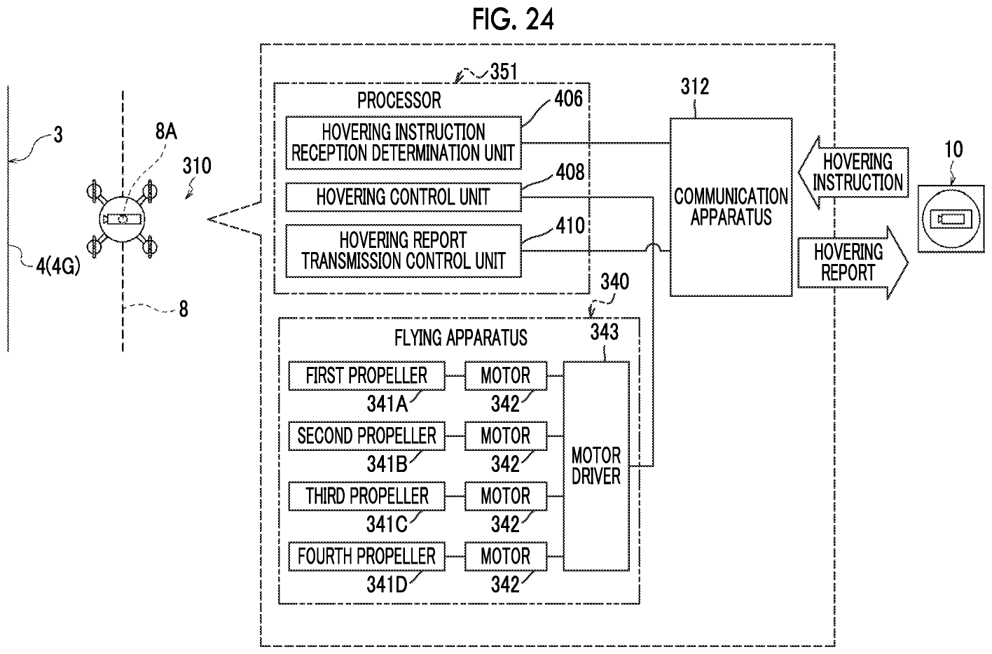

As illustrated in FIG. 24 as an example, in the flying object 310, the hovering instruction reception determination unit 406 determines whether or not the communication apparatus 312 has received the hovering instruction.

In a case where the hovering instruction reception determination unit 406 determines that the communication apparatus 312 has received the hovering instruction, the hovering control unit 408 performs a control of causing the flying object 310 to hover via the flying apparatus 340. Specifically, the hovering control unit 408 adjusts the rotation speed of each propeller 341 to a rotation speed at which the flying object 310 hovers by controlling the plurality of motors 342 through the motor driver 343 of the flying apparatus 340. Accordingly, the flying object 310 hovers.

After the control of the hovering control unit 408 is performed, the hovering report transmission control unit 410 performs a control of transmitting a hovering report indicating hovering of the flying object 310 to the base station 10 through the communication apparatus 312.

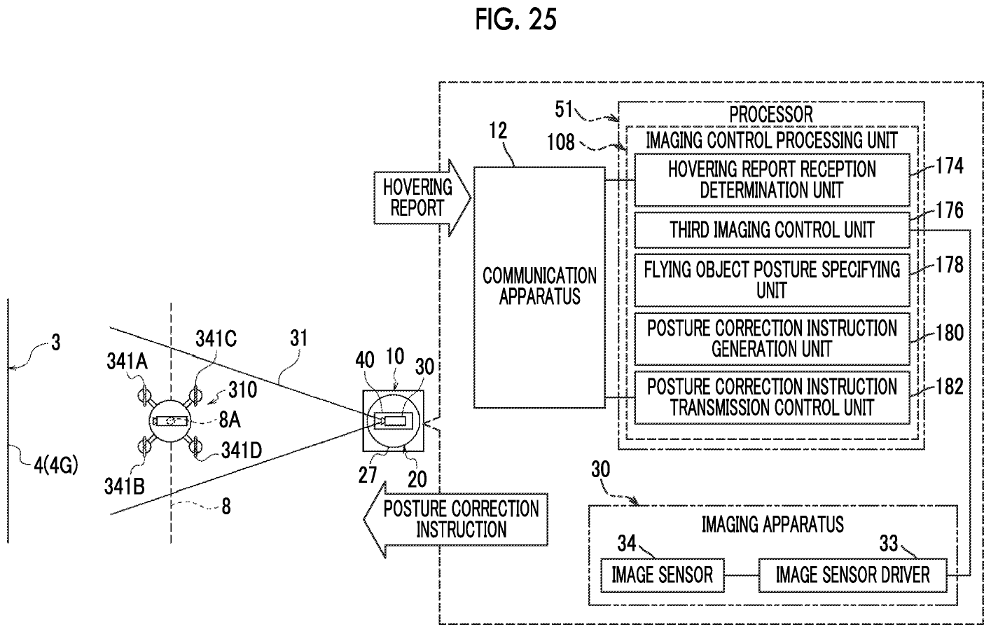

As illustrated in FIG. 25 as an example, in the base station 10, the hovering report reception determination unit 174 determines whether or not the communication apparatus 12 has received the hovering report.

The third imaging control unit 176 performs a control of capturing the imaging scene including the flying object 310 via the imaging apparatus 30. Specifically, the third imaging control unit 176 causes the image sensor 34 to capture the imaging scene including the flying object 310 through the image sensor driver 33 of the imaging apparatus 30. Accordingly, an image is obtained by capturing the imaging scene including the flying object 310 via the imaging apparatus 30.

The flying object posture specifying unit 178 specifies a posture of the flying object 310 based on positions of the plurality of propellers 341 captured in the image by executing the object recognition processing (for example, object recognition processing based on template matching or object recognition processing based on AI) with respect to the image that is obtained by capturing via the imaging apparatus 30 based on the control of the third imaging control unit 176. Specifically, the flying object posture specifying unit 178 specifies the positions of the plurality of propellers 341 based on the image by identifying the colors of the plurality of propellers 341 captured in the image. The flying object posture specifying unit 178 specifies the posture of the flying object 310 based on the positions of the plurality of propellers 341. The posture of the flying object 310 includes a direction of the flying object 310 and/or inclination or the like of the flying object 310.

The posture correction instruction generation unit 180 generates a posture correction instruction for the flying object 310 based on the posture of the flying object 310 specified by the flying object posture specifying unit 178. Specifically, the posture correction instruction generation unit 180 calculates a posture correction amount for correcting the posture of the flying object 310 to a posture of directly facing the inspection target surface 4G in a horizontal state based on the posture of the flying object 310 specified by the flying object posture specifying unit 178. The posture correction instruction generation unit 180 calculates the rotation speed of each propeller 341 corresponding to the posture correction amount and generates the posture correction instruction corresponding to the rotation speed of each propeller 341.

The posture correction instruction transmission control unit 182 performs a control of transmitting the posture correction instruction to the flying object 310 through the communication apparatus 12.

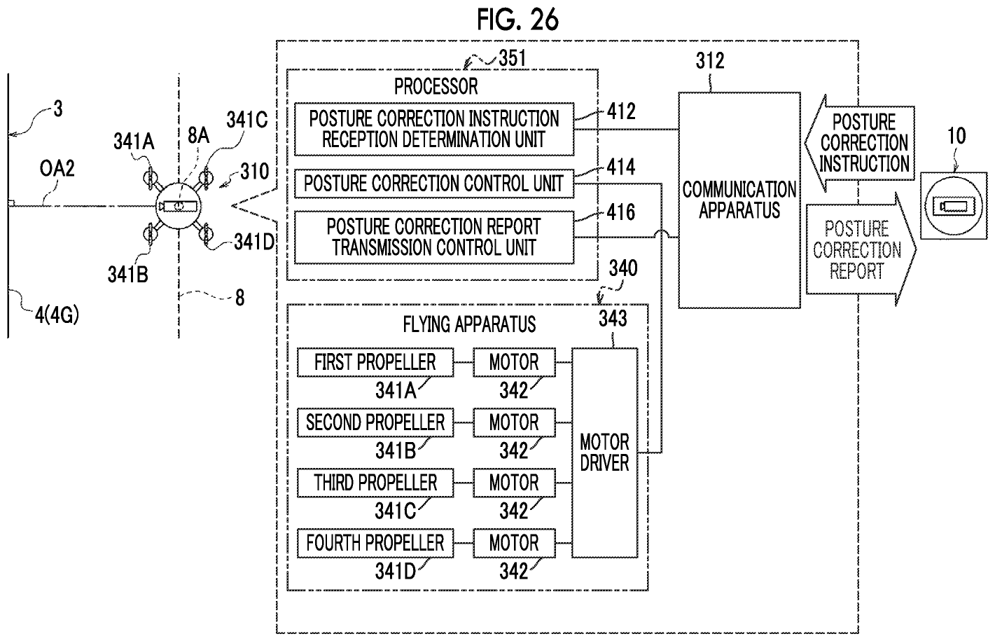

As illustrated in FIG. 26 as an example, in the flying object 310, the posture correction instruction reception determination unit 412 determines whether or not the communication apparatus 312 has received the posture correction instruction.

In a case where the posture correction instruction reception determination unit 412 determines that the communication apparatus 312 has received the posture correction instruction, the posture correction control unit 414 performs a control of correcting the posture of the flying object 310 in accordance with the posture correction instruction via the flying apparatus 340. Specifically, the posture correction control unit 414 adjusts the rotation speeds of the plurality of propellers 341 to the rotation speeds corresponding to the posture correction instruction by controlling the plurality of motors 342 through the motor driver 343 of the flying apparatus 340 in accordance with the posture correction instruction. Accordingly, the posture of the flying object 310 is corrected to the posture of directly facing the inspection target surface 4G in the horizontal state. Correcting the posture of the flying object 310 to the posture of directly facing the inspection target surface 4G in the horizontal state causes the optical axis OA2 of the imaging apparatus 330 to be orthogonal to the inspection target surface 4G in a horizontal state of the imaging apparatus 330.

After the control of the posture correction control unit 414 is performed, the posture correction report transmission control unit 416 performs a control of transmitting a posture correction report indicating correction of the posture of the flying object 310 to the base station 10 through the communication apparatus 312.

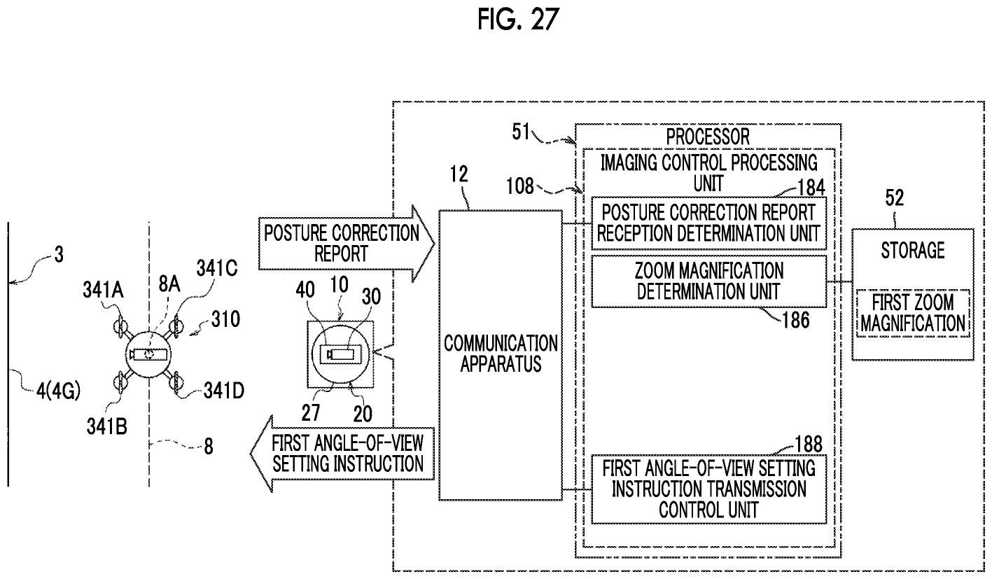

The example illustrated in FIG. 27 as an example is an example in which the first zoom magnification is stored in the storage 52 by the first zoom magnification storage control unit 140 (refer to FIG. 18) because the distance between the inspection target surface 4G and the smooth surface 7 is constant as the predetermined distance L, as in the example illustrated in FIG. 18.

As illustrated in FIG. 27 as an example, in the base station 10, the posture correction report reception determination unit 184 determines whether or not the communication apparatus 12 has received the posture correction report.

In a case where the posture correction report reception determination unit 184 determines that the communication apparatus 12 has received the posture correction report, the zoom magnification determination unit 186 determines which one of the first zoom magnification and the second zoom magnification is the zoom magnification stored in the storage 52 by the first zoom magnification storage control unit 140 or by the second zoom magnification storage control unit 146.

In a case where the zoom magnification determination unit 186 determines that the zoom magnification stored in the storage 52 is the first zoom magnification, the first angle-of-view setting instruction transmission control unit 188 performs a control of transmitting a first angle-of-view setting instruction corresponding to the first zoom magnification to the flying object 310 through the communication apparatus 12.

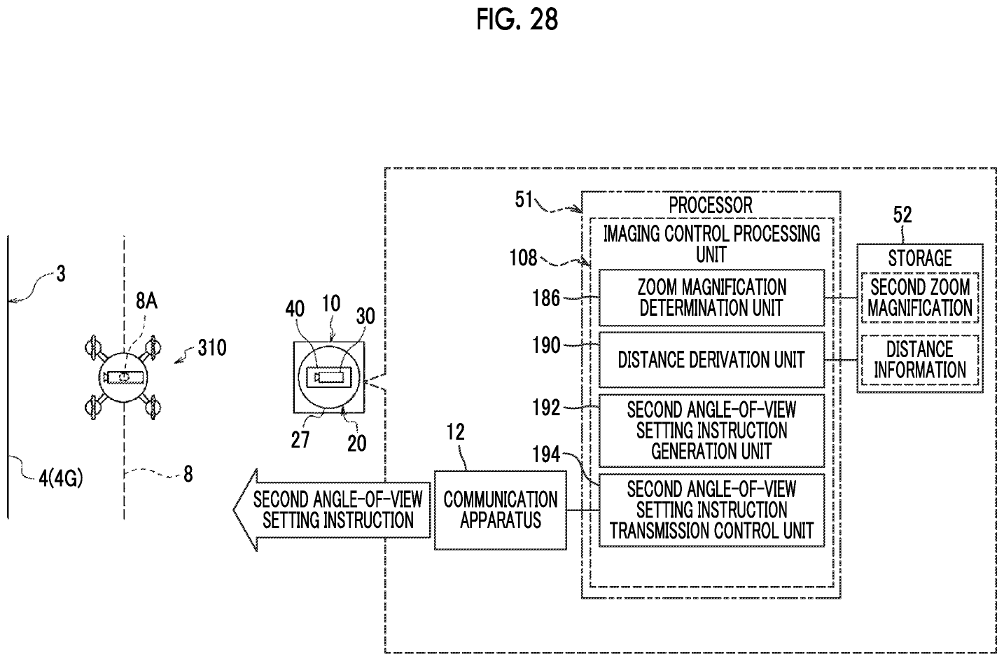

The example illustrated in FIG. 28 as an example is an example in which the second zoom magnification is stored in the storage 52 by the second zoom magnification storage control unit 146 (refer to FIG. 19) because the distance between the inspection target surface 4G and the smooth surface 7 is not constant, as in the example illustrated in FIG. 19.

As illustrated in FIG. 28 as an example, in the base station 10, in a case where the zoom magnification determination unit 186 determines that the zoom magnification stored in the storage 52 is the second zoom magnification, the distance derivation unit 190 derives the distance between the inspection target surface 4G and the target imaging position 8A based on the distance information stored in the storage 52 by the distance information storage control unit 122.

The second angle-of-view setting instruction generation unit 192 adjusts the second zoom magnification to a zoom magnification at which the pixel resolution of the imaging apparatus 330 has the predetermined value based on the distance derived by the distance derivation unit 190. The second angle-of-view setting instruction generation unit 192 generates a second angle-of-view setting instruction corresponding to the second zoom magnification adjusted based on the distance derived by the distance derivation unit 190. Specifically, in a case where the distance derived by the distance derivation unit 190 is the shortest distance between the inspection target surface 4G and the smooth surface 7, the second angle-of-view setting instruction generation unit 192 generates the second angle-of-view setting instruction corresponding to the second zoom magnification determined by the second zoom magnification determination unit 144.

On the other hand, in a case where the distance derived by the distance derivation unit 190 is longer than the shortest distance between the inspection target surface 4G and the smooth surface 7, the second angle-of-view setting instruction generation unit 192 adjusts the second zoom magnification by increasing the second zoom magnification determined by the second zoom magnification determination unit 144 in accordance with the distance derived by the distance derivation unit 190. The second angle-of-view setting instruction generation unit 192 generates the second angle-of-view setting instruction corresponding to the adjusted second zoom magnification.

The second angle-of-view setting instruction transmission control unit 194 performs a control of transmitting the second angle-of-view setting instruction generated by the second angle-of-view setting instruction generation unit 192 to the flying object 310 through the communication apparatus 12. In the following description, the first angle-of-view setting instruction and the second angle-of-view setting instruction will be referred to as an angle-of-view setting instruction unless otherwise required to distinguish between the first angle-of-view setting instruction and the second angle-of-view setting instruction.

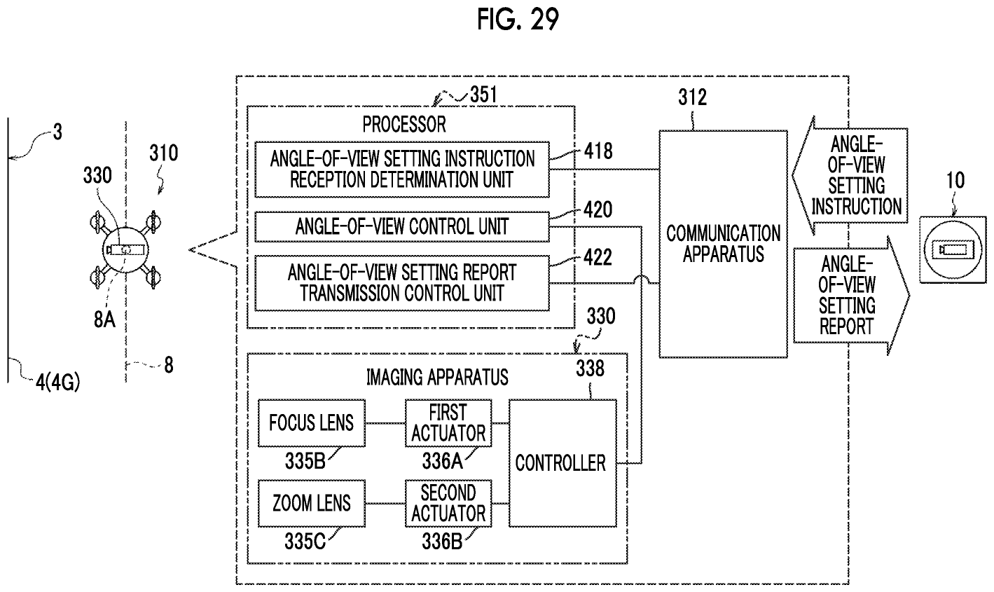

As illustrated in FIG. 29 as an example, in the flying object 310, the angle-of-view setting instruction reception determination unit 418 determines whether or not the communication apparatus 312 has received the angle-of-view setting instruction.

In a case where the angle-of-view setting instruction reception determination unit 418 determines that the communication apparatus 312 has received the angle-of-view setting instruction, the angle-of-view control unit 420 performs a control of setting an angle of view of the imaging apparatus 330 to an angle of view corresponding to the angle-of-view setting instruction via the imaging apparatus 330. Specifically, the angle-of-view control unit 420 adjusts the position of the zoom lens 335C to a position corresponding to the angle-of-view setting instruction by controlling the second actuator 336B through the controller 338. By adjusting the position of the zoom lens 335C, the zoom magnification of the imaging apparatus 330 is adjusted.

For example, in a case where the communication apparatus 312 has received the first angle-of-view setting instruction as the angle-of-view setting instruction, the angle-of-view control unit 420 sets the zoom magnification of the imaging apparatus 330 to the first zoom magnification in accordance with the first angle-of-view setting instruction. On the other hand, in a case where the communication apparatus 312 has received the second angle-of-view setting instruction as the angle-of-view setting instruction, the angle-of-view control unit 420 sets the zoom magnification of the imaging apparatus 330 to the second zoom magnification in accordance with the second angle-of-view setting instruction.

In addition, the angle-of-view control unit 420 adjusts the position of the focus lens 335B to a position corresponding to the angle-of-view setting instruction by controlling the first actuator 336A through the controller 338. By adjusting the position of the focus, a focus of the imaging apparatus 330 is adjusted. In this case, the angle-of-view control unit 420 may operate at least one of the zoom lens 335C or the focus lens 335B. By adjusting the angle of view via the angle-of-view control unit 420, the pixel resolution of the imaging apparatus 330 is constantly maintained. By constantly maintaining the pixel resolution of the imaging apparatus 330, a range in which the inspection target surface 4G is actually imaged by the imaging apparatus 330 is constantly maintained even in a case where the distance between the inspection target surface 4G and the imaging position 8A changes.

After the control of the angle-of-view control unit 420 is performed, the angle-of-view setting report transmission control unit 422 performs a control of transmitting an angle-of-view setting report indicating setting of the angle of view of the imaging apparatus 330 to the angle of view corresponding to the angle-of-view setting instruction to the base station 10 through the communication apparatus 312.

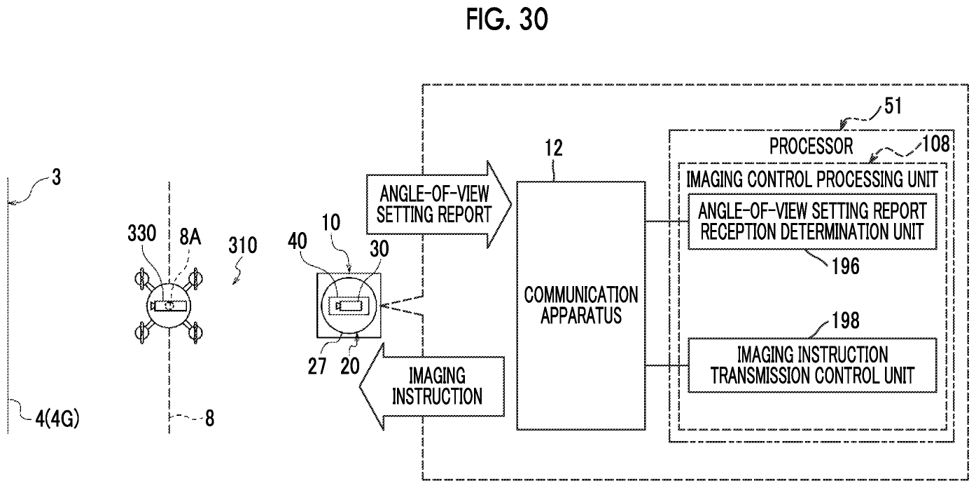

As illustrated in FIG. 30 as an example, in the base station 10, the angle-of-view setting report reception determination unit 196 determines whether or not the communication apparatus 12 has received the angle-of-view setting report.

In a case where the angle-of-view setting report reception determination unit 196 determines that the communication apparatus 12 has received the angle-of-view setting report, the imaging instruction transmission control unit 198 performs a control of transmitting the imaging instruction to the flying object 310 through the communication apparatus 12.

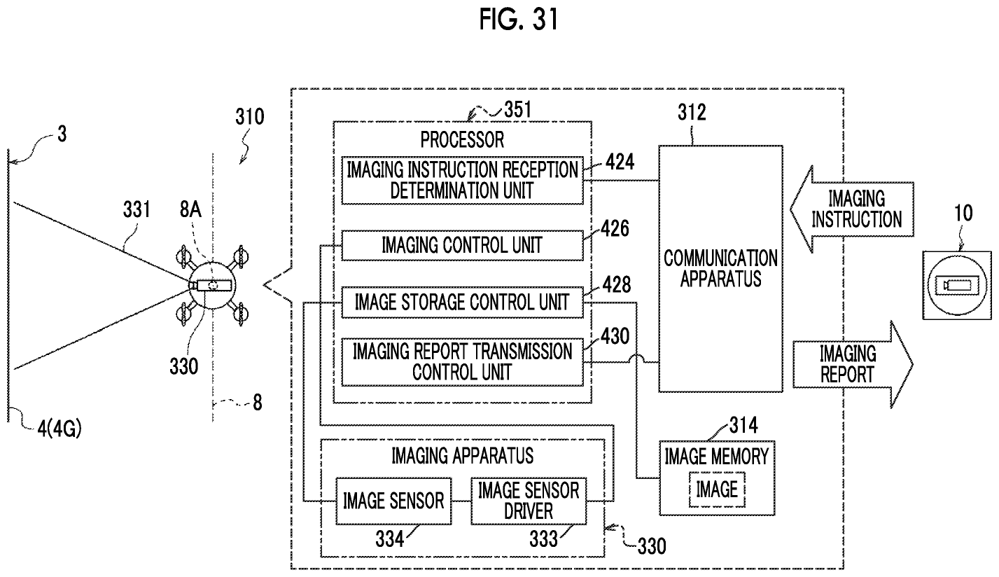

As illustrated in FIG. 31 as an example, in the flying object 310, the imaging instruction reception determination unit 424 determines whether or not the communication apparatus 312 has received the imaging instruction.

In a case where the imaging instruction reception determination unit 424 determines that the communication apparatus 312 has received the imaging instruction, the imaging control unit 426 performs a control of imaging the inspection target surface 4G via the imaging apparatus 330. Specifically, the imaging control unit 426 causes the image sensor 334 to image the inspection target surface 4G through the image sensor driver 333 of the imaging apparatus 330. In this case, the imaging apparatus 330 images a part of the inspection target surface 4G. Accordingly, an image is obtained by imaging the part of the inspection target surface 4G via the imaging apparatus 330. The image obtained by capturing via the imaging apparatus 330 under control of the imaging control unit 426 is an example of a “first image” according to the embodiment of the disclosed technology.

The image storage control unit 428 stores the image obtained by capturing via the imaging apparatus 330 in the image memory 314.

After the image is stored in the image memory 314, the imaging report transmission control unit 430 performs a control of transmitting an imaging report indicating imaging of the part of the inspection target surface 4G via the imaging apparatus 330 to the base station 10 through the communication apparatus 312.

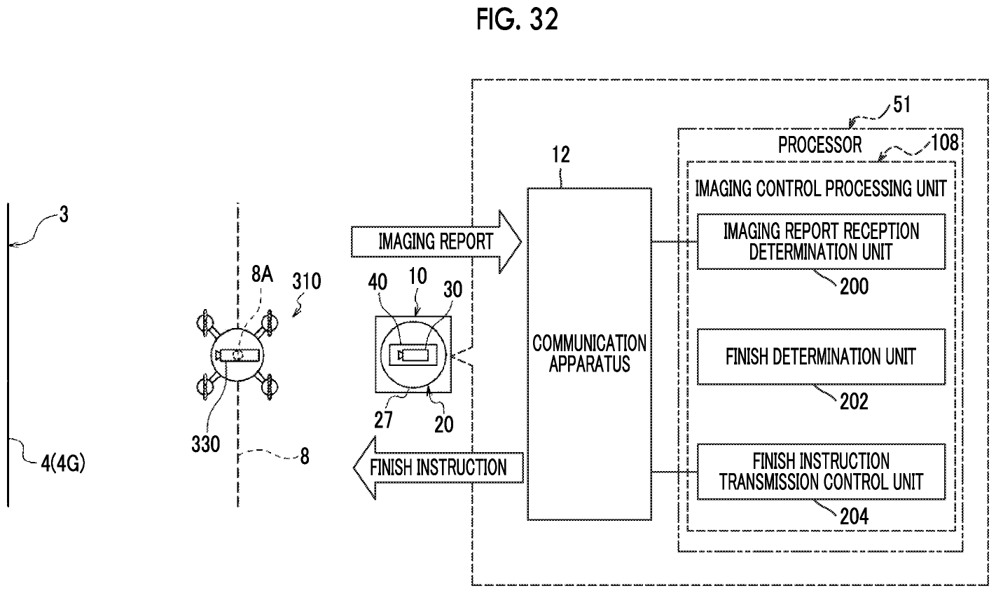

As illustrated in FIG. 32 as an example, in the base station 10, the imaging report reception determination unit 200 determines whether or not the communication apparatus 12 has received the imaging report.

The finish determination unit 202 determines whether or not a condition for finishing the flying imaging support processing is established. Examples of the condition for finishing the flying imaging support processing include a condition that the number of imaging reports reaches the number of imaging positions 8A. In a case where the number of imaging reports is less than the number of imaging positions 8A, the finish determination unit 202 determines that the condition for finishing the flying imaging support processing is not established.

In a case where the condition for finishing the flying imaging support processing is not established, the flying imaging support processing of the base station 10 is repeatedly executed. In accordance with repeated execution of the flying imaging support processing of the base station 10, the flying object 310 flies along the flying route 8 to move to each imaging position 8A in order, and the inspection target surface 4G is imaged by the imaging apparatus 330 each time each of the plurality of imaging positions 8A is reached. Accordingly, a plurality of images are acquired. In addition, in a case where the distance between the inspection target surface 4G and each imaging position 8A is constant as the predetermined distance L (refer to FIG. 18), the zoom magnification of the imaging apparatus 330 is maintained at the first zoom magnification at each imaging position 8A. Accordingly, the pixel resolution of the imaging apparatus 330 is constantly maintained.

On the other hand, for example, in a case where the flying object 310 flies across the recessed portion 4F (refer to FIG. 19), the distance between the inspection target surface 4G and each imaging position 8A changes. In this case, the second zoom magnification of the imaging apparatus 330 is adjusted in accordance with the distance between the inspection target surface 4G and the imaging position 8A at each imaging position 8A. Accordingly, the pixel resolution of the imaging apparatus 330 is constantly maintained. By constantly maintaining the pixel resolution of the imaging apparatus 330, a range actually imaged by the imaging apparatus 330 is constantly maintained even in a case where the distance between the inspection target surface 4G and the imaging position 8A changes. The distance between the inspection target surface 4G and the imaging position 8A corresponds to a distance between the inspection target surface 4G and the imaging apparatus 330.

In a case where the number of imaging reports has reached the number of imaging positions 8A, the finish determination unit 202 determines that the condition for finishing the flying imaging support processing is established.

In a case where the finish determination unit 202 determines that the condition for finishing the flying imaging support processing is established, the finish instruction transmission control unit 204 performs a control of transmitting a finish instruction to the flying object 310 through the communication apparatus 12.

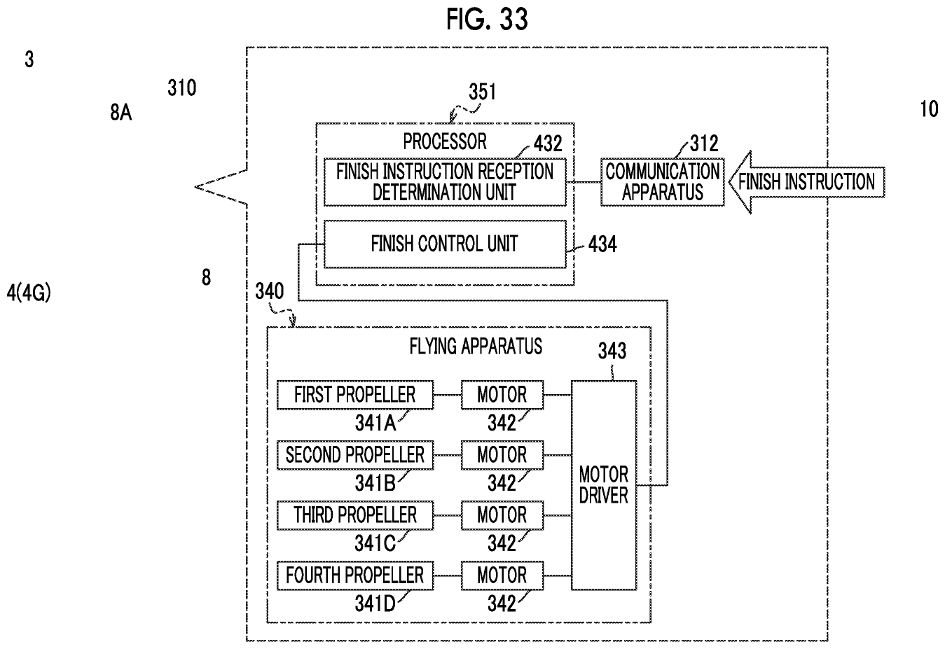

As illustrated in FIG. 33 as an example, in the flying object 310, the finish instruction reception determination unit 432 determines whether or not the communication apparatus 312 has received the finish instruction.

In a case where the finish instruction reception determination unit 432 determines that the communication apparatus 312 has received the finish instruction, the finish control unit 434 performs a control of finishing flying with respect to the flying apparatus 340. Examples of the control of finishing flying include a control of causing the flying object 310 to land, a control of causing the flying object 310 to return to a position at which the flying object 310 has started the flying imaging processing, and/or a control of switching the flying object 310 to be maneuvered using a maneuvering apparatus (not illustrated).

The finish control unit 434 adjusts the rotation speed of each propeller 341 by controlling the plurality of motors 342 through the motor driver 343 of the flying apparatus 340 in accordance with the finish instruction.

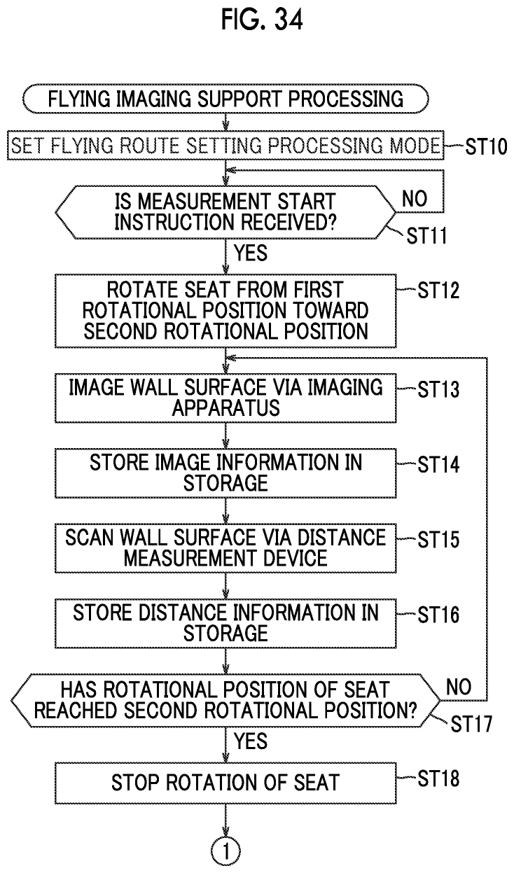

Next, action of the imaging system S according to the first embodiment will be described with reference to FIG. 34 to FIG. 42.

First, an example of a flow of the flying imaging support processing performed by the processor 51 of the base station 10 will be described with reference to FIG. 34 to FIG. 39.

In the flying imaging support processing illustrated in FIG. 34, first, in step ST10, the operation mode setting unit 102 sets the operation mode of the base station 10 to the flying route setting processing mode. After the processing of step ST10 is executed, the flying imaging support processing transitions to step ST11.

In step ST11, the first reception determination unit 112 determines whether or not the measurement start instruction is received by the reception apparatus 14. In step ST11, in a case where the measurement start instruction is not received by the reception apparatus 14, a negative determination is made, and the determination of step ST11 is performed again. In step ST11, in a case where the measurement start instruction is received by the reception apparatus 14, a positive determination is made, and the flying imaging support processing transitions to step ST12.

In step ST12, the first rotation control unit 114 rotates the seat 27 from the first rotational position toward the second rotational position by controlling the rotational drive apparatus 20 based on the measurement start instruction. After the processing of step ST12 is executed, the flying imaging support processing transitions to step ST13.

In step ST13, the first imaging control unit 116 causes the imaging apparatus 30 to image the wall surface 4. After the processing of step ST13 is executed, the flying imaging support processing transitions to step ST14.

In step ST14, the image information storage control unit 118 stores the image information, which is generated by associating the image obtained in step ST13 with the rotational position of the seat 27, in the storage 52. After the processing of step ST14 is executed, the flying imaging support processing transitions to step ST15.

In step ST15, the first distance measurement control unit 120 causes the distance measurement device 40 to scan the wall surface 4. After the processing of step ST15 is executed, the flying imaging support processing transitions to step ST16.

In step ST16, the distance information storage control unit 122 stores the distance information, which is generated by associating the distance measured in step ST15 with the rotational position detected by the rotation detector (not illustrated) and with the rotational angle detected by the angle detector (not illustrated), in the storage 52. After the processing of step ST16 is executed, the flying imaging support processing transitions to step ST17.

In step ST17, the rotational position determination unit 124 determines whether or not the rotational position of the seat 27 has reached the second rotational position. In step ST17, in a case where the rotational position of the seat 27 has not reached the second rotational position, a negative determination is made, and the flying imaging support processing transitions to step ST13.

By repeatedly executing step ST13 and step ST14 while the rotational position of the seat 27 reaches the second rotational position, the plurality of imaged regions of the wall surface 4 are continuously imaged in order from the first end part side to the second end part side of the wall surface 4. The image information corresponding to each imaged region is stored in the storage 52. In addition, by repeatedly executing step ST15 and step ST16 while the rotational position of the seat 27 reaches the second rotational position, each of the plurality of distance measurement regions of the wall surface 4 is continuously scanned with the laser light in order from the first end part side to the second end part side of the wall surface 4. The distance information corresponding to each distance measurement region is stored in the storage 52. In step ST17, in a case where the rotational position of the seat 27 has reached the second rotational position, a positive determination is made, and the flying imaging support processing transitions to step ST18.

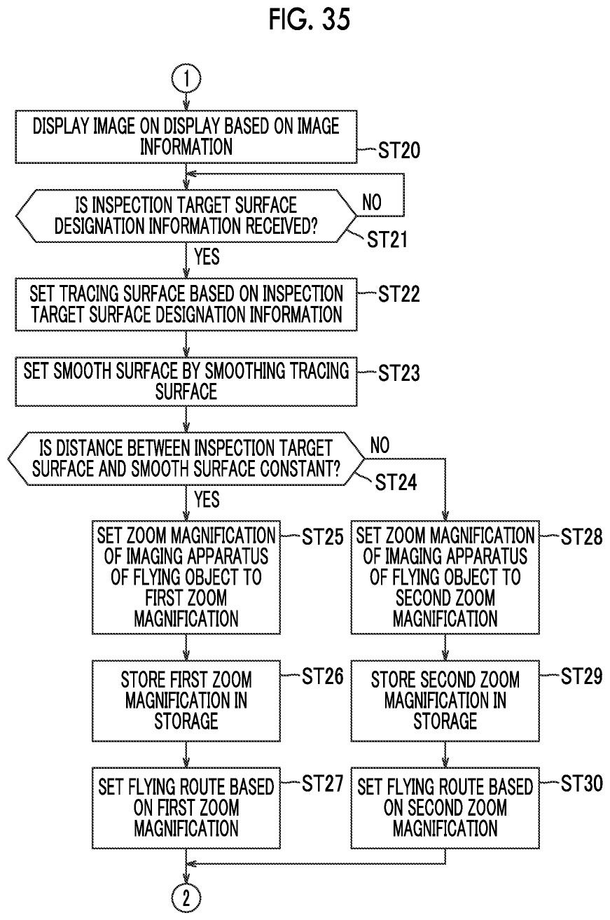

In step ST18, the rotation stop control unit 126 stops rotation of the seat 27 by stopping rotation of the rotational drive apparatus 20. After the processing of step ST18 is executed, the flying imaging support processing transitions to step ST20 illustrated in FIG. 35.

In step ST20 illustrated in FIG. 35, the image display control unit 128 displays the image on the display 16 based on the image information stored in the storage 52. In the image, the wall surface 4 is represented as an image. After the processing of step ST20 is executed, the flying imaging support processing transitions to step ST21.

In step ST21, the second reception determination unit 130 determines whether or not the inspection target surface designation information provided from the worker 5 is received by the reception apparatus 14. In step ST21, in a case where the inspection target surface designation information is not received by the reception apparatus 14, a negative determination is made, and the determination of step ST21 is performed again. In step ST21, in a case where the inspection target surface designation information is received by the reception apparatus 14, a positive determination is made, and the flying imaging support processing transitions to step ST22.

In step ST22, the tracing surface setting unit 132 sets the tracing surface 6, which traces the inspection target surface 4G, based on the inspection target surface designation information. After the processing of step ST22 is executed, the flying imaging support processing transitions to step ST23.

In step ST23, the smooth surface setting unit 134 sets the smooth surface 7 by smoothing the tracing surface 6. After the processing of step ST23 is executed, the flying imaging support processing transitions to step ST24.

In step ST24, the distance determination unit 136 determines whether or not the distance between the inspection target surface 4G and the smooth surface 7 is constant based on the distance information stored in the storage 52. In step ST24, in a case where the distance between the inspection target surface 4G and the smooth surface 7 is constant, a positive determination is made, and the flying imaging support processing transitions to step ST25. In step ST24, in a case where the distance between the inspection target surface 4G and the smooth surface 7 is not constant, a negative determination is made, and the flying imaging support processing transitions to step ST28.

In step ST25, the first zoom magnification determination unit 138 determines the zoom magnification of the imaging apparatus 330 of the flying object 310 as the first zoom magnification. The first zoom magnification is the zoom magnification at which the pixel resolution of the imaging apparatus 330 has the predetermined value. After the processing of step ST25 is executed, the flying imaging support processing transitions to step ST26.

In step ST26, the first zoom magnification storage control unit 140 stores the first zoom magnification determined by the first zoom magnification determination unit 138 in the storage 52. After the processing of step ST26 is executed, the flying imaging support processing transitions to step ST27.

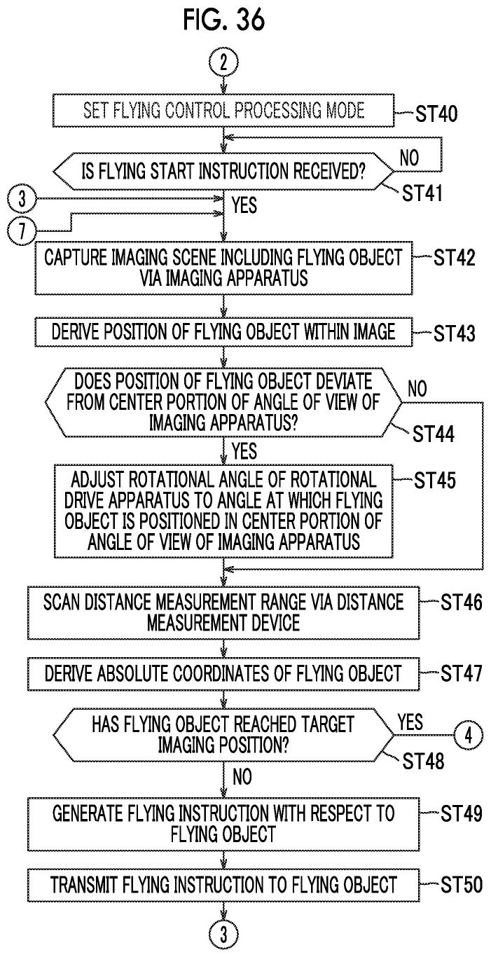

In step ST27, the first flying route setting unit 142 sets the flying route 8 passing through the plurality of imaging positions 8A by setting the plurality of imaging positions 8A on the smooth surface 7 based on the first zoom magnification determined by the first zoom magnification determination unit 138. As an example, in the case of imaging the inspection target surface 4G at the first zoom magnification determined by the first zoom magnification determination unit 138, the first flying route setting unit 142 sets the flying route 8 passing through the plurality of imaging positions 8A by setting the plurality of imaging positions 8A at the positions where the imaging ranges 331 of the imaging apparatus 330 partially overlap with each other at the adjacent imaging positions 8A among the plurality of imaging positions 8A. After the processing of step ST27 is executed, the flying imaging support processing transitions to step ST40 illustrated in FIG. 36.

In step ST28, the second zoom magnification determination unit 144 determines the zoom magnification of the imaging apparatus 330 of the flying object 310 as the second zoom magnification. After the processing of step ST28 is executed, the flying imaging support processing transitions to step ST29.

In step ST29, the second zoom magnification storage control unit 146 stores the second zoom magnification determined by the second zoom magnification determination unit 144 in the storage 52. After the processing of step ST29 is executed, the flying imaging support processing transitions to step ST30.

In step ST30, the second flying route setting unit 148 sets the flying route 8 passing through the plurality of imaging positions 8A by setting the plurality of imaging positions 8A on the smooth surface 7 based on the second zoom magnification determined by the second zoom magnification determination unit 144. Even in the case of adjusting the second zoom magnification in accordance with the distance between the inspection target surface 4G and the imaging position 8A in step ST73 and step ST74 described later, the second flying route setting unit 148 sets the flying route 8 passing through the plurality of imaging positions 8A by setting the plurality of imaging positions 8A at the positions where the imaging ranges 331 of the imaging apparatus 330 partially overlap with each other at the adjacent imaging positions 8A among the plurality of imaging positions 8A. After the processing of step ST30 is executed, the flying imaging support processing transitions to step ST40 illustrated in FIG. 36.

In step ST40 illustrated in FIG. 36, the operation mode setting unit 102 sets the operation mode of the base station 10 to the flying control processing mode. After the processing of step ST40 is executed, the flying imaging support processing transitions to step ST41.

In step ST41, the third reception determination unit 152 determines whether or not the flying start instruction is received by the reception apparatus 14. In step ST41, in a case where the flying start instruction is not received by the reception apparatus 14, a negative determination is made, and the determination of step ST41 is performed again. In step ST41, in a case where the flying start instruction is received by the reception apparatus 14, a positive determination is made, and the flying imaging support processing transitions to step ST42.

In step ST42, the second imaging control unit 154 causes the imaging apparatus 30 to capture the imaging scene including the flying object 310. After the processing of step ST42 is executed, the flying imaging support processing transitions to step ST43.

In step ST43, the flying object position derivation unit 156 derives the position of the flying object 310 within the image obtained by capturing via the imaging apparatus 30. After the processing of step ST43 is executed, the flying imaging support processing transitions to step ST44.

In step ST44, the positional deviation determination unit 158 determines whether or not the position of the flying object 310 deviates from the center portion of the angle of view of the imaging apparatus 30 based on the position of the flying object 310 within the image derived in step ST43. In step ST44, in a case where the position of the flying object 310 deviates from the center portion of the angle of view, a positive determination is made, and the flying imaging support processing transitions to step ST45. In step ST44, in a case where the position of the flying object 310 does not deviate from the center portion of the angle of view, a negative determination is made, and the flying imaging support processing transitions to step ST46.

In step ST45, the second rotation control unit 160 adjusts the rotational angle of the rotational drive apparatus 20 to the angle at which the flying object 310 is positioned in the center portion of the angle of view of the imaging apparatus 30. After the processing of step ST45 is executed, the flying imaging support processing transitions to step ST46.

In step ST46, the second distance measurement control unit 162 causes the distance measurement device 40 to scan the distance measurement range 41 with the laser light. In this case, since the flying object 310 is positioned within the distance measurement range 41 of the distance measurement device 40, the distance between the flying object 310 and the distance measurement device 40 is obtained. After the processing of step ST46 is executed, the flying imaging support processing transitions to step ST47.

In step ST47, the flying object coordinate derivation unit 164 derives the absolute coordinates of the flying object 310 based on the absolute coordinates of the rotational drive apparatus 20, the rotational angle of the rotational drive apparatus 20, the angle of the laser light emitted from the distance measurement device 40 toward the flying object 310, and the distance between the flying object 310 and the distance measurement device 40. After the processing of step ST47 is executed, the flying imaging support processing transitions to step ST48.

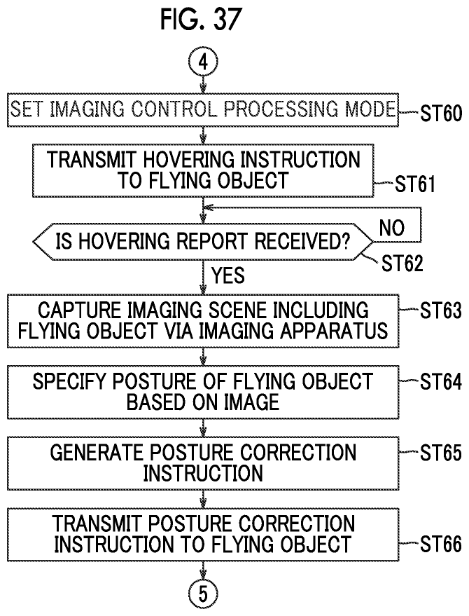

In step ST48, the imaging position reaching determination unit 166 determines whether or not the flying object 310 has reached the target imaging position 8A based on the absolute coordinates of the flying object 310 derived in step ST47 and on the absolute coordinates of the target imaging position 8A. In step ST48, in a case where the flying object 310 has not reached the target imaging position 8A, a negative determination is made, and the flying imaging support processing transitions to step ST49. In step ST48, in a case where the flying object 310 has reached the target imaging position 8A, a positive determination is made, and the flying imaging support processing transitions to step ST60 illustrated in FIG. 37.

In step ST49, the flying instruction generation unit 168 generates the flying instruction with respect to the flying object 310 based on the difference between the absolute coordinates of the flying object 310 derived in step ST47 and the absolute coordinates of the target imaging position 8A. After the processing of step ST49 is executed, the flying imaging support processing transitions to step ST50.

In step ST50, the flying instruction transmission control unit 170 transmits the flying instruction to the flying object 310 through the communication apparatus 12. After the processing of step ST50 is executed, the flying imaging support processing transitions to step ST42. By repeatedly executing step ST42 to step ST50, a positive determination is made in step ST48 in a case where the flying object 310 reaches the target imaging position 8A, and the flying imaging support processing transitions to step ST60 illustrated in FIG. 37.

In step ST60 illustrated in FIG. 37, the operation mode setting unit 102 sets the operation mode of the base station 10 to the imaging control processing mode. After the processing of step ST60 is executed, the flying imaging support processing transitions to step ST61.

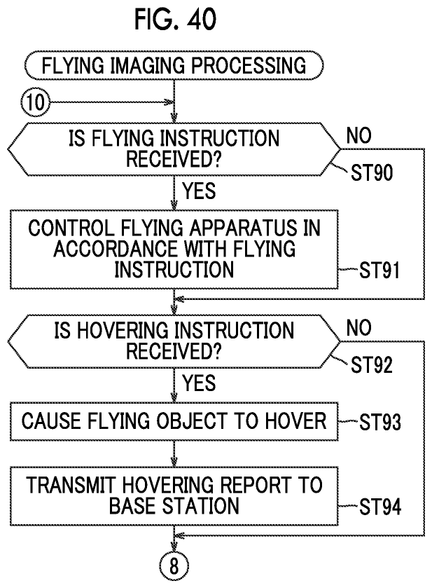

In step ST61, the hovering instruction transmission control unit 172 transmits the hovering instruction to the flying object 310 through the communication apparatus 12. After the processing of step ST61 is executed, the flying imaging support processing transitions to step ST62. In a case where the hovering instruction is transmitted to the flying object 310 by executing the processing of step ST61, processing of step ST92 to step ST94 of the flying imaging processing (refer to FIG. 40) is executed by the processor 351 of the flying object 310. Accordingly, the hovering report is transmitted to the base station 10 from the flying object 310.

Therefore, in step ST62, the hovering report reception determination unit 174 determines whether or not the hovering report transmitted from the flying object 310 is received by the communication apparatus 12. In step ST62, in a case where the hovering report is not received by the communication apparatus 12, a negative determination is made, and the determination of step ST62 is performed again. In step ST62, in a case where the hovering report is received by the communication apparatus 12, a positive determination is made, and the flying imaging support processing transitions to step ST63.

In step ST63, the third imaging control unit 176 causes the imaging apparatus 30 to capture the imaging scene including the flying object 310. After the processing of step ST63 is executed, the flying imaging support processing transitions to step ST64.

In step ST64, the flying object posture specifying unit 178 specifies the posture of the flying object 310 based on the positions of the plurality of propellers 341 captured in the image by executing the object recognition processing with respect to the image obtained by capturing via the imaging apparatus 30. After the processing of step ST64 is executed, the flying imaging support processing transitions to step ST65.

In step ST65, the posture correction instruction generation unit 180 generates the posture correction instruction for the flying object 310 based on the posture of the flying object 310 specified in step ST64. After the processing of step ST65 is executed, the flying imaging support processing transitions to step ST66.

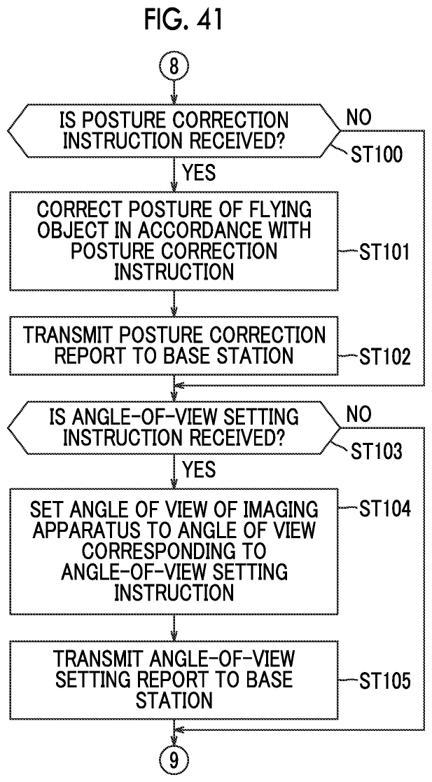

In step ST66, the posture correction instruction transmission control unit 182 transmits the posture correction instruction to the flying object 310 through the communication apparatus 12. After the processing of step ST66 is executed, the flying imaging support processing transitions to step ST70. In a case where the posture correction instruction is transmitted to the flying object 310 by executing the processing of step ST66, processing of step ST100 to step ST102 of the flying imaging processing (refer to FIG. 41) is executed by the processor 351 of the flying object 310. Accordingly, the posture correction report is transmitted to the base station 10 from the flying object 310.

In step ST70, the posture correction report reception determination unit 184 determines whether or not the posture correction report transmitted from the flying object 310 is received by the communication apparatus 12. In step ST70, in a case where the posture correction report is not received by the communication apparatus 12, a negative determination is made, and the determination of step ST70 is performed again. In step ST70, in a case where the posture correction report is received by the communication apparatus 12, a positive determination is made, and the flying imaging support processing transitions to step ST71.

In step ST71, the zoom magnification determination unit 186 determines which of the first zoom magnification and the second zoom magnification is the zoom magnification stored in the storage 52 in step ST26 or in step ST29. In step ST71, in a case where the zoom magnification stored in the storage 52 is the first zoom magnification, the flying imaging support processing transitions to step ST72. In step ST71, in a case where the zoom magnification stored in the storage 52 is the second zoom magnification, the flying imaging support processing transitions to step ST73.

In step ST72, the first angle-of-view setting instruction transmission control unit 188 transmits the first angle-of-view setting instruction with respect to the first zoom magnification to the flying object 310 through the communication apparatus 12. After the processing of step ST72 is executed, the flying imaging support processing transitions to step ST80. In a case where the first angle-of-view setting instruction is transmitted to the flying object 310 by executing the processing of step ST72, processing of step ST103 to step ST105 of the flying imaging processing (refer to FIG. 41) is executed by the processor 351 of the flying object 310. Accordingly, the angle-of-view setting report is transmitted to the base station 10 from the flying object 310.

In step ST73, the distance derivation unit 190 derives the distance between the inspection target surface 4G and the target imaging position 8A based on the distance information stored in the storage 52 in step ST15. After the processing of step ST73 is executed, the flying imaging support processing transitions to step ST74.

In step ST74, the second angle-of-view setting instruction generation unit 192 adjusts the second zoom magnification to the zoom magnification at which the pixel resolution of the imaging apparatus 330 has the above predetermined value based on the distance derived in step ST73. The second angle-of-view setting instruction generation unit 192 generates the second angle-of-view setting instruction corresponding to the second zoom magnification adjusted based on the distance derived in step ST73. After the processing of step ST74 is executed, the flying imaging support processing transitions to step ST75.

In step ST75, the second angle-of-view setting instruction transmission control unit 194 performs a control of transmitting the second angle-of-view setting instruction generated in step ST74 to the flying object 310 through the communication apparatus 12. After the processing of step ST75 is executed, the flying imaging support processing transitions to step ST80. In a case where the second angle-of-view setting instruction is transmitted to the flying object 310 by executing the processing of step ST75, the processing of step ST103 to step ST105 of the flying imaging processing (refer to FIG. 41) is executed by the processor 351 of the flying object 310. Accordingly, the angle-of-view setting report is transmitted to the base station 10 from the flying object 310.

As described above, the angle-of-view setting report is transmitted to the base station 10 from the flying object 310 by executing the processing of step ST72, and the angle-of-view setting report is transmitted to the base station 10 from the flying object 310 by executing the processing of step ST75. Therefore, in step ST80, the angle-of-view setting report reception determination unit 196 determines whether or not the angle-of-view setting report transmitted from the flying object 310 is received by the communication apparatus 12. In step ST80, in a case where the angle-of-view setting report is not received by the communication apparatus 12, a negative determination is made, and the determination of step ST80 is performed again. In step ST80, in a case where the angle-of-view setting report is received by the communication apparatus 12, a positive determination is made, and the flying imaging support processing transitions to step ST81.

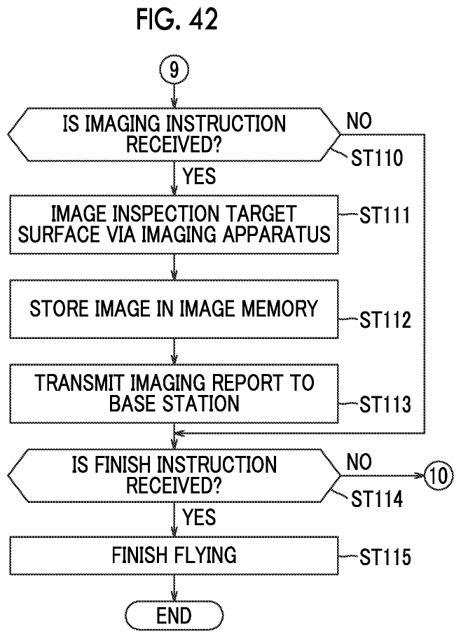

In step ST81, the imaging instruction transmission control unit 198 transmits the imaging instruction to the flying object 310 through the communication apparatus 12. After the processing of step ST81 is executed, the flying imaging support processing transitions to step ST82. In a case where the imaging instruction is transmitted to the flying object 310 by executing the processing of step ST81, processing of step ST110 to step ST113 of the flying imaging processing (refer to FIG. 42) is executed by the processor 351 of the flying object 310. Accordingly, the imaging report is transmitted to the base station 10 from the flying object 310.

Therefore, in step ST82, the imaging report reception determination unit 200 determines whether or not the imaging report transmitted from the flying object 310 is received by the communication apparatus 12. In step ST82, in a case where the imaging report is not received by the communication apparatus 12, a negative determination is made, and the determination of step ST82 is performed again. In step ST82, in a case where the imaging report is received by the communication apparatus 12, a positive determination is made, and the flying imaging support processing transitions to step ST83.

In step ST83, the finish determination unit 202 determines whether or not the condition for finishing the flying imaging support processing is established. Examples of the condition for finishing the flying imaging support processing include a condition that the number of imaging reports received in step ST82 (that is, the number of times positive determinations are made in step ST82) has reached the number of imaging positions 8A. In step ST83, in a case where the condition for finishing the flying imaging support processing is not established, a negative determination is made, and the flying imaging support processing transitions to step ST42. By repeatedly executing the above flying imaging support processing, a plurality of images are acquired. In step ST83, in a case where the condition for finishing the flying imaging support processing is established, a positive determination is made, and the flying imaging support processing transitions to step ST84.

In step ST84, the finish instruction transmission control unit 204 transmits the finish instruction to the flying object 310 through the communication apparatus 12. After the processing of step ST84 is executed, the flying imaging support processing is finished.

Next, an example of a flow of the flying imaging processing performed by the processor 351 of the flying object 310 will be described with reference to FIG. 40 to FIG. 42. In the flying imaging processing illustrated in FIG. 40, first, in step ST90, the flying instruction reception determination unit 402 determines whether or not the flying instruction is received by the communication apparatus 312. In step ST90, in a case where the flying instruction is not received by the communication apparatus 312, a negative determination is made, and the flying imaging processing transitions to step ST92. In step ST90, in a case where the flying instruction is received by the communication apparatus 312, a positive determination is made, and the flying imaging processing transitions to step ST91.

In step ST91, the flying control unit 404 controls the flying apparatus 340 in accordance with the flying instruction. After the processing of step ST91 is executed, the flying imaging processing transitions to step ST92.

In step ST92, the hovering instruction reception determination unit 406 determines whether or not the hovering instruction is received by the communication apparatus 312. In step ST92, in a case where the hovering instruction is not received by the communication apparatus 312, a negative determination is made, and the flying imaging processing transitions to step ST100. In step ST92, in a case where the hovering instruction is received by the communication apparatus 312, a positive determination is made, and the flying imaging processing transitions to step ST93.

In step ST93, the hovering control unit 408 causes the flying object 310 to hover. After the processing of step ST93 is executed, the flying imaging processing transitions to step ST94.

In step ST94, the hovering report transmission control unit 410 transmits the hovering report to the base station 10 through the communication apparatus 312. After the processing of step ST94 is executed, the flying imaging processing transitions to step ST100.

In step ST100, the posture correction instruction reception determination unit 412 determines whether or not the posture correction instruction is received by the communication apparatus 312. In step ST100, in a case where the posture correction instruction is not received by the communication apparatus 312, a negative determination is made, and the flying imaging processing transitions to step ST103. In step ST100, in a case where the posture correction instruction is received by the communication apparatus 312, a positive determination is made, and the flying imaging processing transitions to step ST101.

In step ST101, the posture correction control unit 414 corrects the posture of the flying object 310 in accordance with the posture correction instruction. After the processing of step ST101 is executed, the flying imaging processing transitions to step ST102.

In step ST102, the posture correction report transmission control unit 416 transmits the posture correction report to the base station 10 through the communication apparatus 312. After the processing of step ST102 is executed, the flying imaging processing transitions to step ST103.

In step ST103, the angle-of-view setting instruction reception determination unit 418 determines whether or not the angle-of-view setting instruction is received by the communication apparatus 312. In step ST103, in a case where the angle-of-view setting instruction is not received by the communication apparatus 312, a negative determination is made, and the flying imaging processing transitions to step ST110. In step ST103, in a case where the angle-of-view setting instruction is received by the communication apparatus 312, a positive determination is made, and the flying imaging processing transitions to step ST104.

In step ST104, the angle-of-view control unit 420 sets the angle of view of the imaging apparatus 330 to the angle of view corresponding to the angle-of-view setting instruction. After the processing of step ST104 is executed, the flying imaging processing transitions to step ST105.

In step ST105, the angle-of-view setting report transmission control unit 422 transmits the angle-of-view setting report to the base station 10 through the communication apparatus 312. After the processing of step ST105 is executed, the flying imaging processing transitions to step ST110.

In step ST110, the imaging instruction reception determination unit 424 determines whether or not the imaging instruction is received by the communication apparatus 312. In step ST110, in a case where the imaging instruction is not received by the communication apparatus 312, a negative determination is made, and the flying imaging processing transitions to step ST114. In step ST110, in a case where the imaging instruction is received by the communication apparatus 312, a positive determination is made, and the flying imaging processing transitions to step ST111.

In step ST111, the imaging control unit 426 causes the imaging apparatus 330 to image the inspection target surface 4G. After the processing of step ST111 is executed, the flying imaging processing transitions to step ST112.

In step ST112, the image information storage control unit 118 stores the image obtained by capturing via the imaging apparatus 330 in the image memory 314. After the processing of step ST112 is executed, the flying imaging processing transitions to step ST113.

In step ST113, the imaging report transmission control unit 430 transmits the imaging report to the base station 10 through the communication apparatus 312. After the processing of step ST113 is executed, the flying imaging processing transitions to step ST114.

In step ST114, the finish instruction reception determination unit 432 determines whether or not the communication apparatus 312 has received the finish instruction. In step ST114, in a case where the communication apparatus 312 has not received the finish instruction, a negative determination is made, and the flying imaging processing transitions to step ST90. In step ST114, in a case where the communication apparatus 312 has received the finish instruction, a positive determination is made, and the flying imaging processing transitions to step ST115.

In step ST115, the finish control unit 434 finishes flying of the flying object 310. Examples of the control of finishing flying via the finish control unit 434 include the control of causing the flying object 310 to land, the control of causing the flying object 310 to return to the position at which the flying object 310 has started the flying imaging processing, and/or the control of switching the flying object 310 to be maneuvered using the maneuvering apparatus (not illustrated). After the processing of step ST115 is executed, the flying imaging processing is finished.

The above control method described as the action of the imaging system S is an example of a “control method” according to the embodiment of the disclosed technology.

As described above, in the first embodiment, the processor 51 causes the rotational drive apparatus 20 to which the distance measurement device 40 is attached to rotate the distance measurement device 40 and causes the distance measurement device 40 to measure the distance between the wall surface 4 and the distance measurement device 40 at the plurality of distance measurement locations of the wall surface 4. In addition, the processor 51 sets the flying route 8 for causing the flying object 310 to fly along the wall surface 4 based on the distance measured for each distance measurement location. The processor 51 performs a control of causing the flying object 310 to fly along the flying route 8 and causing the imaging apparatus 330 mounted on the flying object 310 to image the plurality of imaged regions of the wall surface 4. Accordingly, for example, without using the satellite positioning system, the flying object 310 can fly along the wall surface 4, and the plurality of imaged regions of the wall surface 4 can be imaged by the imaging apparatus 330.

In addition, in the case of causing the flying object 310 to fly along the flying route 8 and acquiring a plurality of images by causing the imaging apparatus 330 mounted on the flying object 310 to image the plurality of imaged regions of the wall surface 4, the processor 51 performs a control of constantly maintaining the pixel resolution of the imaging apparatus 330. Accordingly, for example, even in a case where the wall surface 4 has the recessed portion 4F, resolution of the image can be constantly maintained.

In addition, the processor 51 adjusts the rotational angle of the rotational drive apparatus 20 to the rotational angle at which the flying object 310 is included within the distance measurement range 41 of the distance measurement device 40, and causes the distance measurement device 40 to measure the distance between the flying object 310 and the distance measurement device 40. The processor 51 performs a control of causing the flying object 310 to fly along the flying route 8 based on the rotational angle of the rotational drive apparatus 20 and on the distance between the flying object 310 and the distance measurement device 40. Accordingly, for example, the flying object 310 can fly within a wide range, compared to a case where the distance measurement range 41 of the distance measurement device 40 is fixed.

In addition, the processor 51 derives the absolute coordinates of the flying object 310 based on the absolute coordinates of the rotational drive apparatus 20, the rotational angle of the rotational drive apparatus 20, the angle of the laser light emitted from the distance measurement device 40 toward the flying object 310, and the distance between the flying object 310 and the distance measurement device 40. A control of causing the flying object 310 to fly along the flying route 8 based on the absolute coordinates of the flying object 310 is performed. Accordingly, for example, without using the satellite positioning system, the flying object 310 can fly along the wall surface 4 based on the absolute coordinates of the flying object 310.

In addition, the processor 51 performs a control of adjusting the rotational angle of the rotational drive apparatus 20 to the rotational angle at which the flying object 310 is included within the distance measurement range 41 of the distance measurement device 40 based on the image obtained by imaging the flying object 310 via the imaging apparatus 30. Accordingly, for example, the distance measurement range 41 of the distance measurement device 40 can move following the flying object 310.

In addition, the processor 51 performs a control of adjusting the rotational angle of the rotational drive apparatus 20 to the angle at which the flying object 310 is positioned in the center portion of the angle of view of the imaging apparatus 30. Accordingly, for example, even in a case where the flying object 310 moves, separation of the flying object 310 from the angle of view of the imaging apparatus 30 can be suppressed, compared to a case where the rotational angle of the rotational drive apparatus 20 is adjusted to an angle at which the flying object 310 is positioned at a position separated from the center portion of the angle of view of the imaging apparatus 30.

In addition, the flying object 310 comprises the plurality of propellers 341 categorized with different aspects. The processor 51 controls the posture of the flying object 310 based on the positions of the plurality of propellers 341 captured in the image obtained by capturing via the imaging apparatus 30. Accordingly, for example, the posture of the flying object 310 can be accurately controlled, compared to a case where the plurality of propellers 341 are not categorized with different aspects.

In addition, the plurality of propellers 341 are categorized with different colors. Accordingly, for example, the posture of the flying object 310 can be specified by a simple configuration of only varying the colors of the plurality of propellers 341.

In addition, the flying object 310 acquires a plurality of images each time the flying object 310 reaches each of the plurality of imaging positions 8A set on the flying route 8. Accordingly, for example, a state of the wall surface 4 can be inspected by analyzing the plurality of images via the image analysis apparatus 2.

In addition, the plurality of imaging positions 8A are set to the positions at which the images acquired at the adjacent imaging positions 8A among the plurality of imaging positions 8A partially overlap with each other. Accordingly, for example, images can be recognized as adjacent images based on an overlap amount between the images in the image analysis apparatus 2.

In addition, in a case where the flying object 310 flies across the recessed portion 4F, the processor 51 performs the control of constantly maintaining the pixel resolution of the imaging apparatus 330 by operating at least one of the zoom lens 335C or the focus lens 335B of the imaging apparatus 330. Accordingly, for example, even in a case where the flying object 310 flies across the recessed portion 4F, the pixel resolution of the imaging apparatus 330 can be constantly maintained.

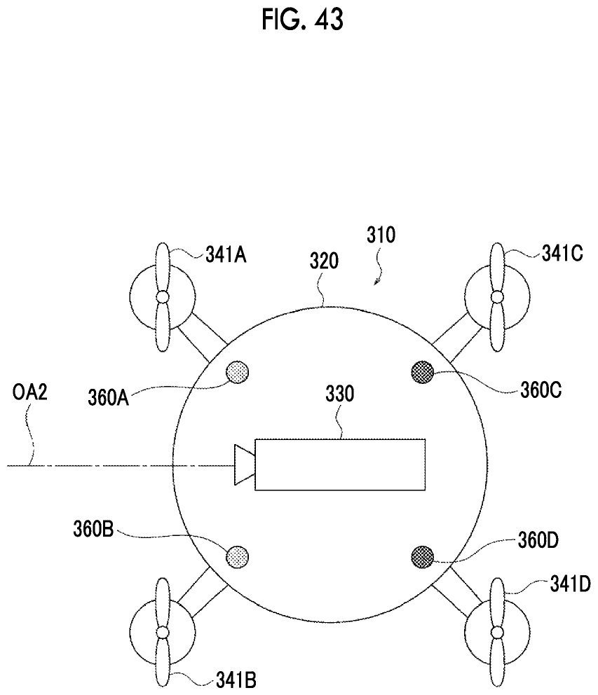

As illustrated in FIG. 43 as an example, the flying object 310 may comprise a first member 360A, a second member 360B, a third member 360C, and a fourth member 360D. The first member 360A is disposed on a right side of a front portion of the flying object body 320. The second member 360B is disposed on a left side of the front portion of the flying object body 320. The third member 360C is disposed on a right side of a rear portion of the flying object body 320. The fourth member 360D is disposed on a left side of the rear portion of the flying object body 320.

As an example, the first member 360A and the third member 360C are disposed on the right side of the imaging apparatus 330, and the second member 360B and the fourth member 360D are disposed on the left side of the imaging apparatus 330. The first member 360A is disposed at a position of line symmetry with the second member 360B about the optical axis OA2 of the imaging apparatus 330 in a plan view. The third member 360C is disposed at a position of line symmetry with the fourth member 360D about the optical axis OA2 of the imaging apparatus 330 in a plan view. The first member 360A, the second member 360B, the third member 360C, and the fourth member 360D are an example of a “plurality of members” according to the embodiment of the disclosed technology.

The first member 360A, the second member 360B, the third member 360C, and the fourth member 360D are categorized with different colors as an example of different aspects. In FIG. 43, the color of each member is represented by a dot provided to each of the first member 360A, the second member 360B, the third member 360C, and the fourth member 360D.

As an example, the color of the first member 360A is the same as the color of the second member 360B, and the color of the third member 360C is the same as the color of the fourth member 360D. A first color set for the first member 360A and the second member 360B is different from a second color set for the third member 360C and the fourth member 360D. Each of the first color and the second color may be a chromatic color or an achromatic color. The first color and the second color may be any color as long as the processor 51 (refer to FIG. 4) of the base station 10, described later, can identify the first color and the second color based on the image obtained by capturing via the imaging apparatus 30.

While the first color is set for the first member 360A and the second member 360B and the second color is set for the third member 360C and the fourth member 360D in the example illustrated in FIG. 43, this is merely an example. The first color may be set for the first member 360A and the third member 360C, and the second color may be set for the second member 360B and the fourth member 360D. In addition, the first color may be set for the first member 360A and the fourth member 360D, and the second color may be set for the second member 360B and the third member 360C. In addition, colors different from each other may be set for the first member 360A, the second member 360B, the third member 360C, and the fourth member 360D.

In addition, the first member 360A, the second member 360B, the third member 360C, and the fourth member 360D may be light-emitting objects that emit light of different colors as an example of different aspects. Furthermore, the first member 360A, the second member 360B, the third member 360C, and the fourth member 360D may be light-emitting objects that turn on and off with different turn-on and turn-off patterns as an example of different aspects.

According to such a modification example, the posture of the flying object 310 can also be specified with a simple configuration of only varying aspects of the first member 360A, the second member 360B, the third member 360C, and the fourth member 360D.

In addition, in the first embodiment, instead of the distance determination unit 136, the processor 51 may determine whether or not the inspection target surface 4G has the recessed portion 4F by executing image recognition processing with respect to the image information stored in the storage 52 to determine whether or not an image corresponding to the recessed portion 4F is included in the image represented by the image information. In a case where the inspection target surface 4G has the recessed portion 4F, the processing of the first zoom magnification determination unit 138, the first zoom magnification storage control unit 140, and the first flying route setting unit 142 may be executed. In a case where the inspection target surface 4G does not have the recessed portion 4F, the processing of the second zoom magnification determination unit 144, the second zoom magnification storage control unit 146, and the second flying route setting unit 148 may be executed. Even in this case, the resolution of the image can be constantly maintained.

In addition, the processor 51 may determine whether or not the inspection target surface 4G has the recessed portion 4F and, in a case where it is determined that the inspection target surface 4G has the recessed portion 4F, further determine whether or not the area of the opening portion 4F1 of the recessed portion 4F is less than a predetermined area. For example, the predetermined opening area is set to be less than the area through which the flying object 310 can enter inside the recessed portion 4F. In a case where it is determined that the inspection target surface 4G does not have the recessed portion 4F, the processor 51 may set the flying route 8 along the inspection target surface 4G.

In addition, in a case where it is determined that the area of the opening portion 4F1 of the recessed portion 4F is greater than or equal to the predetermined area while the inspection target surface 4G has the recessed portion 4F, the processor 51 may set the flying route 8 that passes through the tracing surface 6 along an inner surface of the recessed portion 4F. On the other hand, in a case where it is determined that the inspection target surface 4G has the recessed portion 4F and where the area of the opening portion 4F1 of the recessed portion 4F is less than the predetermined area, the processor 51 may set the flying route 8 on the smooth surface 7 facing the inspection target surface 4G having the recessed portion 4F (that is, a smooth virtual plane facing the inspection target surface 4G). Even in this case, the resolution of the image can be constantly maintained.

In addition, while the inspection target object 3 has the recessed portion 4F in the first embodiment, a protruding portion may be provided instead of the recessed portion 4F. In the case of causing the flying object 310 to fly along the flying route 8 and acquiring a plurality of images by causing the imaging apparatus 330 mounted on the flying object 310 to image the inspection target surface 4G, the processor 51 may perform the control of constantly maintaining the pixel resolution of the imaging apparatus 330.

### Second Embodiment

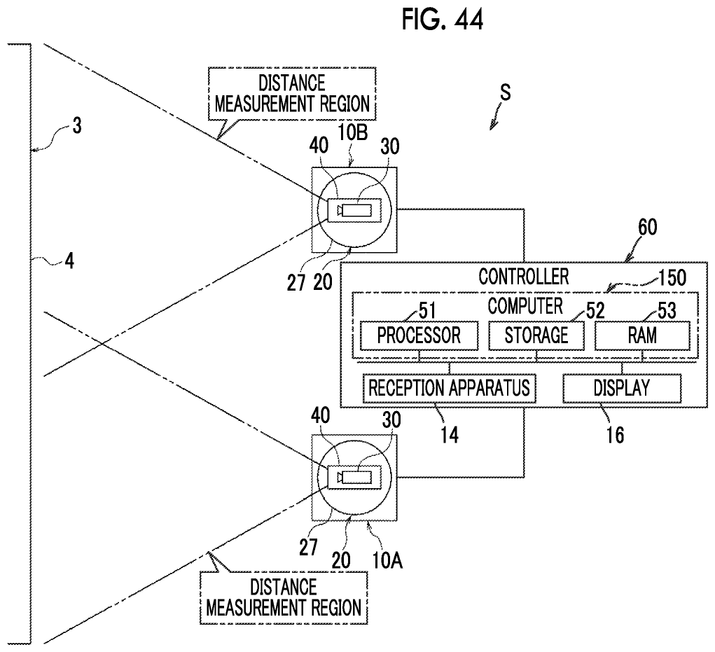

As illustrated in FIG. 44 as an example, a configuration of the imaging system S in a second embodiment is changed from that in the first embodiment as follows.

That is, the imaging system S comprises a first base station 10A and a second base station 10B as an example of a plurality of base stations. The imaging system S comprises a controller 60 that is common to the first base station 10A and to the second base station 10B. The controller 60 comprises the reception apparatus 14, the display 16, and a computer 150. Points that the computer 150 comprises the processor 51, the storage 52, and the RAM 53 and that the processor 51, the storage 52, the RAM 53, the reception apparatus 14, and the display 16 are connected to a bus are the same as the first embodiment.

In the following description, each of the first base station 10A and the second base station 10B will be referred to as the base station 10 unless otherwise required to distinguish between the first base station 10A and the second base station 10B. Each base station 10 comprises the rotational drive apparatus 20, the imaging apparatus 30, and the distance measurement device 40. The rotational drive apparatus 20, the imaging apparatus 30, and the distance measurement device 40 are electrically connected to the controller 60. The rotational drive apparatus 20, the imaging apparatus 30, and the distance measurement device 40 have the same configurations as the first embodiment.

The first base station 10A and the second base station 10B are installed at positions where the wall surface 4 of the inspection target object 3 can be imaged by the imaging apparatus 30 and where the distance between the wall surface 4 and the distance measurement device 40 can be measured by the distance measurement device 40. For example, in a case where the inspection target object 3 is a bridge across a river, the first base station 10A is installed on a river bank on one side of the river, and the second base station 10B is installed on a river bank on the other side of the river.

As an example, the first base station 10A and the second base station 10B are installed at positions where the distance measurement regions of each distance measurement device 40 partially overlap with each other. Hereinafter, an example in which the distance measurement device 40 emits the laser light upward at an inclination will be described as an example. The rotational drive apparatus 20, the imaging apparatus 30, and the distance measurement device 40 of the first base station 10A are examples of a “first rotational drive apparatus”, a “first imaging apparatus”, and a “first distance measurement device” according to the embodiment of the disclosed technology. The rotational drive apparatus 20, the imaging apparatus 30, and the distance measurement device 40 of the second base station 10B are examples of a “second rotational drive apparatus”, a “second imaging apparatus”, and a “second distance measurement device” according to the embodiment of the disclosed technology.

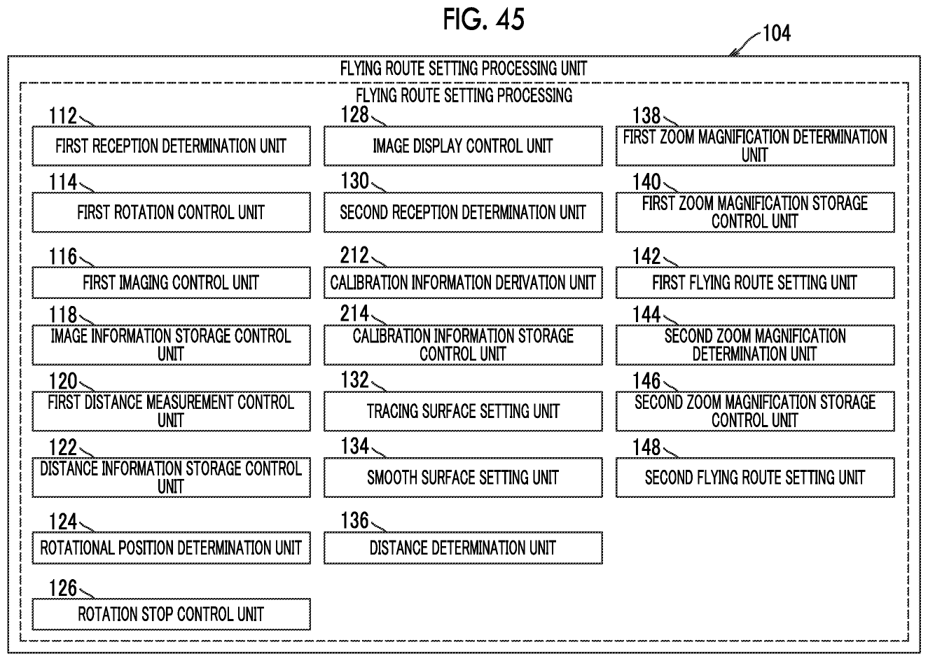

As illustrated in FIG. 45 as an example, the flying route setting processing unit 104 includes a calibration information derivation unit 212 and a calibration information storage control unit 214 in addition to the first reception determination unit 112, the first rotation control unit 114, the first imaging control unit 116, the image information storage control unit 118, the first distance measurement control unit 120, the distance information storage control unit 122, the rotational position determination unit 124, the rotation stop control unit 126, the image display control unit 128, the second reception determination unit 130, the tracing surface setting unit 132, the smooth surface setting unit 134, the distance determination unit 136, the first zoom magnification determination unit 138, the first zoom magnification storage control unit 140, the first flying route setting unit 142, the second zoom magnification determination unit 144, the second zoom magnification storage control unit 146, and the second flying route setting unit 148.

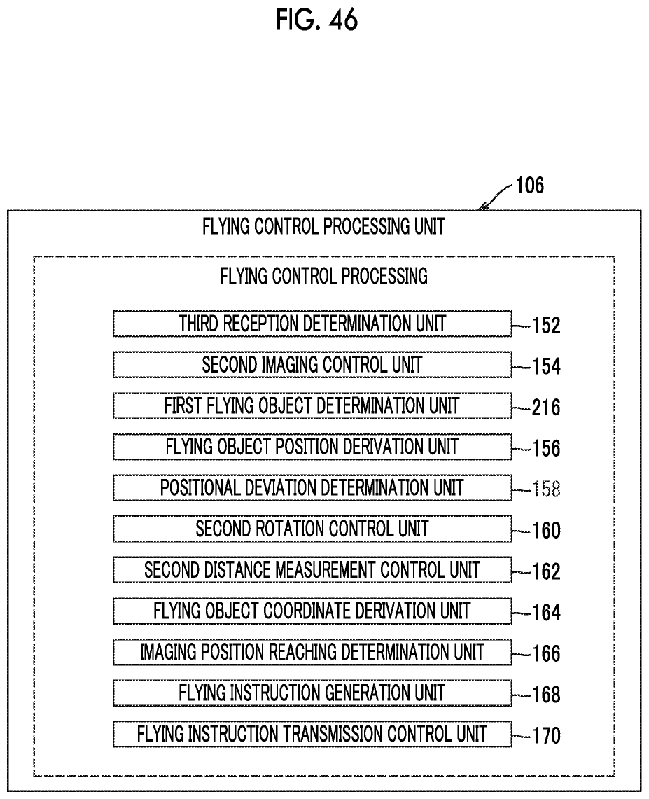

As illustrated in FIG. 46 as an example, the flying control processing unit 106 includes a first flying object determination unit 216 in addition to the third reception determination unit 152, the second imaging control unit 154, the flying object position derivation unit 156, the positional deviation determination unit 158, the second rotation control unit 160, the second distance measurement control unit 162, the flying object coordinate derivation unit 164, the imaging position reaching determination unit 166, the flying instruction generation unit 168, and the flying instruction transmission control unit 170.

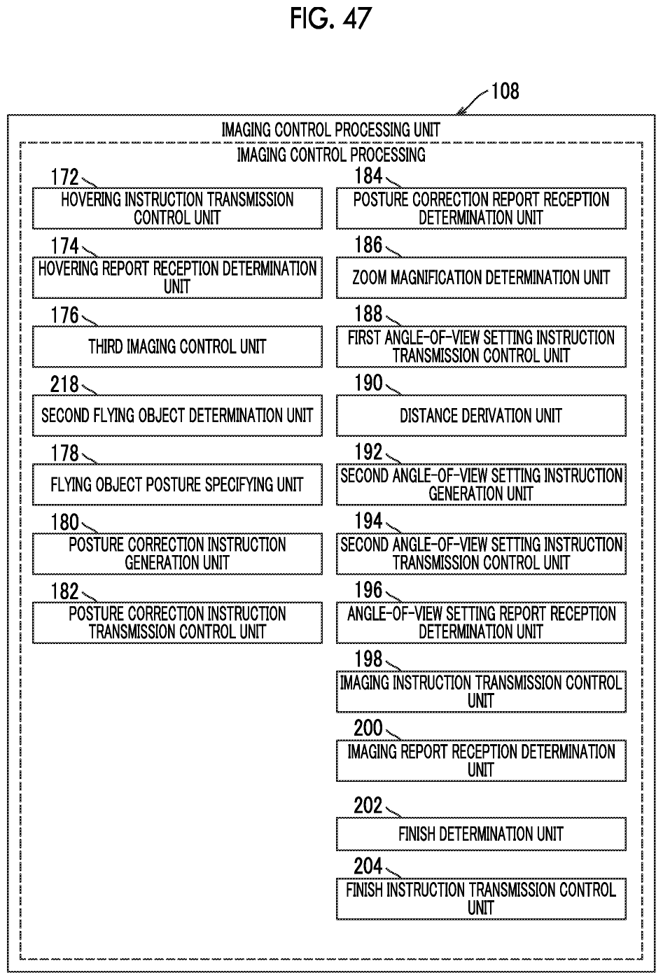

As illustrated in FIG. 47 as an example, the imaging control processing unit 108 includes a second flying object determination unit 218 in addition to the hovering instruction transmission control unit 172, the hovering report reception determination unit 174, the third imaging control unit 176, the flying object posture specifying unit 178, the posture correction instruction generation unit 180, the posture correction instruction transmission control unit 182, the posture correction report reception determination unit 184, the zoom magnification determination unit 186, the first angle-of-view setting instruction transmission control unit 188, the distance derivation unit 190, the second angle-of-view setting instruction generation unit 192, the second angle-of-view setting instruction transmission control unit 194, the angle-of-view setting report reception determination unit 196, the imaging instruction transmission control unit 198, the imaging report reception determination unit 200, the finish determination unit 202, and the finish instruction transmission control unit 204.

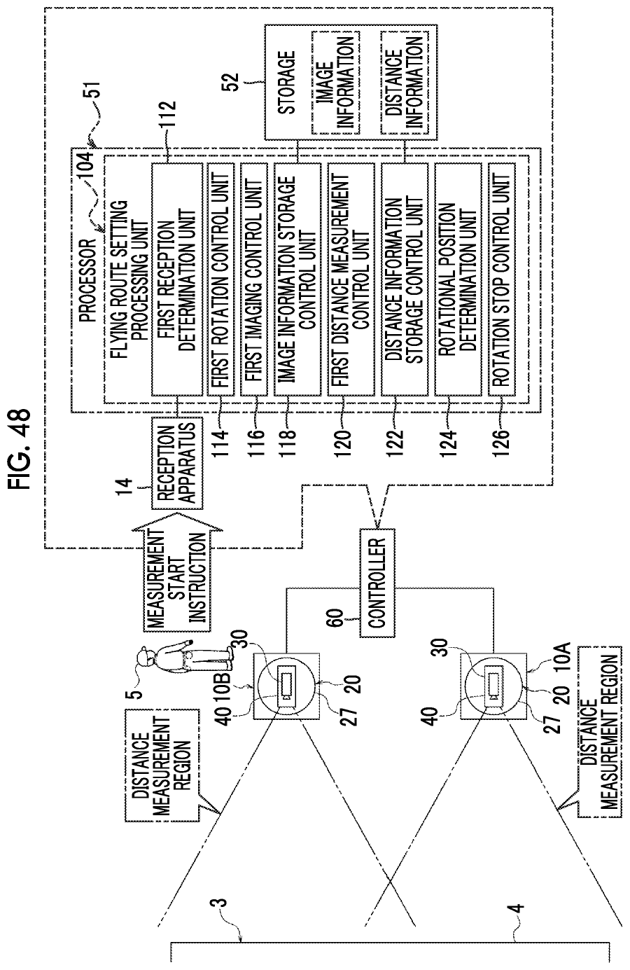

As illustrated in FIG. 48 as an example, the worker 5 provides the measurement start instruction to the reception apparatus 14. The first reception determination unit 112 determines whether or not the measurement start instruction is received by the reception apparatus 14.

In a case where the first reception determination unit 112 determines that the measurement start instruction is received by the reception apparatus 14, the first rotation control unit 114 performs the control of rotating the seat 27 from the first rotational position toward the second rotational position via the rotational drive apparatus 20 of each base station 10. Hereinafter, an example in which the first rotation control unit 114 synchronously rotates the seat 27 of each base station 10 will be described as an example.

The first imaging control unit 116 performs the control of imaging the wall surface 4 via the imaging apparatus 30 of each base station 10. The image information storage control unit 118 generates the image information by associating the image obtained by capturing via the imaging apparatus 30 of each base station 10 with the rotational position of the seat 27 detected by the rotation detector (not illustrated) provided in the pan/tilt mechanism 26 and/or the seat 27 and stores the image information in the storage 52.

The first distance measurement control unit 120 performs the control of scanning the wall surface 4 with the laser light via the distance measurement device 40 of each base station 10. During scanning of the distance measurement device 40 of each base station 10 performed once, the distance between the wall surface 4 and the distance measurement device 40 is measured at the plurality of distance measurement locations in the part of the wall surface 4 in the horizontal direction.

Hereinafter, in the case of distinguishing between a distance measurement location measured by the distance measurement device 40 of the first base station 10A and a distance measurement location measured by the distance measurement device 40 of the second base station 10B, the distance measurement location measured by the distance measurement device 40 of the first base station 10A will be referred to as a first distance measurement location, and the distance measurement location measured by the distance measurement device 40 of the second base station 10B will be referred to as a second distance measurement location.

The first distance measurement location is an example of a “first distance measurement location” according to the embodiment of the disclosed technology, and the second distance measurement location is an example of a “second distance measurement location” according to the embodiment of the disclosed technology. The distance between the wall surface 4 and the distance measurement device 40 measured by the distance measurement device 40 of the first base station 10A is an example of the “first distance” according to the embodiment of the disclosed technology, and the distance between the wall surface 4 and the distance measurement device 40 measured by the distance measurement device 40 of the second base station 10B is an example of the “second distance” according to the embodiment of the disclosed technology.

The distance information storage control unit 122 generates the distance information by associating the distance measured for each distance measurement location by each base station 10 with the rotational position of the seat 27 detected by the rotation detector (not illustrated) provided in the pan/tilt mechanism 26 and/or the seat 27 and with the rotational angle of the scanner minor 47 detected by the angle detector (not illustrated) provided in the scanner mirror 47 and stores the distance information in the storage 52.

The rotational position determination unit 124 determines whether or not the rotational position of the seat 27 of each base station 10 has reached the second rotational position. The rotational position determination unit 124 determines whether or not the rotational position of the seat 27 has reached the second rotational position by, for example, comparing the rotational position of the seat 27 detected by the rotation detector (not illustrated) provided in the pan/tilt mechanism 26 and/or the seat 27 and the position of the second rotational position with each other.

In a case where the rotational position determination unit 124 determines that the rotational position of the seat 27 of each base station 10 has reached the second rotational position, the rotation stop control unit 126 performs the control of stopping rotation of the seat 27 via each rotational drive apparatus 20.

According to the above, in each base station 10, the image information and the distance information corresponding to the wall surface 4 are obtained by imaging the wall surface 4 a plurality of times via the imaging apparatus 30 and by scanning the wall surface 4 a plurality of times via the distance measurement device 40 while the seat 27 rotates from the first rotational position to the second rotational position.

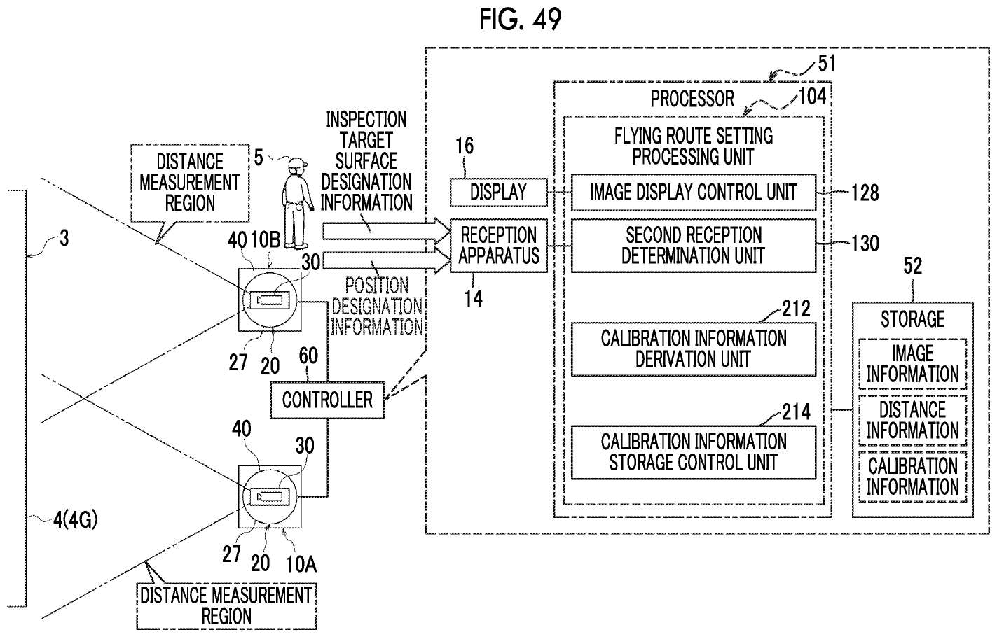

As illustrated in FIG. 49 as an example, in the controller 60, the image display control unit 128 performs the control of displaying the image (that is, the image in which the wall surface 4 is represented as an image) on the display 16 based on the image information stored in the storage 52.

The worker 5 determines the inspection target surface 4G to be inspected by the flying object 310 based on the image displayed on the display 16. The worker 5 provides the inspection target surface designation information indicating designation of the inspection target surface 4G to the reception apparatus 14. Hereinafter, an example in which the wall surface 4 is determined as the inspection target surface 4G will be described as an example.

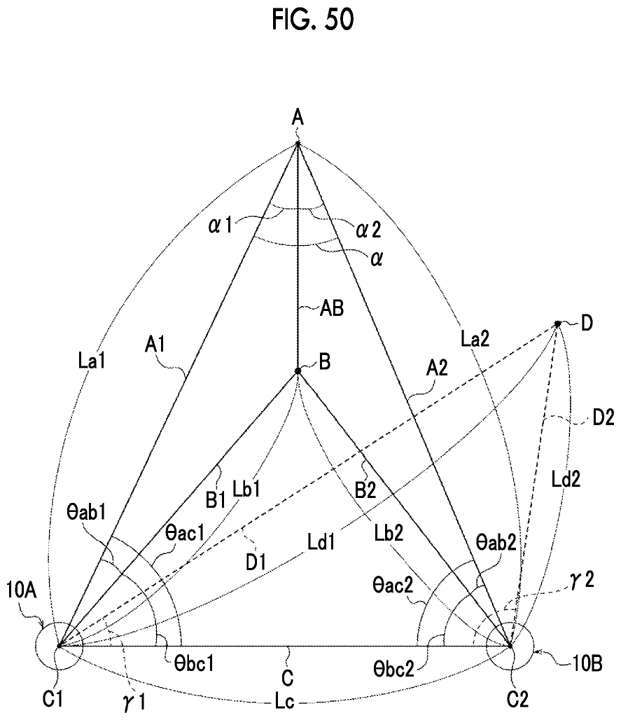

In addition, the worker 5 determines a plurality of positions of the wall surface 4 from a region in which the distance measurement regions of each distance measurement device 40 overlap with each other based on the image displayed on the display 16. Position designation information indicating designation of the plurality of positions is provided to the reception apparatus 14. Hereinafter, an example in which a point A and a point B of the wall surface 4 are determined as the plurality of positions as illustrated in FIG. 50 as an example will be described. The point A and the point B are positions separated from each other in the horizontal direction and in the vertical direction.

The second reception determination unit 130 determines whether or not the inspection target surface designation information and the position designation information are received by the reception apparatus 14.

The calibration information derivation unit 212 derives calibration information based on the position designation information and on the distance information. As will be described later, the calibration information is information for converting the distance measured by the distance measurement device 40 of the second base station 10B (that is, the distance between the wall surface 4 and the second base station 10B into a distance with reference to the position of the distance measurement device 40 of the first base station 10A. In addition, the calibration information is information for converting the position of the flying object 310 measured by the distance measurement device 40 of the second base station 10B into a position with reference to the position of the distance measurement device 40 of the first base station 10A. Specifically, the calibration information derivation unit 212 derives the calibration information using the following procedure.

First, the calibration information derivation unit 212 calculates a length La1 of a side A1 based on the distance information. The side A1 is a side connecting the point A and a point C1 of the first base station 10A to each other. Next, the calibration information derivation unit 212 calculates an angle θac1 based on the distance information. The angle θac1 is an angle between the side A1 and a side C. The side C is a side connecting the point C1 of the first base station 10A and a point C2 of the second base station 10B to each other.

Next, the calibration information derivation unit 212 calculates a length Lb1 of a side B1 based on the distance information. The side B1 is a side connecting the point B and the point C1 indicating the position at which the first base station 10A is installed to each other. Next, the calibration information derivation unit 212 calculates an angle θbc1 based on the distance information. The angle θbc1 is an angle between the side B1 and the side C.

The calibration information derivation unit 212 calculates an angle θab1 based on Expression (1) below. The angle θab1 is an angle between the side A1 and the side B1.

θ_{ab}1=θ_{ac}1−θ_{bc}1 (1)

Similarly, the calibration information derivation unit 212 calculates a length La2 of a side A2 based on the distance information. The side A2 is a side connecting the point A and the point C2 indicating the position at which the second base station 10B is installed to each other. Next, the calibration information derivation unit 212 calculates an angle θac2 based on the distance information. The angle θac2 is an angle between the side A2 and the side C.

Next, the calibration information derivation unit 212 calculates a length Lb2 of a side B2 based on the distance information. The side B2 is a side connecting the point C2 of the second base station 10B and the point B to each other. Next, the calibration information derivation unit 212 calculates an angle θbc2 based on the distance information. The angle θbc2 is an angle between the side B2 and the side C.

The calibration information derivation unit 212 calculates an angle θab2 based on Expression (2) below. The angle θab2 is an angle between the side A2 and the side B2.

θ_{ab}2=θ_{ac}2−θ_{bc}2 (2)

Next, the calibration information derivation unit 212 calculates an angle α1 based on Expression (3) below depending on the law of cosines. The angle α1 is an angle between the side A1 and a side AB. The side AB is a side connecting the point A and the point B to each other.

$$α 1 = {cos}^{- 1} \frac{{L}_{a} 1 - {L}_{b} 1 cos ( {θ}_{a c} 1 - {θ}_{bc} 1 )}{\sqrt{{L}_{a} {1}^{2} + {L}_{b} {1}^{2} - 2 {L}_{a} 1 {L}_{b} 1 cos ( {θ}_{a c} 1 - {θ}_{bc} 1 )}} \qquad ( 3 )$$

Similarly, the calibration information derivation unit 212 calculates an angle α2 based on Expression (4) below depending on the law of cosines. The angle α2 is an angle between the side A2 and the side AB.

$$α 2 = {cos}^{- 1} \frac{{L}_{a} 2 - {L}_{b} 2 cos ( {θ}_{a c} 2 - {θ}_{bc} 2 )}{\sqrt{{L}_{a} {2}^{2} + {L}_{b} {2}^{2} - 2 {L}_{a} 2 {L}_{b} 2 cos ( {θ}_{a c} 2 - {θ}_{bc} 2 )}} \qquad ( 4 )$$

The calibration information derivation unit 212 calculates an angle α based on Expression (5) below.

α=α1+α2 (5)

Next, the calibration information derivation unit 212 calculates a length Lc of the side C based on Expression (6) below depending on the law of cosines.

L_{c}=\sqrt{Lₐ1²+Lₐ2²−2Lₐ1Lₐ2 cos α} (6)

In addition, the calibration information derivation unit 212 derives coordinates of the side C as an angular reference.

According to the above, for an unknown position D (for example, a position on the wall surface 4 or the position of the flying object 310), a length Ld2 and an angle γ2 of a side D2 measured by the second base station 10B can be converted into a length Ld1 and an angle γ1 of a side D1 measured in a pseudo manner by the first base station 10A based on Expression (7) below and Expression (8) below using the length Lc calculated using Expression (6) (that is, using a distance between the first base station 10A and the second base station 10B). The side D1 is a side connecting the position D and the point C1 of the first base station 10A to each other, and the side D2 is a side connecting the position D and the point C2 of the second base station 10B to each other. The angle γ1 and the angle γ2 are angles with reference to the side C. The angle γ1 is an angle between the side D1 and the side C, and the angle γ2 is an angle between the side D2 and the side C.

The distance measured by the distance measurement device 40 of the second base station 10B is converted into a distance with reference to the position of the first base station 10A using Expression (7) below. The position of the first base station 10A is synonymous with the position of the distance measurement device 40 of the first base station 10A.

L_{d}1=L_{c}²+L_{d}2²−2L_{c}L_{d}2 cos γ2 (7)

In addition, the rotational angle of the rotational drive apparatus 20 of the second base station 10B is converted into an angle with reference to the position of the first base station 10A using Expression (8) below.

$$γ 1 = {cos}^{- 1} \frac{{L}_{c} - {L}_{d} 2 cos γ 2}{\sqrt{{L}_{c}^{2} + {L}_{d} {2}^{2} - 2 {L}_{c} {L}_{d} 2 cos γ 2}} \qquad ( 8 )$$

The calibration information storage control unit 214 stores a conversion expression obtained by substituting a value of the length Lc calculated using Expression (6) for the length Lc in Expression (7) and in Expression (8) below and the coordinates of the side C in the storage 52 as the calibration information. The calibration information stored in the storage 52 is an example of “predetermined first calibration information” and “predetermined second calibration information” according to the embodiment of the disclosed technology.

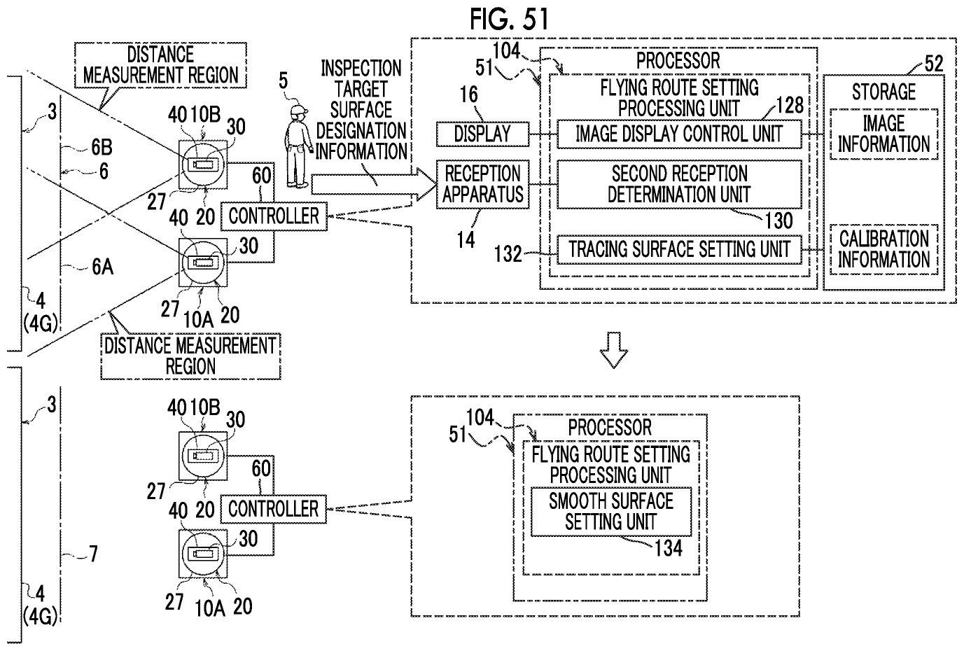

As illustrated in FIG. 51 as an example, in the controller 60, the image display control unit 128 performs the control of displaying the image (that is, the image in which the wall surface 4 is represented as an image) on the display 16 based on the image information stored in the storage 52.

The worker 5 determines the inspection target surface 4G based on the image displayed on the display 16. The worker 5 provides the inspection target surface designation information indicating designation of the inspection target surface 4G to the reception apparatus 14. The second reception determination unit 130 determines whether or not the inspection target surface designation information is received by the reception apparatus 14.

In a case where the second reception determination unit 130 determines that the inspection target surface designation information is received by the reception apparatus 14, the tracing surface setting unit 132 sets the tracing surface 6 based on the inspection target surface designation information. In the example illustrated in FIG. 51, the tracing surface 6, as an example, has the first tracing surface 6A positioned within the distance measurement region of the distance measurement device 40 of the first base station 10A and the second tracing surface 6B positioned within the distance measurement region of the distance measurement device 40 of the second base station 10B. In this case, for the second tracing surface 6B, the tracing surface setting unit 132 sets the second tracing surface 6B based on relative coordinates with reference to the position of the first base station 10A based on the calibration information stored in the storage 52. Accordingly, the entire tracing surface 6 is set based on the relative coordinates with reference to the position of the first base station 10A.

The smooth surface setting unit 134 sets the smooth surface 7 (that is, the smooth virtual plane facing the wall surface 4) by smoothing the tracing surface 6. The smooth surface 7 is also set based on the relative coordinates with reference to the position of the first base station 10A, in the same manner as the tracing surface 6. A method of setting the smooth surface 7 via the smooth surface setting unit 134 is the same as that in the first embodiment.

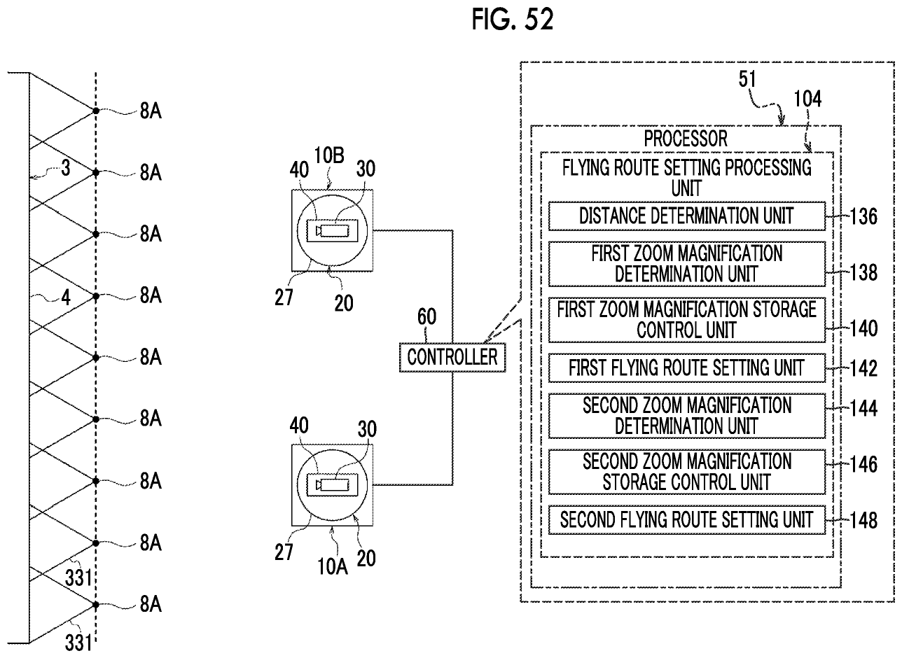

As illustrated in FIG. 52 as an example, functions of the distance determination unit 136, the first zoom magnification determination unit 138, the first zoom magnification storage control unit 140, the first flying route setting unit 142, the second zoom magnification determination unit 144, the second zoom magnification storage control unit 146, and the second flying route setting unit 148 are the same as those in the first embodiment. In the example illustrated in FIG. 52 as an example, the flying route 8 passing through the plurality of imaging positions 8A is set by the first flying route setting unit 142 or by the second flying route setting unit 148. The flying route 8 is set using the relative coordinates with reference to the position of the first base station 10A.

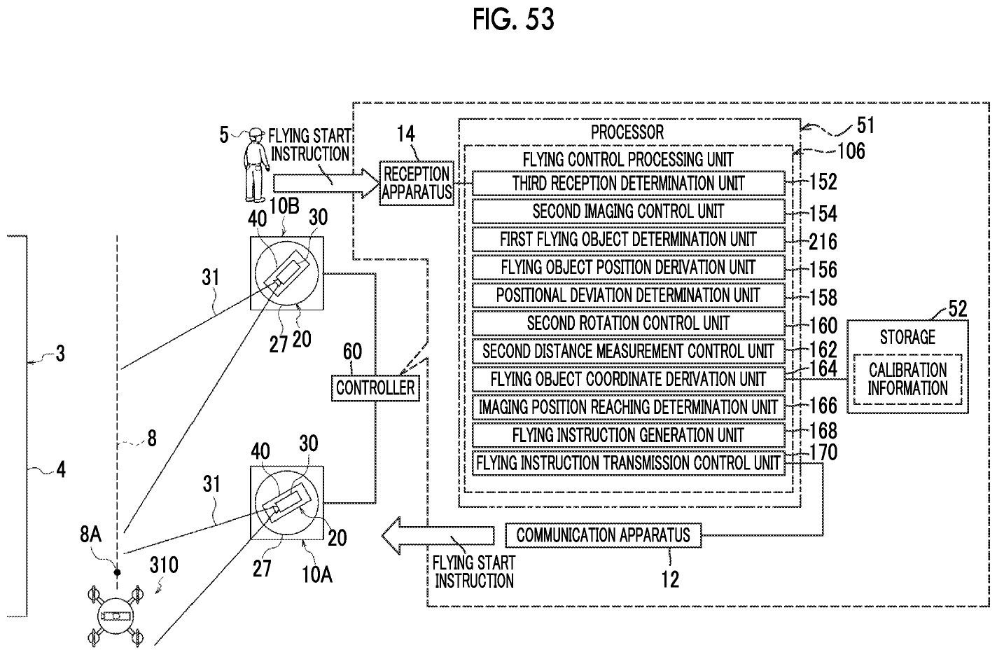

As illustrated in FIG. 53 as an example, the flying object 310 is disposed within the imaging range 31 of the imaging apparatus 30 of the first base station 10A. The worker 5 provides the flying start instruction to the reception apparatus 14 in a stage where the flying object 310 is in a state of being able to start flying. The third reception determination unit 152 determines whether or not the flying start instruction is received by the reception apparatus 14.

In a case where the third reception determination unit 152 determines that the flying start instruction is received by the reception apparatus 14, the second imaging control unit 154 performs the control of capturing the imaging scene via the imaging apparatus 30 of each base station 10.

The first flying object determination unit 216 determines which base station 10 of the first base station 10A and the second base station 10B has obtained the image in which the flying object 310 is captured as an image by executing the object recognition processing with respect to the image obtained by capturing via the imaging apparatus 30 of each base station 10. As will be described later, the distance measurement device 40 to measure the position of the flying object 310 is selected from the distance measurement device 40 of the first base station 10A and the distance measurement device 40 of the second base station 10B in accordance with a determination result of the first flying object determination unit 216.

The flying object position derivation unit 156 derives the position, within the image, of the flying object 310 included as an image in the image by executing the object recognition processing with respect to the image in which the flying object 310 is captured as an image out of the image obtained by the first base station 10A and the image obtained by the second base station 10B.

The positional deviation determination unit 158 determines whether or not the position of the flying object 310 deviates from the center portion of the angle of view of the imaging apparatus 30 of the first base station 10A or the second base station 10B based on the position of the flying object 310 within the image derived by the flying object position derivation unit 156.

In a case where it is determined that the position of the flying object 310 deviates from the center portion of the angle of view of the imaging apparatus 30, the second rotation control unit 160 performs the control of adjusting the rotational angle in the horizontal direction and/or the rotational angle in the vertical direction of the rotational drive apparatus 20 to the angle at which the flying object 310 is positioned in the center portion of the angle of view of the imaging apparatus 30.

The second distance measurement control unit 162 selects the distance measurement device 40 to measure the position of the flying object 310 from the distance measurement device 40 of the first base station 10A and the distance measurement device 40 of the second base station 10B based on the determination result of the first flying object determination unit 216. That is, the second distance measurement control unit 162 selects the distance measurement device 40 of the base station 10 determined by the first flying object determination unit 216 as obtaining the image in which the flying object 310 is captured as an image out of the first base station 10A and the second base station 10B, as the distance measurement device 40 to measure the position of the flying object 310.

The second distance measurement control unit 162 performs the control of scanning the distance measurement range 41 with the laser light via the distance measurement device 40 selected from the distance measurement device 40 of the first base station 10A and the distance measurement device 40 of the second base station 10B. In this case, since the flying object 310 is positioned within the distance measurement range 41 of the selected distance measurement device 40, the distance between the flying object 310 and the distance measurement device 40 is obtained.

For the base station 10 determined by the first flying object determination unit 216 as obtaining the image in which the flying object 310 is captured as an image out of the first base station 10A and the second base station 10B, the flying object coordinate derivation unit 164 derives relative coordinates of the flying object 310 with reference to the position of each base station 10 based on the rotational angle of the rotational drive apparatus 20, the angle of the laser light emitted from the distance measurement device 40 toward the flying object 310, and the distance between the flying object 310 and the distance measurement device 40.

In a case where the flying object 310 is positioned within the imaging range 31 of the imaging apparatus 30 of the second base station 10B, the flying object coordinate derivation unit 164 converts the relative coordinates of the flying object 310 with reference to the position of the second base station 10B into relative coordinates with reference to the position of the first base station 10A based on the calibration information stored in the storage 52. That is, the position of the flying object 310 measured by the distance measurement device 40 of the second base station 10B is converted into a position with reference to the position of the first base station 10A.

Based on the coordinates of the flying object 310 derived by the flying object coordinate derivation unit 164 and on the coordinates of the imaging position 8A (hereinafter, referred to as the target imaging position 8A) closest to the flying object 310 among the plurality of imaging positions 8A, the imaging position reaching determination unit 166 determines whether or not the flying object 310 has reached the target imaging position 8A. Both of the coordinates of the flying object 310 and the coordinates of the target imaging position 8A are relative coordinates with reference to the position of the first base station 10A.

In a case where the imaging position reaching determination unit 166 determines that the flying object 310 has not reached the target imaging position 8A, the flying instruction generation unit 168 generates the flying instruction with respect to the flying object 310 based on the difference between the coordinates of the flying object 310 derived by the flying object coordinate derivation unit 164 and the coordinates of the target imaging position 8A.

The flying instruction transmission control unit 170 performs the control of transmitting the flying instruction to the flying object 310 through the communication apparatus 12. Accordingly, the flying object 310 flies toward the target imaging position 8A in accordance with the flying instruction.

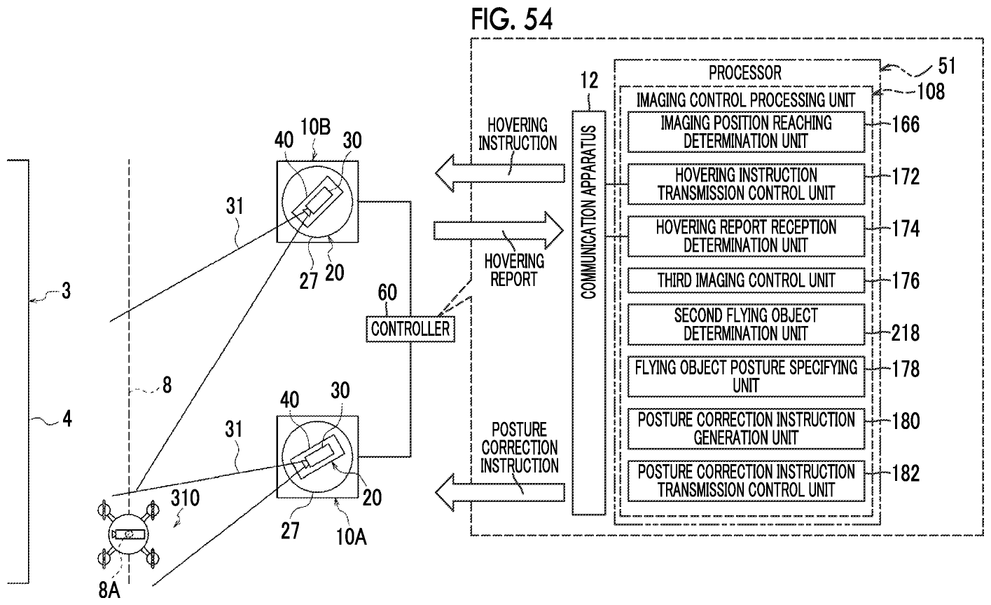

As illustrated in FIG. 54 as an example, in the controller 60, in a case where the imaging position reaching determination unit 166 determines that the flying object 310 has reached the target imaging position 8A, the hovering instruction transmission control unit 172 performs the control of transmitting the hovering instruction to the flying object 310 through the communication apparatus 12.

The hovering report reception determination unit 174 determines whether or not the communication apparatus 12 has received the hovering report transmitted from the flying object 310 in accordance with hovering of the flying object 310.

In a case where the hovering report reception determination unit 174 determines that the communication apparatus 12 has received the hovering report, the third imaging control unit 176 performs the control of causing the imaging apparatus 30 of each base station 10 to capture the imaging scene.

The second flying object determination unit 218 determines which base station 10 of the first base station 10A and the second base station 10B has obtained the image in which the flying object 310 is captured as an image by executing the object recognition processing with respect to the image obtained by capturing via the imaging apparatus 30 of each base station 10.

The flying object posture specifying unit 178 specifies the posture of the flying object 310 based on the positions of the plurality of propellers 341 captured in the image by executing the object recognition processing with respect to the image in which the flying object 310 is captured as an image out of the image obtained by the first base station 10A and the image obtained by the second base station 10B.

The posture correction instruction generation unit 180 generates the posture correction instruction for the flying object 310 based on the posture of the flying object 310 specified by the flying object posture specifying unit 178. The posture correction instruction transmission control unit 182 performs the control of transmitting the posture correction instruction to the flying object 310 through the communication apparatus 12. Accordingly, the posture of the flying object 310 is corrected.

Functions of the posture correction report reception determination unit 184, the zoom magnification determination unit 186, the first angle-of-view setting instruction transmission control unit 188, the distance derivation unit 190, the second angle-of-view setting instruction generation unit 192, the second angle-of-view setting instruction transmission control unit 194, the angle-of-view setting report reception determination unit 196, the imaging instruction transmission control unit 198, the imaging report reception determination unit 200, the finish determination unit 202, and the finish instruction transmission control unit 204 illustrated in FIG. 47 are the same as those in the first embodiment.

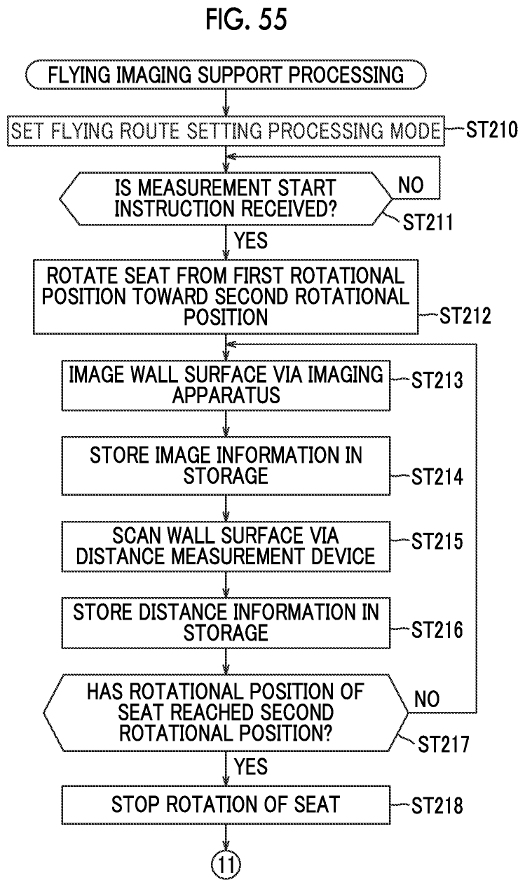

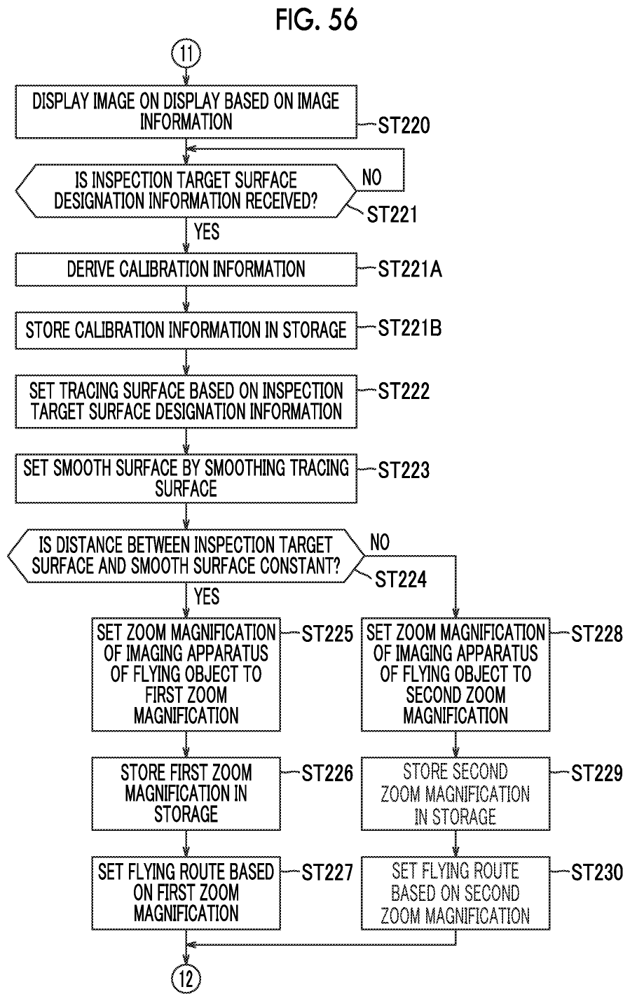

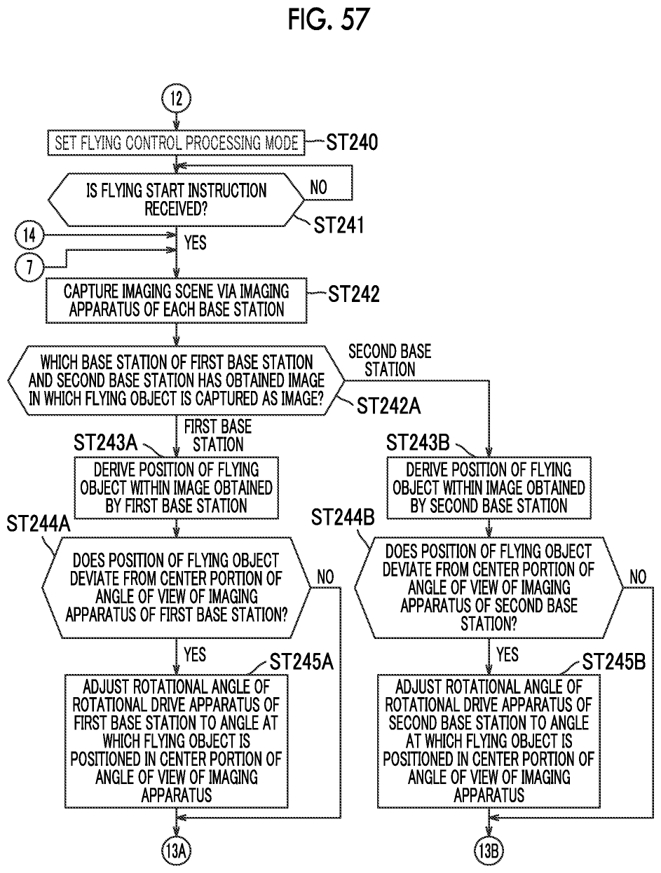

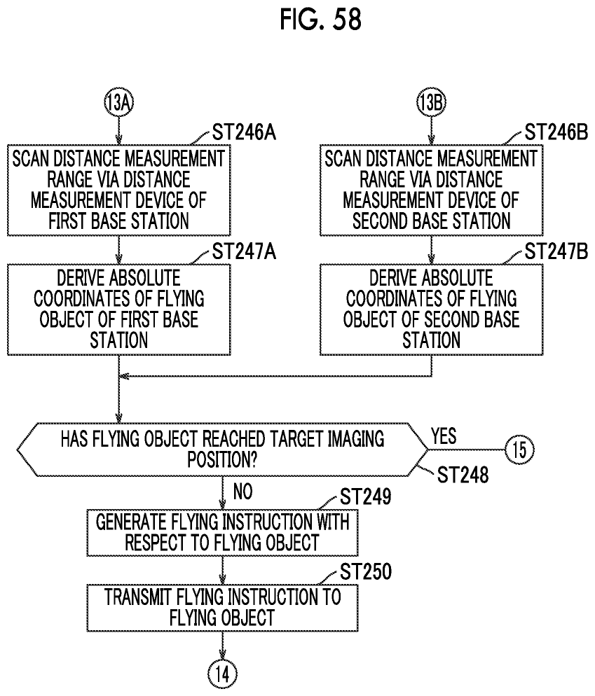

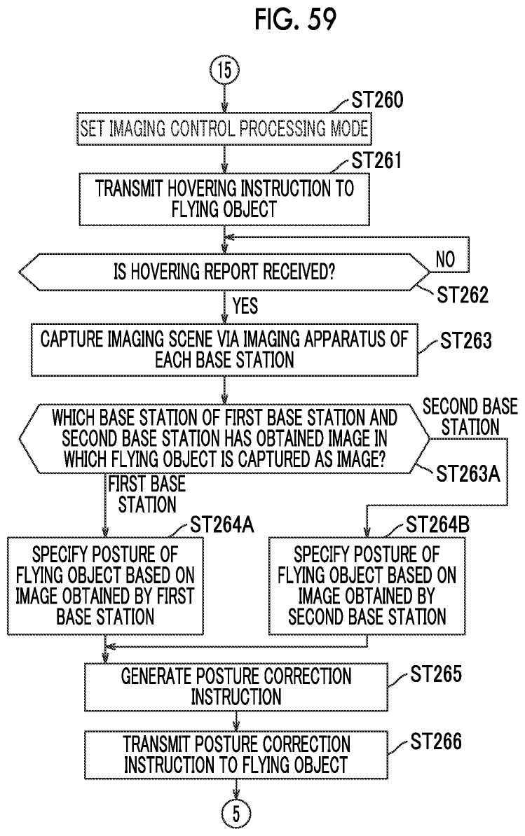

Next, an example of a flow of the flying imaging support processing performed by the processor 51 of the controller 60 in the imaging system S according to the second embodiment will be described with reference to FIG. 55 to FIG. 59.

In the flying imaging support processing illustrated in FIG. 55, first, in step ST210, the operation mode setting unit 102 sets the operation mode of the base station 10 to the flying route setting processing mode. After the processing of step ST210 is executed, the flying imaging support processing transitions to step ST211.

In step ST211, the first reception determination unit 112 determines whether or not the measurement start instruction is received by the reception apparatus 14. In step ST211, in a case where the measurement start instruction is not received by the reception apparatus 14, a negative determination is made, and the determination of step ST211 is performed again. In step ST211, in a case where the measurement start instruction is received by the reception apparatus 14, a positive determination is made, and the flying imaging support processing transitions to step ST212.

In step ST212, the first rotation control unit 114 rotates the seat 27 from the first rotational position toward the second rotational position by controlling the rotational drive apparatus 20 of each base station 10 based on the measurement start instruction. After the processing of step ST212 is executed, the flying imaging support processing transitions to step ST213.

In step ST213, the first imaging control unit 116 causes the imaging apparatus 30 of each base station 10 to image the wall surface 4. After the processing of step ST213 is executed, the flying imaging support processing transitions to step ST214.

In step ST214, the image information storage control unit 118 stores the image information, which is generated by associating the image obtained by each base station 10 in step ST213 with the rotational position detected by the rotation detector, in the storage 52. After the processing of step ST214 is executed, the flying imaging support processing transitions to step ST215.

In step ST215, the first distance measurement control unit 120 causes the distance measurement device 40 of each base station 10 to scan the wall surface 4. After the processing of step ST215 is executed, the flying imaging support processing transitions to step ST216.

In step ST216, the distance information storage control unit 122 stores the distance information, which is generated by associating the distance measured by each base station 10 in step ST215 with the rotational position detected by the rotation detector and with the rotational angle detected by the angle detector, in the storage 52. After the processing of step ST216 is executed, the flying imaging support processing transitions to step ST217.

In step ST217, the rotational position determination unit 124 determines whether or not the rotational position of the seat 27 of each base station 10 has reached the second rotational position. In step ST217, in a case where the rotational position of the seat 27 of each base station 10 has not reached the second rotational position, a negative determination is made, and the flying imaging support processing transitions to step ST213.

By repeatedly executing step ST213 and step ST214 while the rotational position of the seat 27 of each base station 10 reaches the second rotational position, the plurality of imaged regions of the wall surface 4 are continuously imaged. The image information corresponding to each imaged region is stored in the storage 52. In addition, by repeatedly executing step ST215 and step ST216 while the rotational position of the seat 27 of each base station 10 reaches the second rotational position, each of the plurality of distance measurement regions of the wall surface 4 is continuously scanned with the laser light. The distance information corresponding to each distance measurement region is stored in the storage 52. In step ST217, in a case where the rotational position of the seat 27 of each base station 10 has reached the second rotational position, a positive determination is made, and the flying imaging support processing transitions to step ST218.

In step ST218, the rotation stop control unit 126 stops rotation of the seat 27 by stopping rotation of the rotational drive apparatus 20 of each base station 10. After the processing of step ST218 is executed, the flying imaging support processing transitions to step ST220.

In step ST220, the image display control unit 128 displays the image on the display 16 based on the image information stored in the storage 52. In the image, the wall surface 4 is represented as an image. After the processing of step ST220 is executed, the flying imaging support processing transitions to step ST221.

In step ST221, the second reception determination unit 130 determines whether or not the inspection target surface designation information and the position designation information provided from the worker 5 are received by the reception apparatus 14. In step ST221, in a case where the inspection target surface designation information and the position designation information are not received by the reception apparatus 14, a negative determination is made, and the determination of step ST221 is performed again. In step ST221, in a case where the inspection target surface designation information and the position designation information are received by the reception apparatus 14, a positive determination is made, and the flying imaging support processing transitions to step ST221A.

In step ST221A, the calibration information derivation unit 212 derives the calibration information based on the position designation information and on the distance information. After the processing of step ST221A is executed, the flying imaging support processing transitions to step ST221B.

In step ST221B, the calibration information storage control unit 214 stores the calibration information in the storage 52. After the processing of step ST221B is executed, the flying imaging support processing transitions to step ST222.

In step ST222, the tracing surface setting unit 132 sets the tracing surface 6, which traces the inspection target surface 4G, based on the inspection target surface designation information and on the calibration information. After the processing of step ST222 is executed, the flying imaging support processing transitions to step ST223.

In step ST223, the smooth surface setting unit 134 sets the smooth surface 7 by smoothing the tracing surface 6. After the processing of step ST223 is executed, the flying imaging support processing transitions to step ST224.

In step ST224, the distance determination unit 136 determines whether or not the distance between the inspection target surface 4G and the smooth surface 7 is constant based on the distance information stored in the storage 52. In step ST224, in a case where the distance between the inspection target surface 4G and the smooth surface 7 is constant, a positive determination is made, and the flying imaging support processing transitions to step ST225. In step ST224, in a case where the distance between the inspection target surface 4G and the smooth surface 7 is not constant, a negative determination is made, and the flying imaging support processing transitions to step ST228.

In step ST225, the first zoom magnification determination unit 138 determines the zoom magnification of the imaging apparatus 330 of the flying object 310 as the first zoom magnification. The first zoom magnification is the zoom magnification at which the pixel resolution of the imaging apparatus 330 has the predetermined value. After the processing of step ST225 is executed, the flying imaging support processing transitions to step ST226.

In step ST226, the first zoom magnification storage control unit 140 stores the first zoom magnification determined by the first zoom magnification determination unit 138 in the storage 52. After the processing of step ST226 is executed, the flying imaging support processing transitions to step ST227.

In step ST227, the first flying route setting unit 142 sets the flying route 8 passing through the plurality of imaging positions 8A by setting the plurality of imaging positions 8A on the smooth surface 7 based on the first zoom magnification determined by the first zoom magnification determination unit 138. As an example, in the case of imaging the inspection target surface 4G at the first zoom magnification determined by the first zoom magnification determination unit 138, the first flying route setting unit 142 sets the flying route 8 passing through the plurality of imaging positions 8A by setting the plurality of imaging positions 8A at the positions where the imaging ranges 331 of the imaging apparatus 330 partially overlap with each other at the adjacent imaging positions 8A among the plurality of imaging positions 8A. After the processing of step ST227 is executed, the flying imaging support processing transitions to step ST240.

In step ST228, the second zoom magnification determination unit 144 determines the zoom magnification of the imaging apparatus 330 of the flying object 310 as the second zoom magnification. After the processing of step ST228 is executed, the flying imaging support processing transitions to step ST229.

In step ST229, the second zoom magnification storage control unit 146 stores the second zoom magnification determined by the second zoom magnification determination unit 144 in the storage 52. After the processing of step ST229 is executed, the flying imaging support processing transitions to step ST230.

In step ST230, the second flying route setting unit 148 sets the flying route 8 passing through the plurality of imaging positions 8A by setting the plurality of imaging positions 8A on the smooth surface 7 based on the second zoom magnification determined by the second zoom magnification determination unit 144. Even in the case of adjusting the second zoom magnification in accordance with the distance between the inspection target surface 4G and the imaging position 8A in step ST273 and step ST274 described later, the second flying route setting unit 148 sets the flying route 8 passing through the plurality of imaging positions 8A by setting the plurality of imaging positions 8A at the positions where the imaging ranges 331 of the imaging apparatus 330 partially overlap with each other at the adjacent imaging positions 8A among the plurality of imaging positions 8A. After the processing of step ST230 is executed, the flying imaging support processing transitions to step ST240.

In step ST240, the operation mode setting unit 102 sets the operation mode of the base station 10 to the flying control processing mode. After the processing of step ST240 is executed, the flying imaging support processing transitions to step ST241.

In step ST241, the third reception determination unit 152 determines whether or not the flying start instruction is received by the reception apparatus 14. In step ST241, in a case where the flying start instruction is not received by the reception apparatus 14, a negative determination is made, and the determination of step ST241 is performed again. In step ST241, in a case where the flying start instruction is received by the reception apparatus 14, a positive determination is made, and the flying imaging support processing transitions to step ST242.

In step ST242, the second imaging control unit 154 causes the imaging apparatus 30 of each base station 10 to capture the imaging scene. After the processing of step ST242 is executed, the flying imaging support processing transitions to step ST242A.

In step ST242A, the first flying object determination unit 216 determines which base station 10 of the first base station 10A and the second base station 10B has obtained the image in which the flying object 310 is captured as an image by executing the object recognition processing with respect to the image obtained by capturing via the imaging apparatus 30 of each base station 10. In step ST242A, in a case where the first flying object determination unit 216 determines that the flying object 310 is captured as an image in the image obtained by the first base station 10A, the flying imaging support processing transitions to step ST243A. In step ST242A, in a case where the first flying object determination unit 216 determines that the flying object 310 is captured as an image in the image obtained by the second base station 10B, the flying imaging support processing transitions to step ST243B.

In step ST243A, the flying object position derivation unit 156 derives the position of the flying object 310 within the image obtained by capturing via the imaging apparatus 30 of the first base station 10A. After the processing of step ST243A is executed, the flying imaging support processing transitions to step ST244A.

In step ST244A, the positional deviation determination unit 158 determines whether or not the position of the flying object 310 deviates from the center portion of the angle of view of the imaging apparatus 30 of the first base station 10A based on the position of the flying object 310 within the image derived in step ST243A. In step ST244A, in a case where the position of the flying object 310 deviates from the center portion of the angle of view of the first base station 10A, a positive determination is made, and the flying imaging support processing transitions to step ST245A. In step ST244A, in a case where the position of the flying object 310 does not deviate from the center portion of the angle of view, a negative determination is made, and the flying imaging support processing transitions to step ST246A.

In step ST245A, the second rotation control unit 160 adjusts the rotational angle of the rotational drive apparatus 20 of the first base station 10A to the angle at which the flying object 310 is positioned in the center portion of the angle of view of the imaging apparatus 30. After the processing of step ST245A is executed, the flying imaging support processing transitions to step ST246A.

In step ST243B, the flying object position derivation unit 156 derives the position of the flying object 310 within the image obtained by capturing via the imaging apparatus 30 of the second base station 10B. After the processing of step ST243B is executed, the flying imaging support processing transitions to step ST244B.

In step ST244B, the positional deviation determination unit 158 determines whether or not the position of the flying object 310 deviates from the center portion of the angle of view of the imaging apparatus 30 of the second base station 10B based on the position of the flying object 310 within the image derived in step ST243B. In step ST244B, in a case where the position of the flying object 310 deviates from the center portion of the angle of view of the second base station 10B, a positive determination is made, and the flying imaging support processing transitions to step ST245B. In step ST244B, in a case where the position of the flying object 310 does not deviate from the center portion of the angle of view, a negative determination is made, and the flying imaging support processing transitions to step ST246B.

In step ST245B, the second rotation control unit 160 adjusts the rotational angle of the rotational drive apparatus 20 of the second base station 10B to the angle at which the flying object 310 is positioned in the center portion of the angle of view of the imaging apparatus 30. After the processing of step ST245B is executed, the flying imaging support processing transitions to step ST246B.

In step ST246A, the second distance measurement control unit 162 causes the distance measurement device 40 of the first base station 10A to scan the distance measurement range 41 with the laser light. In this case, since the flying object 310 is positioned within the distance measurement range 41 of the distance measurement device 40, the distance between the flying object 310 and the distance measurement device 40 is obtained. After the processing of step ST246A is executed, the flying imaging support processing transitions to step ST247A.

In step ST247A, the flying object coordinate derivation unit 164 derives the relative coordinates of the flying object 310 with reference to the position of the first base station 10A based on the rotational angle of the rotational drive apparatus 20, the angle of the laser light emitted from the distance measurement device 40 toward the flying object 310, and the distance between the flying object 310 and the distance measurement device 40 with respect to the first base station 10A. After the processing of step ST247A is executed, the flying imaging support processing transitions to step ST248.

In step ST246B, the second distance measurement control unit 162 causes the distance measurement device 40 of the second base station 10B to scan the distance measurement range 41 with the laser light. In this case, since the flying object 310 is positioned within the distance measurement range 41 of the distance measurement device 40, the distance between the flying object 310 and the distance measurement device 40 is obtained. After the processing of step ST246B is executed, the flying imaging support processing transitions to step ST247B.

In step ST247B, the flying object coordinate derivation unit 164 derives the relative coordinates of the flying object 310 with reference to the position of the first base station 10A based on the rotational angle of the rotational drive apparatus 20, the angle of the laser light emitted from the distance measurement device 40 toward the flying object 310, the distance between the flying object 310 and the distance measurement device 40, and the calibration information with respect to the second base station 10B. After the processing of step ST247B is executed, the flying imaging support processing transitions to step ST248.

In step ST248, the imaging position reaching determination unit 166 determines whether or not the flying object 310 has reached the target imaging position 8A based on the coordinates of the flying object 310 derived in step ST247A or step ST247B and on the coordinates of the target imaging position 8A. In step ST248, in a case where the flying object 310 has reached the target imaging position 8A, a positive determination is made, and the flying imaging support processing transitions to step ST260. In step ST248, in a case where the flying object 310 has not reached the target imaging position 8A, a negative determination is made, and the flying imaging support processing transitions to step ST249.

In step ST249, the flying instruction generation unit 168 generates the flying instruction with respect to the flying object 310 based on the difference between the absolute coordinates of the flying object 310 derived in step ST247A or step ST247B and the absolute coordinates of the target imaging position 8A. After the processing of step ST249 is executed, the flying imaging support processing transitions to step ST250.

In step ST250, the flying instruction transmission control unit 170 transmits the flying instruction to the flying object 310 through the communication apparatus 12. After the processing of step ST250 is executed, the flying imaging support processing transitions to step ST242. By repeatedly executing step ST242 to step ST244B and step ST246A to step ST250, a positive determination is made in step ST248 in a case where the flying object 310 reaches the target imaging position 8A, and the flying imaging support processing transitions to step ST260.

In step ST260, the operation mode setting unit 102 sets the operation mode of the base station 10 to the imaging control processing mode. After the processing of step ST260 is executed, the flying imaging support processing transitions to step ST261.

In step ST261, the hovering instruction transmission control unit 172 transmits the hovering instruction to the flying object 310 through the communication apparatus 12. After the processing of step ST261 is executed, the flying imaging support processing transitions to step ST262.

In step ST262, the hovering report reception determination unit 174 determines whether or not the hovering report is received by the communication apparatus 12. In step ST262, in a case where the hovering report is not received by the communication apparatus 12, a negative determination is made, and the determination of step ST262 is performed again. In step ST262, in a case where the hovering report is received by the communication apparatus 12, a positive determination is made, and the flying imaging support processing transitions to step ST263.

In step ST263, the third imaging control unit 176 causes the imaging apparatus 30 of each base station 10 to capture the imaging scene. After the processing of step ST263 is executed, the flying imaging support processing transitions to step ST263A.

In step ST263A, the second flying object determination unit 218 determines which base station 10 of the first base station 10A and the second base station 10B has obtained the image in which the flying object 310 is captured as an image by executing the object recognition processing with respect to the image obtained by capturing via the imaging apparatus 30 of each base station 10. In step ST263A, in a case where the second flying object determination unit 218 determines that the flying object 310 is captured as an image in the image obtained by the first base station 10A, the flying imaging support processing transitions to step ST264A. In step ST263A, in a case where the first flying object determination unit 216 determines that the flying object 310 is captured as an image in the image obtained by the second base station 10B, the flying imaging support processing transitions to step ST264B.

In step ST264A, the flying object posture specifying unit 178 specifies the posture of the flying object 310 based on the positions of the plurality of propellers 341 captured in the image by executing the object recognition processing with respect to the image obtained by the first base station 10A. After the processing of step ST264A is executed, the flying imaging support processing transitions to step ST265.

In step ST264B, the flying object posture specifying unit 178 specifies the posture of the flying object 310 based on the positions of the plurality of propellers 341 captured in the image by executing the object recognition processing with respect to the image obtained by the second base station 10B. After the processing of step ST264B is executed, the flying imaging support processing transitions to step ST265.

In step ST265, the posture correction instruction generation unit 180 generates the posture correction instruction for the flying object 310 based on the posture of the flying object 310 specified in step ST264A and step ST264B. After the processing of step ST265 is executed, the flying imaging support processing transitions to step ST266.

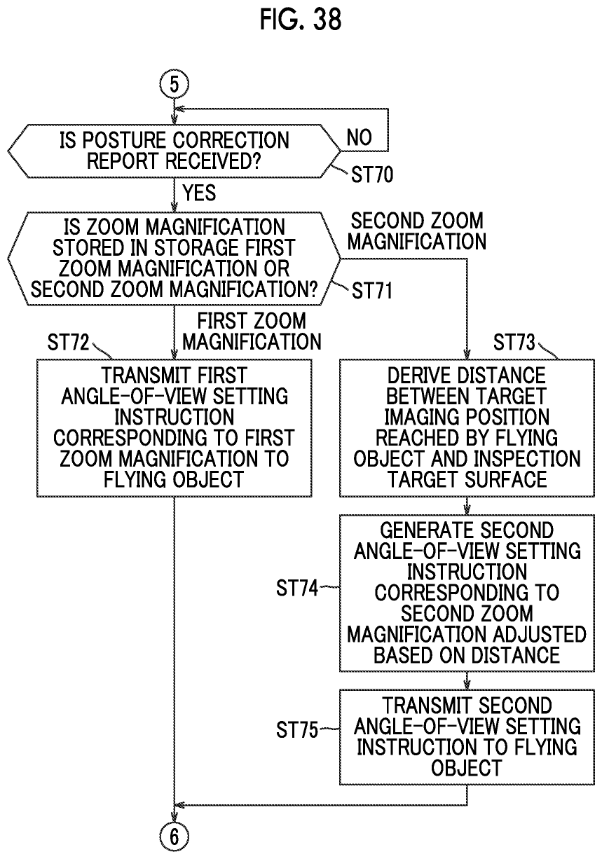

In step ST266, the posture correction instruction transmission control unit 182 transmits the posture correction instruction to the flying object 310 through the communication apparatus 12. After the processing of step ST266 is executed, the flying imaging support processing transitions to step ST70 (refer to FIG. 38).

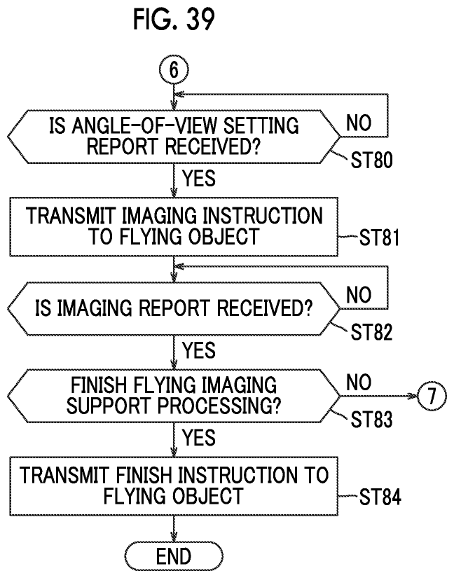

Step ST70 to step ST84 (refer to FIG. 38 and FIG. 39) are the same as those in the first embodiment. In the second embodiment, in a case where a negative determination is made in step ST83 (refer to FIG. 39), the flying imaging support processing transitions to step ST242.

As described above, in the second embodiment, the processor 51 causes the rotational drive apparatus 20 of the first base station 10A to rotate the distance measurement device 40 and causes the distance measurement device 40 of the first base station 10A to measure the distance at the plurality of first distance measurement locations of the wall surface 4. In addition, the processor 51 causes the rotational drive apparatus 20 of the second base station 10B rotate the distance measurement device 40 and causes the distance measurement device 40 of the second base station 10B to measure the distance at the plurality of second distance measurement locations of the wall surface 4. The processor 51 sets the flying route 8 based on the distance measured for each first distance measurement location and on the distance measured for each second distance measurement location. Accordingly, for example, a long flying route 8 can be set, compared to the case of setting the flying route 8 via one base station 10.

In addition, the processor 51 converts the distance measured by the distance measurement device 40 of the second base station 10B into a distance with reference to the position of the distance measurement device 40 of the first base station 10A based on the predetermined calibration information. Accordingly, for example, the flying route 8 can be set with reference to the position of the distance measurement device 40 of the first base station 10A with respect to the distance measurement region of the distance measurement device 40 of the second base station 10B.

In addition, the processor 51 converts the position of the flying object 310 measured by the distance measurement device 40 of the second base station 10B into a position with reference to the position of the distance measurement device 40 of the first base station 10A based on the predetermined calibration information. Accordingly, for example, in a case where the flying object 310 flies in the distance measurement region of the distance measurement device 40 of the second base station 10B, the flying object 310 can be controlled with reference to the position of the first base station 10A.

In addition, the processor 51 selects the distance measurement device 40 to measure the position of the flying object 310 from the distance measurement device 40 of the first base station 10A and the distance measurement device 40 of the second base station 10B in accordance with the position of the flying object 310. Accordingly, for example, the flying object 310 that flies along the flying route 8 set from the distance measurement region of the distance measurement device 40 of the first base station 10A to the distance measurement region of the distance measurement device 40 of the second base station 10B can be controlled.

While the imaging system S comprises the first base station 10A and the second base station 10B as an example of the plurality of base stations in the second embodiment, three or more base stations may be comprised.

### Third Embodiment

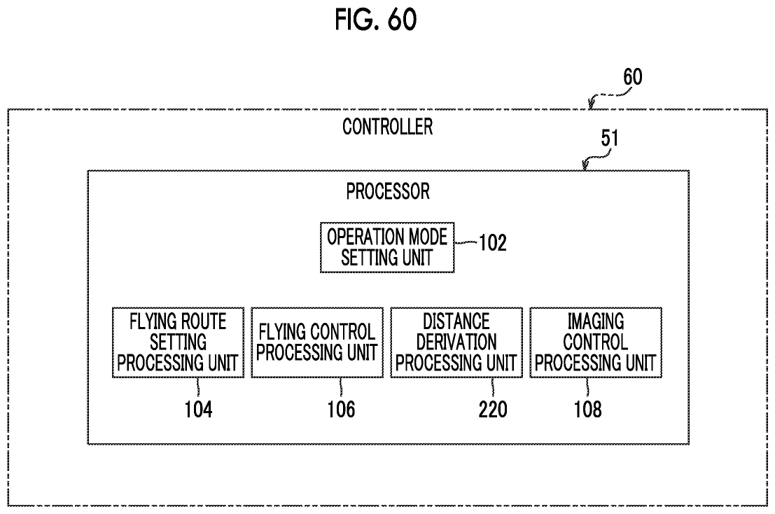

As illustrated in FIG. 60 as an example, a configuration of the controller 60 in a third embodiment is changed from that in the second embodiment as follows.

That is, the controller 60 has a distance derivation mode as an operation mode. In the case of deriving a distance between a point X positioned outside the distance measurement region of each distance measurement device 40 and each distance measurement device 40 in a state where the flying route setting processing is executed by the flying route setting processing unit 104, the operation mode setting unit 102 sets the distance derivation mode as the operation mode of the controller 60.

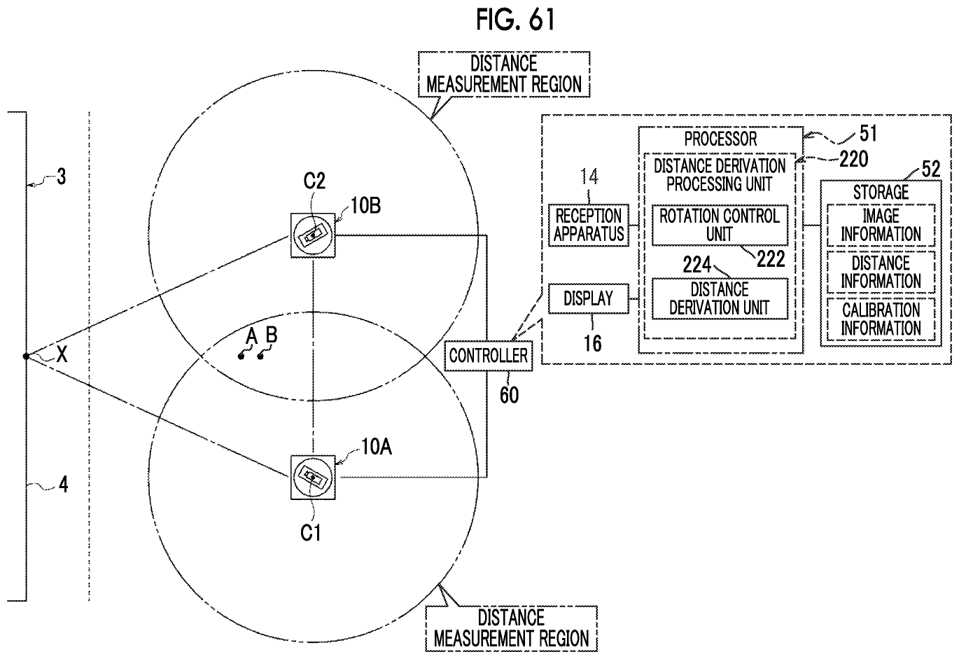

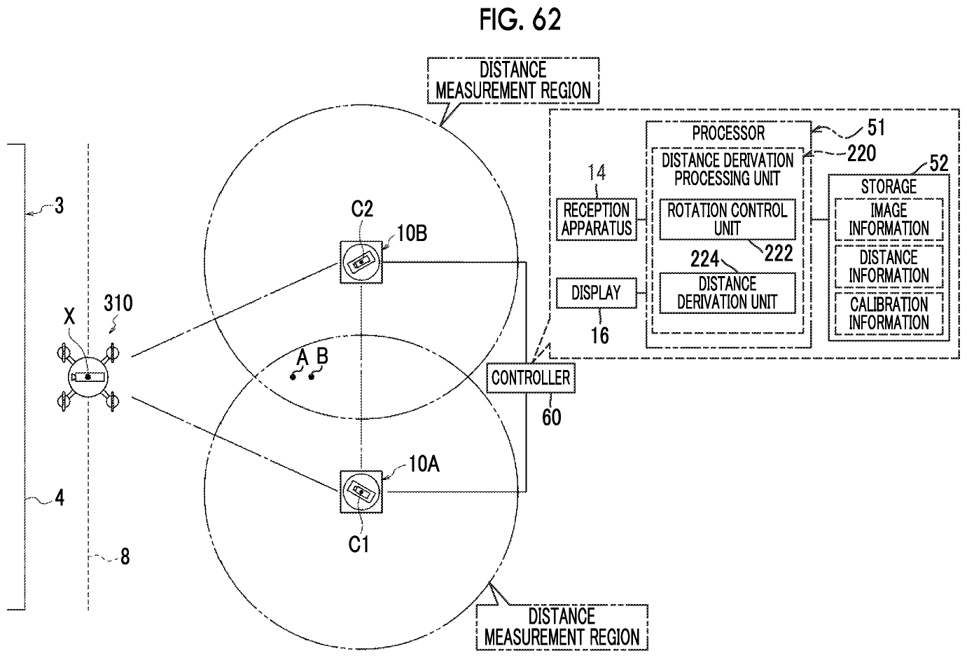

In addition, in the case of deriving the distance between the point X positioned outside the distance measurement region of each distance measurement device 40 and each distance measurement device 40 in a state where the flying control processing is executed by the flying control processing unit 106, the operation mode setting unit 102 sets the distance derivation mode as the operation mode of the base station 10. In a case where the operation mode of the controller 60 is set to the distance derivation mode by the operation mode setting unit 102, the processor 51 operates as a distance derivation processing unit 220. As illustrated in FIG. 61 and FIG. 62 as an example, the distance derivation processing unit 220 includes a rotation control unit 222 and a distance derivation unit 224.

As illustrated in FIG. 61 and FIG. 62 as an example, an example of deriving the distance between the point X positioned outside the distance measurement region of each distance measurement device 40 and each distance measurement device 40 with respect to the second embodiment will be described in the third embodiment. As an example, in FIG. 61, the point X is a position on the wall surface 4 of the inspection target object 3 and is a position as a reference in the case of setting the flying route 8. In addition, as an example, in FIG. 62, the point X is the position of the flying object 310 that flies along the flying route 8.

Hereinafter, in the case of distinguishing between the distance measurement region of the distance measurement device 40 of the first base station 10A and the distance measurement region of the distance measurement device 40 of the second base station 10B, the distance measurement region of the distance measurement device 40 of the first base station 10A will be referred to as a first distance measurement region, and the distance measurement region of the distance measurement device 40 of the second base station 10B will be referred to as a second distance measurement region. The first distance measurement region is an example of a “first distance measurement region” according to the embodiment of the disclosed technology, and the second distance measurement region is an example of a “second distance measurement region” according to the embodiment of the disclosed technology.

The rotation control unit 222 adjusts the rotational angle of each rotational drive apparatus 20 to an angle at which the point X is positioned in the center portion of the angle of view of each imaging apparatus 30 by controlling each rotational drive apparatus 20. For example, in a case where a position designation instruction for designating the point X on the wall surface 4 is provided by the worker 5, the rotation control unit 222 adjusts the rotational angle of each rotational drive apparatus 20 to the angle at which the point X on the wall surface 4 is positioned in the center portion of the angle of view of each imaging apparatus 30 by controlling each rotational drive apparatus 20 based on the position designation instruction.

In addition, for example, in a case where the flying object 310 is positioned in the center portion of the angle of view of the imaging apparatus 30 of the first base station 10A, the rotation control unit 222 adjusts the rotational angle of the rotational drive apparatus 20 of the second base station 10B to an angle at which the flying object 310 is positioned in the center portion of the angle of view of the imaging apparatus 30 of the second base station 10B by controlling the rotational drive apparatus 20 of the second base station 10B based on the rotational angle of the rotational drive apparatus 20 of the first base station 10A.

In addition, for example, in a case where the flying object 310 is positioned in the center portion of the angle of view of the imaging apparatus 30 of the second base station 10B, the rotation control unit 222 adjusts the rotational angle of the rotational drive apparatus 20 of the first base station 10A to an angle at which the flying object 310 is positioned in the center portion of the angle of view of the imaging apparatus 30 of the first base station 10A by controlling the rotational drive apparatus 20 of the first base station 10A based on the rotational angle of the rotational drive apparatus 20 of the second base station 10B.

By adjusting the rotational angle of the rotational drive apparatus 20 of the first base station 10A to the angle at which the flying object 310 is positioned in the center portion of the angle of view of the imaging apparatus 30 of the first base station 10A, the rotational angle of the rotational drive apparatus 20 of the first base station 10A is set to an angle of a direction in which the point X is positioned with respect to the distance measurement device 40 of the first base station 10A. Similarly, by adjusting the rotational angle of the rotational drive apparatus 20 of the second base station 10B to the angle at which the flying object 310 is positioned in the center portion of the angle of view of the imaging apparatus 30 of the second base station 10B, the rotational angle of the rotational drive apparatus 20 of the second base station 10B is set to an angle of a direction in which the point X is positioned with respect to the distance measurement device 40 of the second base station 10B.

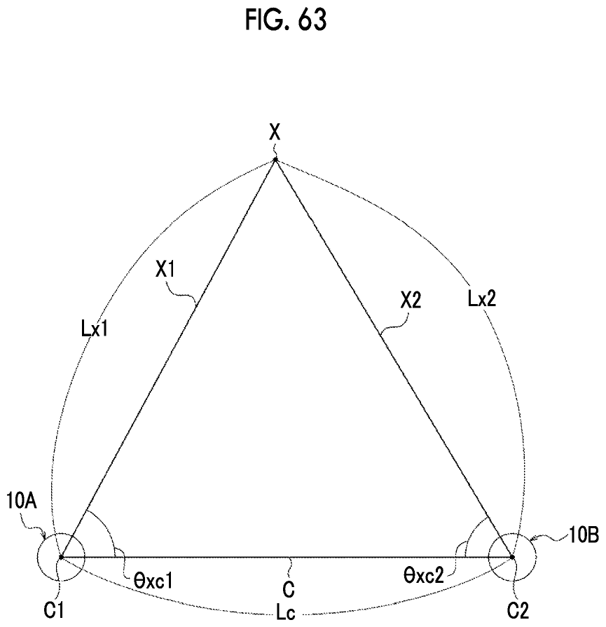

The distance derivation unit 224 derives the distance between each distance measurement device 40 and the point X based on the calibration information and on the rotational angle of each rotational drive apparatus 20. Hereinafter, a procedure of deriving the distance between each distance measurement device 40 and the point X will be described with reference to FIG. 63.

The distance derivation unit 224 derives an angle θxc1 of a side X1 with reference to the side C based on the calibration information and on the rotational angle of the rotational drive apparatus 20 of the first base station 10A. The side X1 is a side connecting the point X and the point C1 of the first base station 10A to each other. The position of the first base station 10A is synonymous with the position of the distance measurement device 40 of the first base station 10A.

In addition, the distance derivation unit 224 derives an angle θxc2 of a side X2 with reference to the side C based on the calibration information and on the rotational angle of the rotational drive apparatus 20 of the second base station 10B. The side X2 is a side connecting the point X and the point C2 of the second base station 10B to each other. The position of the second base station 10B is synonymous with the position of the distance measurement device 40 of the second base station 10B.

Next, the distance derivation unit 224 calculates a length Lx1 of the side X1 based on Expression (9) below.

Lₓ1=\sqrt{L_{c}²+Lₓ2²−2L_{c}Lₓ2 cos θ_{xc}2} (9)

Similarly, the distance derivation unit 224 calculates a length Lx2 of the side X2 based on Expression (10) below.

Lₓ2=\sqrt{L_{c}²+Lₓ1²−2L_{c}Lₓ1 cos θ_{xc}1} (10)

The distance between each distance measurement device 40 and the point X is derived using the above procedure.

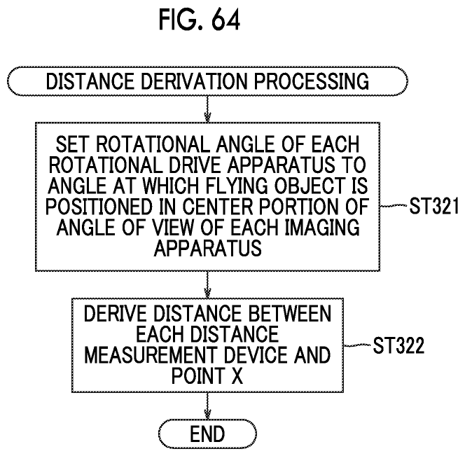

Next, an example of distance derivation processing executed by the distance derivation processing unit 220 according to the third embodiment will be described with reference to FIG. 64.

In the distance derivation processing illustrated in FIG. 64, first, in step ST321, the rotation control unit 222 adjusts the rotational angle of each rotational drive apparatus 20 to the angle at which the point X is positioned in the center portion of the angle of view of each imaging apparatus 30 by controlling each rotational drive apparatus 20.

In step ST322, the distance derivation unit 224 derives the distance between each distance measurement device 40 and the point X based on the calibration information and on the rotational angle of each rotational drive apparatus 20.

As described above, in the third embodiment, in the case of setting the flying route 8 with reference to the point X positioned outside the first distance measurement region of the distance measurement device 40 of the first base station 10A and outside the second distance measurement region of the distance measurement device 40 of the second base station 10B, the processor 51 derives the distance between the point X and the distance measurement device 40 of the first base station 10A based on the angle of the direction in which the point X is positioned with respect to the distance measurement device 40 of the first base station 10A and on a distance between the distance measurement device 40 of the first base station 10A and the distance measurement device 40 of the second base station 10B. Similarly, the processor 51 derives the distance between the point X and the distance measurement device 40 of the second base station 10B based on the angle of the direction in which the point X is positioned with respect to the distance measurement device 40 of the second base station 10B and on the distance between the distance measurement device 40 of the first base station 10A and the distance measurement device 40 of the second base station 10B. Accordingly, the flying route 8 can be set with reference to the point X positioned outside the first distance measurement region and outside the second distance measurement region.

In addition, in a case where the flying object 310 is positioned outside the first distance measurement region and outside the second distance measurement region, the processor 51 derives the distance between the flying object 310 and the distance measurement device 40 of the first base station 10A based on an angle of a direction in which the flying object 310 is positioned with respect to the distance measurement device 40 of the first base station 10A and on the distance between the distance measurement device 40 of the first base station 10A and the distance measurement device 40 of the second base station 10B. Similarly, the processor 51 derives the distance between the flying object 310 and the distance measurement device 40 of the second base station 10B based on an angle of a direction in which the flying object 310 is positioned with respect to the distance measurement device 40 of the second base station 10B and on the distance between the distance measurement device 40 of the first base station 10A and the distance measurement device 40 of the second base station 10B. Accordingly, the flying object 310 that flies along a flying route set outside the first distance measurement region and outside the second distance measurement region can be controlled.

### Fourth Embodiment

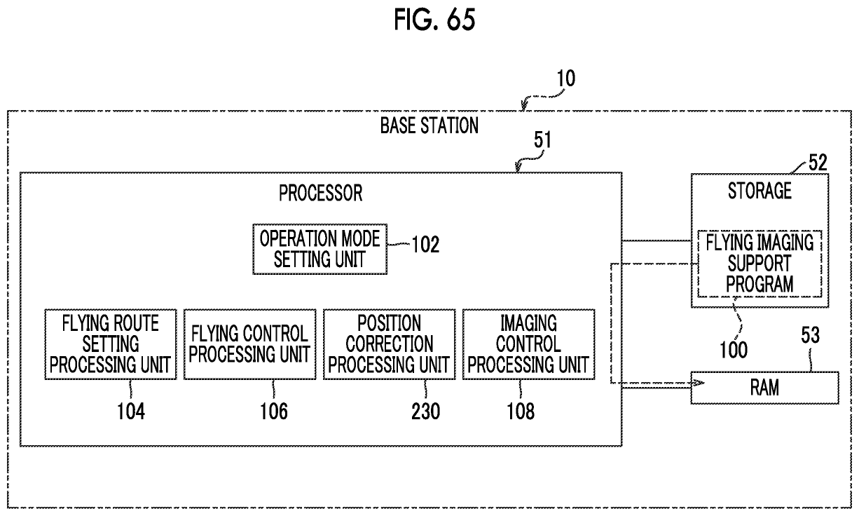

As illustrated in FIG. 65 as an example, a configuration of the base station 10 in a fourth embodiment is changed from that in the first embodiment as follows.

That is, by executing the flying imaging support program 100, the processor 51 operates as a position correction processing unit 230 in addition to the operation mode setting unit 102, the flying route setting processing unit 104, the flying control processing unit 106, and the imaging control processing unit 108.

The base station 10 has the flying route setting processing mode, the flying control processing mode, a position correction processing mode, and the imaging control processing mode as operation modes. The operation mode setting unit 102 sets the flying route setting processing mode, the flying control processing mode, the position correction processing mode, and the imaging control processing mode as the operation mode of the base station 10. In a case where the operation mode of the base station 10 is set to the position correction processing mode by the operation mode setting unit 102, the processor 51 operates as the position correction processing unit 230. While the operation mode setting unit 102 transitions from the flying control processing mode to the imaging control processing mode in the first embodiment, the operation mode setting unit 102 sets the position correction processing mode during the transition from the flying control processing mode to the imaging control processing mode in the fourth embodiment.

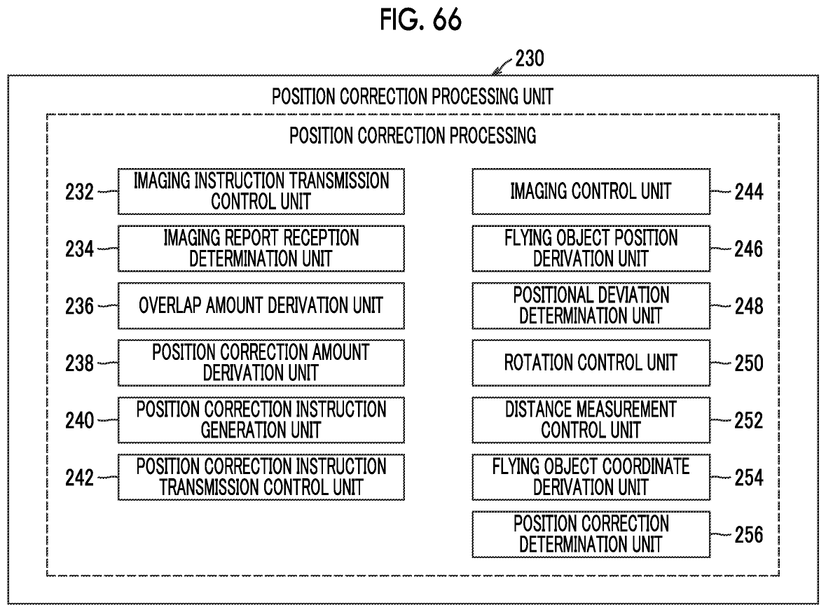

As illustrated in FIG. 66 as an example, the position correction processing unit 230 includes an imaging instruction transmission control unit 232, an imaging report reception determination unit 234, an overlap amount derivation unit 236, a position correction amount derivation unit 238, a position correction instruction generation unit 240, a position correction instruction transmission control unit 242, an imaging control unit 244, a flying object position derivation unit 246, a positional deviation determination unit 248, a rotation control unit 250, a distance measurement control unit 252, a flying object coordinate derivation unit 254, and a position correction determination unit 256.

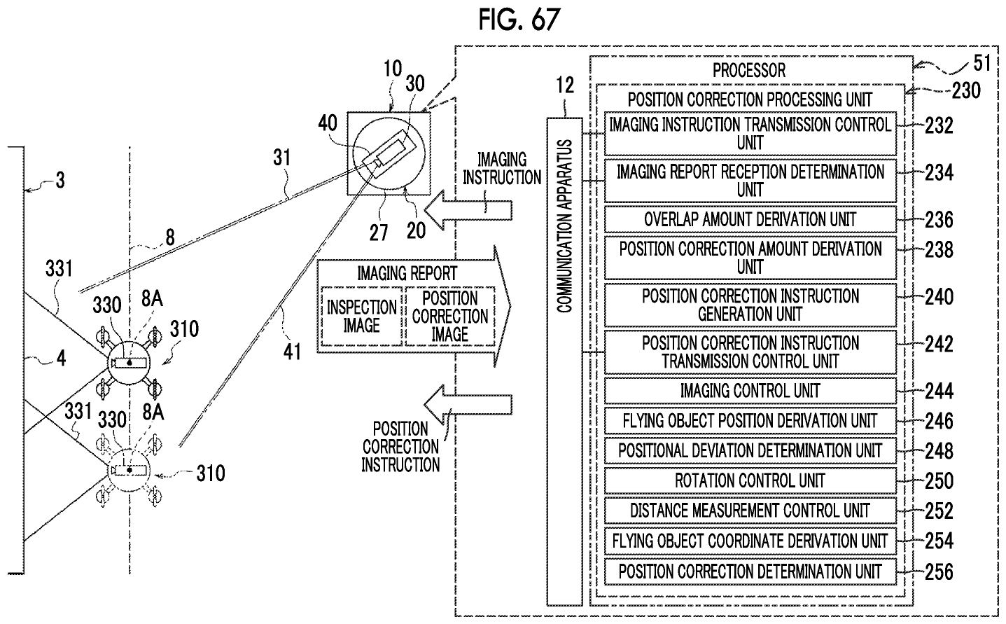

As illustrated in FIG. 67 as an example, in a case where the imaging position reaching determination unit 166 (refer to FIG. 21) determines that the flying object 310 has reached the target imaging position 8A, the imaging instruction transmission control unit 232 performs the control of transmitting the imaging instruction to the flying object 310 through the communication apparatus 12.

The imaging apparatus 330 of the flying object 310 images the wall surface 4 in accordance with the imaging instruction. Accordingly, a position correction image is obtained. After imaging the wall surface 4 via the imaging apparatus 330, the flying object 310 transmits the imaging report to the base station 10. The imaging report includes an inspection image acquired in the previous imaging control processing and the above position correction image. Hereinafter, the inspection image acquired in the previous imaging control processing will be referred to as the previous inspection image. In addition, hereinafter, the imaging position 8A reached by the flying object 310 in a case where the previous inspection image is acquired will be referred to as the previous imaging position 8A.

The previous inspection image is an image obtained by capturing via the imaging apparatus 330 based on the control of the imaging instruction transmission control unit 198 (refer to FIG. 30) of the imaging control processing unit 108 in the imaging control processing mode.

The imaging report reception determination unit 234 determines whether or not the communication apparatus 12 has received the imaging report. In a case where the imaging report reception determination unit 234 determines that the communication apparatus 12 has received the imaging report, the overlap amount derivation unit 236 derives an overlap amount between the previous inspection image and the position correction image.

The position correction amount derivation unit 238 derives a position correction amount for correcting the position of the flying object 310 with respect to the target imaging position 8A based on the overlap amount derived by the overlap amount derivation unit 236. In this case, the position correction amount derivation unit 238 derives the position correction amount corresponding to a difference between the overlap amount derived by the overlap amount derivation unit 236 and a predetermined overlap amount based on a distance between the wall surface 4 and the flying object 310. The predetermined overlap amount is an amount defining an overlap amount between adjacent inspection images and is set to an amount with which inspection images can be recognized as adjacent inspection images based on the overlap amount between the inspection images in the image analysis apparatus 2 (refer to FIG. 1).

The position correction instruction generation unit 240 generates a position correction instruction based on the position correction amount derived by the position correction amount derivation unit 238. The position correction instruction transmission control unit 242 performs a control of transmitting the position correction instruction to the flying object 310 through the communication apparatus 12. The flying object 310 receives the position correction instruction as the flying instruction (refer to FIG. 22). In a case where the position correction instruction as the flying instruction is received, the flying object 310 changes its position by flying in accordance with the position correction instruction.

The imaging control unit 244 performs the control of capturing the imaging scene including the flying object 310 via the imaging apparatus 30. The flying object position derivation unit 246 derives the position, within the image, of the flying object 310 included as an image in the image by executing the object recognition processing with respect to the image obtained by capturing the imaging scene including the flying object 310 via the imaging apparatus 30.

The positional deviation determination unit 248 determines whether or not the position of the flying object 310 deviates from the center portion of the angle of view of the imaging apparatus 30 based on the position of the flying object 310 within the image derived by the flying object position derivation unit 246.

In a case where it is determined that the position of the flying object 310 deviates from the center portion of the angle of view of the imaging apparatus 30, the rotation control unit 250 performs the control of adjusting the rotational angle in the horizontal direction and/or the rotational angle in the vertical direction of the rotational drive apparatus 20 to the angle at which the flying object 310 is positioned in the center portion of the angle of view of the imaging apparatus 30.

The distance measurement control unit 252 performs the control of scanning the distance measurement range 41 with the laser light via the distance measurement device 40. In this case, since the flying object 310 is positioned within the distance measurement range 41 of the distance measurement device 40, the distance between the flying object 310 and the distance measurement device 40 is obtained.

The flying object coordinate derivation unit 254 derives the absolute coordinates of the flying object 310 based on the absolute coordinates of the rotational drive apparatus 20, the rotational angle of the rotational drive apparatus 20, the angle of the laser light emitted from the distance measurement device 40 toward the flying object 310, and the distance between the flying object 310 and the distance measurement device 40.

The position correction determination unit 256 determines whether or not the position of the flying object 310 is corrected based on the absolute coordinates of the flying object 310 derived by the flying object coordinate derivation unit 254. In a case where the position correction determination unit 256 determines that the position of the flying object 310 is not corrected, the above processing of the imaging instruction transmission control unit 232, the imaging report reception determination unit 234, the overlap amount derivation unit 236, the position correction amount derivation unit 238, the position correction instruction generation unit 240, the position correction instruction transmission control unit 242, the imaging control unit 244, the flying object position derivation unit 246, the positional deviation determination unit 248, the rotation control unit 250, the distance measurement control unit 252, and the flying object coordinate derivation unit 254 is executed. Accordingly, a control of causing the flying object 310 to fly to a position at which the overlap amount between the previous inspection image and the current inspection image is the predetermined overlap amount is executed.

In the fourth embodiment, in a case where the position correction determination unit 256 determines that the position of the flying object 310 is corrected, the inspection image is acquired in the current imaging control processing by setting the imaging control processing mode as the operation mode of the base station 10, as in the first embodiment. Hereinafter, the inspection image acquired in the current imaging control processing will be referred to as the current inspection image. In addition, hereinafter, the imaging position 8A reached by the flying object 310 in a case where the current inspection image is acquired will be referred to as the current imaging position 8A.

The operation mode of the base station 10 is an example of an “operation mode” according to the embodiment of the disclosed technology.

The flying control processing mode is an example of a “first mode” according to the embodiment of the disclosed technology, and the position correction processing mode is an example of a “second mode” according to the embodiment of the disclosed technology. The imaging apparatus 330 of the flying object 310 is an example of a “third imaging apparatus” according to the embodiment of the disclosed technology. The position correction image is an example of a “third image” according to the embodiment of the disclosed technology. The previous inspection image is an example of a “fourth image” according to the embodiment of the disclosed technology. The current inspection image is an example of a “fifth image” according to the embodiment of the disclosed technology. The previous imaging position 8A is an example of a “second imaging position” according to the embodiment of the disclosed technology. The current imaging position 8A is an example of a “third imaging position” according to the embodiment of the disclosed technology.

The processing of the overlap amount derivation unit 236, that is, the processing of deriving the overlap amount between the previous inspection image and the position correction image, may be executed by the processor 351 of the flying object 310. The overlap amount derived by the processor 351 of the flying object 310 may be transmitted to the processor 51 of the base station 10.

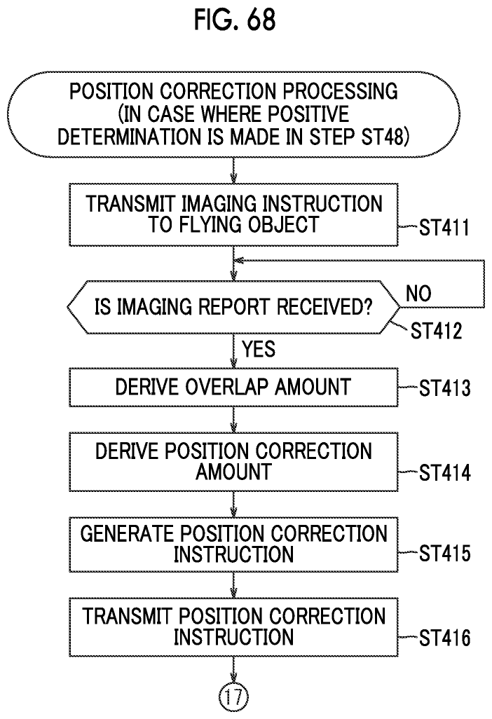

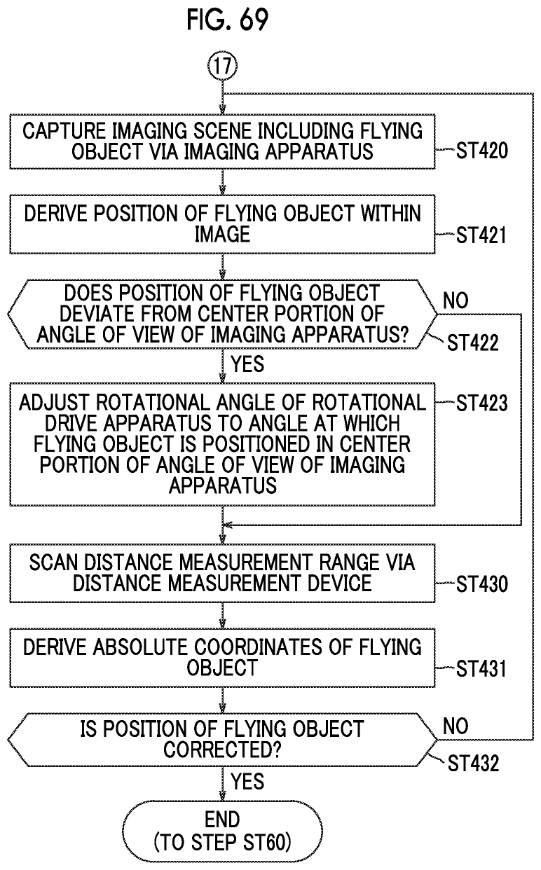

Next, an example of a flow of position correction processing executed by the position correction processing unit 230 according to the fourth embodiment will be described with reference to FIG. 68 and FIG. 69.

In the position correction processing illustrated in FIG. 68, first, in step ST411, the imaging instruction transmission control unit 232 transmits the imaging instruction to the flying object 310 through the communication apparatus 12. After the processing of step ST411 is executed, the position correction processing transitions to step ST412.

In step ST412, the imaging report reception determination unit 234 determines whether or not the communication apparatus 12 has received the imaging report. In step ST412, in a case where the communication apparatus 12 has not received the imaging report, a negative determination is made, and the determination of step ST412 is performed again. In step ST412, in a case where the communication apparatus 12 has received the imaging report, a positive determination is made, and the position correction processing transitions to step ST413.

In step ST413, the overlap amount derivation unit 236 derives the overlap amount between the previous inspection image and the position correction image. After the processing of step ST413 is executed, the position correction processing transitions to step ST414.

In step ST414, the position correction amount derivation unit 238 derives the position correction amount corresponding to the difference between the overlap amount derived by the overlap amount derivation unit 236 and the predetermined overlap amount based on the distance between the wall surface 4 and the flying object 310. After the processing of step ST414 is executed, the position correction processing transitions to step ST415.

In step ST415, the position correction instruction generation unit 240 generates the position correction instruction based on the position correction amount derived by the position correction amount derivation unit 238. After the processing of step ST415 is executed, the position correction processing transitions to step ST416.

In step ST416, the position correction instruction transmission control unit 242 transmits the position correction instruction to the flying object 310 through the communication apparatus 12. After the processing of step ST416 is executed, the position correction processing transitions to step ST420.

In step ST420, the imaging control unit 244 causes the imaging apparatus 30 to capture the imaging scene including the flying object 310. After the processing of step ST420 is executed, the position correction processing transitions to step ST421.

In step ST421, the flying object position derivation unit 246 derives the position of the flying object 310 within the image obtained by capturing via the imaging apparatus 30. After the processing of step ST421 is executed, the position correction processing transitions to step ST422.

In step ST422, the positional deviation determination unit 248 determines whether or not the position of the flying object 310 deviates from the center portion of the angle of view of the imaging apparatus 30 based on the position of the flying object 310 within the image derived in step ST421. In step ST422, in a case where the position of the flying object 310 deviates from the center portion of the angle of view, a positive determination is made, and the position correction processing transitions to step ST423. In step ST422, in a case where the position of the flying object 310 does not deviate from the center portion of the angle of view, a negative determination is made, and the position correction processing transitions to step ST430.

In step ST423, the rotation control unit 250 adjusts the rotational angle of the rotational drive apparatus 20 to the angle at which the flying object 310 is positioned in the center portion of the angle of view of the imaging apparatus 30. After the processing of step ST423 is executed, the position correction processing transitions to step ST430.

In step ST430, the distance measurement control unit 252 causes the distance measurement device 40 to scan the distance measurement range 41 with the laser light. In this case, since the flying object 310 is positioned within the distance measurement range 41 of the distance measurement device 40, the distance between the flying object 310 and the distance measurement device 40 is obtained. After the processing of step ST430 is executed, the position correction processing transitions to step ST431.

In step ST431, the flying object coordinate derivation unit 254 derives the absolute coordinates of the flying object 310 based on the absolute coordinates of the rotational drive apparatus 20, the rotational angle of the rotational drive apparatus 20, the angle of the laser light emitted from the distance measurement device 40 toward the flying object 310, and the distance between the flying object 310 and the distance measurement device 40. After the processing of step ST431 is executed, the position correction processing transitions to step ST432.

In step ST432, the position correction determination unit 256 determines whether or not the position of the flying object 310 is corrected based on the absolute coordinates of the flying object 310 derived in step ST431. In step ST432, in a case where the position of the flying object 310 is not corrected, a negative determination is made, and the position correction processing transitions to step ST420. In step ST432, in a case where the position of the flying object 310 is corrected, a positive determination is made, and the position correction processing is finished.

As described above, in the fourth embodiment, the processor 51 sets the flying control processing mode in which the flying object 310 flies based on the flying route 8 and the position correction processing mode in which the position of the flying object 310 is corrected based on the position correction image obtained by imaging the wall surface 4 via the imaging apparatus 330 in a case where the flying object 310 that has moved from the previous imaging position 8A has reached the current imaging position 8A, as the operation mode of the base station 10. In the case of acquiring the previous inspection image via the imaging apparatus 330 in accordance with reaching of the flying object 310 to the previous imaging position 8A and acquiring the current inspection image via the imaging apparatus 330 in accordance with reaching of the flying object 310 to the current imaging position 8A, the processor 51 corrects the position of the flying object 310 to the position at which the overlap amount between the previous inspection image and the current inspection image is the predetermined overlap amount based on the overlap amount between the previous inspection image and the position correction image in the position correction processing mode. Accordingly, as the position of the flying object 310 is corrected, accuracy of the overlap amount between the previous inspection image and the current inspection image can be improved, compared to the case of acquiring the current inspection image via the imaging apparatus 330 at a time point when, for example, the flying object 310 has reached the current imaging position 8A.

While the imaging system S is used for a purpose of inspection in the embodiments, the imaging system S, for example, may be used for purposes other than inspection, such as transport, imaging, measurement, crop spraying, maintenance, or security.

In addition, while an example of a form of executing the flying imaging support processing via the base station 10 has been illustratively described in the embodiments, the disclosed technology is not limited thereto. For example, the base station 10 and the flying object 310 may execute the flying imaging support processing in a distributed manner. In addition, for example, in a case where an external apparatus communicably connected to the base station 10 and/or the flying object 310 is set, the base station 10 and the external apparatus may execute the flying imaging support processing in a distributed manner, the base station 10, the flying object 310, and the external apparatus may execute the flying imaging support processing in a distributed manner, or the flying object 310 and the external apparatus may execute the flying imaging support processing in a distributed manner.

In addition, while an example of a form in which the flying imaging support program 100 is stored in the storage 52 of the base station 10 has been illustratively described in the embodiments, the disclosed technology is not limited thereto. For example, the flying imaging support program 100 may be stored in a portable storage medium such as an SSD or a USB memory. The storage medium is a non-transitory computer-readable storage medium (that is, a computer-readable storage medium). The flying imaging support program 100 stored in the storage medium is installed on the computer 50 of the base station 10. The processor 51 of the base station 10 executes the flying imaging support processing in accordance with the flying imaging support program 100.

In addition, while an example of a form in which the flying imaging program 400 is stored in the storage 352 of the flying object 310 has been illustratively described in the embodiments, the disclosed technology is not limited thereto. For example, the flying imaging program 400 may be stored in a portable storage medium such as an SSD or a USB memory. The storage medium is a non-transitory storage medium. The flying imaging program 400 stored in the storage medium is installed on the computer 350 of the flying object 310. The processor 351 of the flying object 310 executes the flying imaging processing in accordance with the flying imaging program 400.

In addition, in the embodiments, the flying imaging support program 100 may be stored in a storage device of another computer, a server apparatus, or the like connected to the base station 10 through a network, and the flying imaging support program 100 may be downloaded and installed on the computer 50 of the base station 10 in response to a request of the base station 10.

In addition, the storage device of the other computer, the server apparatus, or the like connected to the base station 10 or the storage 52 of the base station 10 is not required to store the entire flying imaging support program 100 and may store a part of the flying imaging support program 100.

In addition, in the embodiment, the flying imaging program 400 may be stored in a storage device of another computer, a server apparatus, or the like connected to the flying object 310 through a network, and the flying imaging program 400 may be downloaded and installed on the computer 350 of the flying object 310 in response to a request of the flying object 310.

In addition, the storage device of the other computer, the server apparatus, or the like connected to the flying object 310 or the storage 352 of the flying object 310 is not required to store the entire flying imaging program 400 and may store a part of the flying imaging program 400.

In addition, while the computer 50 is incorporated in the base station 10 in the embodiments, the disclosed technology is not limited thereto. For example, the computer 50 may be provided outside the base station 10.

In addition, while the computer 350 is incorporated in the flying object 310 in the embodiments, the disclosed technology is not limited thereto. For example, the computer 350 may be provided outside the flying object 310.

In addition, while the computer 50 is used in the base station 10 in the embodiments, the disclosed technology is not limited thereto. A device including an ASIC, an FPGA, and/or a PLD may be applied instead of the computer 50. In addition, a combination of a hardware configuration and a software configuration may be used instead of the computer 50.

In addition, while the computer 350 is used in the flying object 310 in the embodiments, the disclosed technology is not limited thereto. A device including an ASIC, an FPGA, and/or a PLD may be applied instead of the computer 350. In addition, a combination of a hardware configuration and a software configuration may be used instead of the computer 350.

Various processors illustrated below can be used as a hardware resource for executing various types of processing described in the embodiments. Examples of the processors include a CPU that is a general-purpose processor functioning as the hardware resource for executing the various types of processing by executing software, that is, a program. In addition, examples of the processors include a dedicated electric circuit such as an FPGA, a PLD, or an ASIC that is a processor having a circuit configuration dedicatedly designed to execute specific processing. All of the processors incorporate or are connected to a memory, and all of the processors execute the processing using the memory.

In addition, the hardware resource for executing the various types of processing may be composed of one of the various processors or may be composed of a combination of two or more processors of the same type or different types (for example, a combination of a plurality of FPGAs or a combination of a CPU and an FPGA). In addition, the hardware resource for executing the processing may be one processor.

A first example composed of one processor is a form of one processor composed of a combination of one or more CPUs and software, in which the processor functions as the hardware resource for executing the various types of processing. A second example is, as represented by an SoC or the like, a form of using a processor that implements functions of the entire system including a plurality of hardware resources for executing the various types of processing in one IC chip. Accordingly, the various types of processing are implemented using one or more of the various processors as the hardware resource.

Furthermore, more specifically, an electric circuit in which circuit elements such as semiconductor elements are combined can be used as a hardware structure of the various processors. In addition, the various types of processing are merely an example. Accordingly, unnecessary steps may be deleted, new steps may be added, or a processing order may be changed without departing from the gist of the disclosed technology. Furthermore, the first embodiment, the second embodiment, the third embodiment, and the fourth embodiment may be carried out in combination with each other, as appropriate.

Above described contents and illustrated contents are detailed descriptions for parts according to the embodiment of the disclosed technology and are merely an example of the disclosed technology. For example, description related to the above configurations, functions, actions, and effects is description related to an example of configurations, functions, actions, and effects of the parts according to the embodiment of the disclosed technology. Thus, of course, unnecessary parts may be removed, new elements may be added, or parts may be replaced in the above described contents and the illustrated contents without departing from the gist of the disclosed technology. In addition, particularly, description related to common technical knowledge or the like that does not need to be described in terms of embodying the disclosed technology is omitted in the above described contents and in the illustrated contents in order to avoid complication and to facilitate understanding of the parts according to the embodiment of the disclosed technology.

In the present specification, “A and/or B” is synonymous with “at least one of A or B”. This means that “A and/or B” may be only A, only B, or a combination of A and B. In addition, in the present specification, the same approach as “A and/or B” is applied to a case where three or more matters are represented by connecting the matters with “and/or”.

All documents, patent applications, and technical standards disclosed in the present specification are incorporated in the present specification by reference to the same extent as in a case where each of the documents, patent applications, and technical standards are specifically and individually indicated to be incorporated by reference.

What is claimed is:

1. A control apparatus comprising:
a processor; and
a memory connected to or incorporated in the processor,
wherein the processor is configured to:
rotate a distance measurement device via a rotational drive apparatus to which the distance measurement device is attached;
measure a first distance between a inspection target object and the distance measurement device at a plurality of distance measurement locations of the inspection target object via the distance measurement device;
set a flying route for causing a flying object to fly along the inspection target object based on the first distance measured for each distance measurement location; and
in a case of causing the flying object to fly along the flying route and acquiring each of a plurality of first images by imaging each of a plurality of imaged regions of the inspection target object via a first imaging apparatus mounted on the flying object each time the flying object reaches each of a plurality of first imaging positions set on the flying route, perform a control of constantly maintaining pixel resolution of the first imaging apparatus even in a case where a distance between the inspection target and each of the plurality of first imaging positions changes.

2. The control apparatus according to claim 1,
wherein the processor is configured to:
adjust a rotational angle of the rotational drive apparatus to a second rotational angle at which the flying object is included within a distance measurement range of the distance measurement device;
measure a second distance between the flying object and the distance measurement device via the distance measurement device; and
perform a control of causing the flying object to fly along the flying route based on the second rotational angle and on the second distance.

3. The control apparatus according to claim 2,
wherein the distance measurement device includes a LiDAR scanner,
the second distance is a distance between the flying object and the LiDAR scanner, and
the processor is configured to:
derive second absolute coordinates of the flying object based on first absolute coordinates of the rotational drive apparatus, the second rotational angle, an angle of laser light emitted from the LiDAR scanner toward the flying object, and the second distance; and
perform a control of causing the flying object to fly along the flying route based on the second absolute coordinates.

4. The control apparatus according to claim 2,
wherein a second imaging apparatus is attached to the rotational drive apparatus, and
the processor is configured to perform a control of adjusting the rotational angle of the rotational drive apparatus to the second rotational angle based on a second image obtained by imaging the flying object via the second imaging apparatus.

5. The control apparatus according to claim 4,
wherein the second rotational angle is an angle at which the flying object is positioned in a center portion of an angle of view of the second imaging apparatus.

6. The control apparatus according to claim 4,
wherein the flying object includes a plurality of members categorized with different aspects, and
the processor is configured to control a posture of the flying object based on positions of the plurality of members captured in the second image.

7. The control apparatus according to claim 6,
wherein the different aspects are different colors, and
the members are propellers.

8. The control apparatus according to claim 6,
wherein the different aspects are different colors, and
the members are light-emitting objects.

9. The control apparatus according to claim 6,
wherein the different aspects are different turn-on and turn-off patterns, and
the members are light-emitting objects.

10. The control apparatus according to claim 1,
wherein the plurality of first imaging positions are positions at which the first images acquired at adjacent first imaging positions among the plurality of first imaging positions partially overlap with each other.

11. The control apparatus according to claim 1,
wherein in a case where a surface of the inspection target object has a recessed portion and an area of an opening portion of the recessed portion is less than a predetermined area, the processor is configured to set the flying route on a smooth virtual plane facing the surface.

12. The control apparatus according to claim 11,
wherein the processor is configured to, in a case where the flying object flies across the recessed portion, perform a control of constantly maintaining the pixel resolution by operating at least one of a zoom lens or a focus lens of the first imaging apparatus.

13. The control apparatus according to claim 1,
wherein the processor is configured to:
rotate a first distance measurement device as the distance measurement device via a first rotational drive apparatus as the rotational drive apparatus to which the first distance measurement device is attached;
measure the first distance at a plurality of first distance measurement locations among the plurality of distance measurement locations via the first distance measurement device;
rotate a second distance measurement device as the distance measurement device via a second rotational drive apparatus as the rotational drive apparatus to which the second distance measurement device is attached;
measure the first distance at a plurality of second distance measurement locations among the plurality of distance measurement locations via the second distance measurement device; and
set the flying route based on the first distance measured for each first distance measurement location and on the first distance measured for each second distance measurement location.

14. The control apparatus according to claim 13,
wherein the processor is configured to convert the first distance measured by the second distance measurement device into a distance with reference to a position of the first distance measurement device based on predetermined first calibration information.

15. The control apparatus according to claim 14,
wherein the processor is configured to convert a position of the flying object measured by the second distance measurement device into a position with reference to a position of the first distance measurement device based on predetermined second calibration information.

16. The control apparatus according to claim 14,
wherein the processor is configured to select a distance measurement device to measure a position of the flying object from the first distance measurement device and the second distance measurement device in accordance with the position of the flying object.

17. The control apparatus according to claim 14,
wherein the processor is configured to, in a case of setting the flying route with reference to a point positioned outside a first distance measurement region of the first distance measurement device and outside a second distance measurement region of the second distance measurement device, derive a distance between the point and the first distance measurement device based on an angle of a direction in which the point is positioned with respect to the first distance measurement device and on a distance between the first distance measurement device and the second distance measurement device.

18. The control apparatus according to claim 17,
wherein the processor is configured to, in a case where the flying object is positioned outside the first distance measurement region and outside the second distance measurement region, derive a distance between the flying object and the first distance measurement device based on an angle of a direction in which the flying object is positioned with respect to the first distance measurement device and on the distance between the first distance measurement device and the second distance measurement device.

19. The control apparatus according to claim 1,
wherein the flying object includes a third imaging apparatus,
the processor is configured to perform position correction processing of correcting a position of the flying object based on a third image obtained by imaging the inspection target object via the third imaging apparatus in a case where the flying object that has moved from a second imaging position set on the flying route has reached a third imaging position set on the flying route, and
in a case of acquiring a fourth image by imaging the inspection target object via the third imaging apparatus in accordance with reaching of the flying object to the second imaging position and then acquiring a fifth image by imaging the inspection target object via the third imaging apparatus in accordance with reaching of the flying object to the third imaging position, the position correction processing is processing of correcting the position of the flying object to a position at which an overlap amount between the fourth image and the fifth image is a predetermined overlap amount based on an overlap amount between the fourth image and the third image.

20. A base station comprising:
the control apparatus according to claim 1;
the rotational drive apparatus; and
the distance measurement device.

21. A control method comprising:
rotating a distance measurement device via a rotational drive apparatus to which the distance measurement device is attached;
measuring a first distance between a inspection target object and the distance measurement device at a plurality of distance measurement locations of the inspection target object via the distance measurement device;
setting a flying route for causing a flying object to fly along the inspection target object based on the first distance measured for each distance measurement location; and
performing, in a case of causing the flying object to fly along the flying route and acquiring each of a plurality of first images by imaging each of a plurality of imaged regions of the inspection target object via a first imaging apparatus mounted on the flying object each time the flying object reaches each of a plurality of first imaging positions set on the flying route, a control of constantly maintaining pixel resolution of the first imaging apparatus even in a case where a distance between the inspection target and each of the plurality of first imaging positions changes.

22. A non-transitory computer-readable storage medium storing a program causing a computer to execute a process comprising:
rotating a distance measurement device via a rotational drive apparatus to which the distance measurement device is attached;
measuring a first distance between a inspection target object and the distance measurement device at a plurality of distance measurement locations of the inspection target object via the distance measurement device;
setting a flying route for causing a flying object to fly along the inspection target object based on the first distance measured for each distance measurement location; and
performing, in a case of causing the flying object to fly along the flying route and acquiring each of a plurality of first images by imaging each of a plurality of imaged regions of the inspection target object via a first imaging apparatus mounted on the flying object each time the flying object reaches each of a plurality of first imaging positions set on the flying route, a control of constantly maintaining pixel resolution of the first imaging apparatus even in a case where a distance between the inspection target and each of the plurality of first imaging positions changes.
